(19) United States
(12) Patent Application Publication
(10) Pub. No.: US 2021/0028444 A1
(43) Pub. Date: Jan. 28, 2021

(54) THIN FILM CERAMICS THAT OFFER ELECTRIC AND ELECTROCHEMICAL PROPERTIES USING NANOPOWDERS OF CONTROLLED COMPOSITIONS

(71) Applicant: THE REGENTS OF THE UNIVERSITY OF MICHIGAN, Ann Arbor, MI (US)

(72) Inventors: Richard LAINE, Ann Arbor, MI (US); Eongyu YI, Richmond, CA (US); Eleni TEMECHE, Ann Arbor, MI (US); Bin LIANG, Shenzhen (CN)

(73) Assignee: THE REGENTS OF THE UNIVERSITY OF MICHIGAN, Ann Arbor, MI (US)

(21) Appl. No.: 16/980,262

(22) PCT Filed: Mar. 12, 2019
(86) PCT No.: PCT/US2019/021851

§ 371 Date: Sep. 11, 2020

Related U.S. Application Data
(60) Provisional application No. 62/641,866, filed on Mar. 12, 2018.

(51) Int. Cl. H01M 4/36; H01M 10/0525; H01M 4/58; H01M 4/04; H01M 4/131; H01M 4/1391; H01M 10/054; H01M 4/505; H01M 4/86; H01M 4/525

(52) U.S. Cl. CPC H01M 4/364; H01M 10/0525; H01M 4/5825; H01M 4/0471; H01M 4/525; H01M 4/1391; H01M 10/054; H01M 4/505; H01M 4/8621; H01M 4/131

(57) ABSTRACT

An electrochemically active component is disclosed. The electrochemically active component includes a ceramic film having a thickness of less than or equal to about 100 μm. The ceramic film can be composed of β″-Al₂O₃, LiCoO₂—Li₄SiO₄—Li₃PO₄ (LSPO)-Ag, LiNi_{0.33}Mn_{0.33}CO_{0.33}O₂ (NMC)/xLi₄Si0₄-(1−x)Li₃P0₄ (LSPO)/Ag, wherein 0<x<1, Li₃V0₄(LVO)/Li_{6.25}Al_{0.25}La₃Zr₂O₁₂(Al:LLZO)/Ag, 12CaO-7Al₂O₃ (Ca1₂A₇), or Mg_{0.5}CeₓZr₂₋ₓ(P0₄)₃ (MZPCeₓ), wherein 0<x<0.5. The electrochemically active component is a battery anode, a battery cathode, a battery ion conductor, a battery electron conductor, a thermal electric generator, a high temperature fuel cell, or a gate dielectric.

### CROSS-REFERENCE TO RELATED APPLICATIONS

This application claims the benefit of U.S. Provisional Application No. 62/641,866, filed on Mar. 12, 2018. The entire disclosure of the above application is incorporated herein by reference.

### GOVERNMENT SUPPORT

This invention was made with government support under DMR1105361 awarded by the National Science Foundation. The government has certain rights in the invention.

### FIELD

The present disclosure relates to thin film ceramics and cermets for batteries and energy storage devices.

### BACKGROUND

This section provides background information related to the present disclosure which is not necessarily prior art.

Sodium β″-Al₂O₃ has been the subject of numerous studies for the last 50 years because of its utility and potential utility as a Na⁺ conductor for a variety of applications including batteries and thermal electric generators, as well as a number of different types of high temperature fuel cells. The successful use of Na-β″-Al₂O₃ for any of these applications mandates optimization of its properties as an efficient Na⁺ conductor, in addition to its properties as a mechanically robust ceramic able to endure the rapid temperature extremes encountered in some of the more demanding applications.

In general, it is well recognized that Na-β″-Al₂O₃ offers better Na⁺ transport than the very similar Na β-Al₂O₃; thus, studies have focused on optimizing processing towards this goal, employing a variety of approaches. Among these approaches, researchers have used solid-state reactions; tape casting; and microwave, combustion, and sol-gel syntheses. In addition to optimization of Na-β″-Al₂O₃ contents, a variety of structural formats have been explored, beginning with simple pellets and ranging from tape cast films to tubes, targeting tubular battery and thermoelectric conversion devices.

At present, because of these constraints, commercial Na⁺ batteries and thermoelectric devices use 1-2 mm thick β″-Al₂O₃ tubular electrolytes that also offer a necessary mechanical framework. Processing difficulties have limited this material to such forms, and as a result, cells must operate at 300-350° C., where electrolyte resistance drops but is, in fact, still roughly half of the entire cell due to cell thicknesses. If β″-Al₂O₃ thin films (less than 100 μm) with optimal properties can be achieved, novel cell designs in flat geometries and even room temperature operation may be realized. Indeed, room temperature operation of Na⁺ cells have been reported using NASICON solid electrolytes, but at thicknesses of 1-2 mm depending on the type of battery formulated. The worldwide demand for Li suggests fundamental limitations to total Li resources that are anticipated to result in cost increases. Consequently Na batteries, either Na/S or Na/NiCl, offer a low cost, environmentally friendly alternative.

β″-Al₂O₃ tubes are commonly produced by solid-state reaction, in which starting powders are repeatedly ball-milled and calcined, then sintered to obtain the desired microstructural, physical, and electrochemical properties. Common sintering conditions involve heating to ≥1600° C. for 0.5-4 hours, causing Na₂O to rapidly volatilize, such that the green bodies are covered in a β″-Al₂O₃ powder bed or placed in a container to minimize Na₂O loss. Na₂O loss during sintering results in the formation of less conductive β-Al₂O₃. Furthermore, the high sintering temperatures cause excessive grain growth, leading to 50-500 μm sized grains, which exacerbate mechanical properties.

In many instances, optimization of Na⁺ conductivity is achieved though the introduction of dopants, including Li⁺, Mg²⁺, Ti⁴⁺, Si⁴⁺, and Y³⁺/Zr⁴⁺ (as yttria stabilized zirconia). In part, these dopants stabilize the β″ structure; in part, they limit excessive grain growth; and in part, they provide mechanical strength to the final sintered Na-β″-Al₂O₃ structures.

Good microstructural control has been attempted by vapor phase processes in which α-Al₂O₃/YSZ (70:30 vol. %) composites are sintered to high densities at 1600° C. for 2 hours, then reheated to 1400° C., with the samples covered in Na-β″-Al₂O₃ until full conversion of α-Al₂O₃ to Na-β″-Al₂O₃ is reached. The final grain size is equal to the initial grain size prior to conversion but requires multiple heating steps and high YSZ fractions, which lowers overall conductivity. Simply put, facile processing methods to high density Na-β″-Al₂O₃ films with fine microstructural control at low sintering temperatures remain problematic. Furthermore, most studies involve sintering powder compacts or thick tubes that are not suitable for producing thin films.

Perhaps most important are the targeted Na⁺ conductivities. Most of the battery components discussed focus on operating temperatures close to 300° C., with rare exceptions at 200° C. These systems offer conductivities of 0.1-0.2 Scm⁻¹ (100-200 mScm⁻¹) at 300° C. In comparison, single crystal Na-β″-Al₂O₃ has been found to offer conductivities of 10-30 Scm⁻¹ at 25° C. Na-β″-Al₂O₃(supertonic) with conductivities of approximately 3 mScm⁻¹ at room temperature have been described for producing functional Na batteries that operate at ambient, though only as pellets 1-2 mm thick.

Accordingly, thin films that conduct ions or electrons for battery or energy storage devices are desirable.

### SUMMARY

This section provides a general summary of the disclosure, and is not a comprehensive disclosure of its full scope or all of its features.

In various aspects, the current technology provides an electrochemically active component including a ceramic film having a thickness of less than or equal to about 100 μm, wherein the ceramic film includes Na-β″-Al₂O₃, Na_{1.67}Al_{10.33}Mg_{0.67}O₁₇ (NAMO), 0.4Li₄SiO₄-0.6Li₃PO₄ (LSPO), Mg_{0.5}Zr₂(PO₄)₃ (MZP), La₃Ta₂O₁₂, Li₂₊₂ₓZn₁₋ₓGeO₄ (LISICON), Li₅La₃Ta₂O₁₂, Li_{0.5}La_{0.5}TiO₃, Li₇₋ₓLa₃Zr₂₋ₓTaₓO₁₂ where 0<x<2 (e.g., Li₇La₃Zr₂O₁₂), Li₆La₃SnMO₁₂, Li_{6.75+x}La₃₋ₓSrₓZr_{1.75}Nb_{0.25}O₁₂ where 0.05≤x≤0.25 (LLSZN), Li₂B₄O₇, LiCoO₂ (LCO), LiFePO₄ (LFP), LiNiCoAlO₂ (NCA), LiMn₂O₄ (LMO), LiNi_{0.5}Mn_{1.5}O₄ (LNMO), Li₃VO₄ (LVO), Li₄Ti₅O₁₂, 12CaO-7Al₂O₃ (C12A7), InₓSn₁₋ₓO₂ where 0<x<1 (ITO), and ZnO, Y₂O₃, ZrO₂, NiAl₂O₄, NiO, Fe₂O₃, HfO₂, SiO₂, SrSnO₃, ZnSnO₃, BaSnO₃, RE₂O₃, AlxByPᵤLaₘLi_{z}RE1ₐSi_{b}RE2_{c}Zr_{d}YₑO_{f} where RE is a rare earth element, and the molar range of each element can be: x=0.05 to 0.99, y=0.00 to 0.99, u=0.0 to 3.0, m=2.0 to 3.5, z=2.5 to 10.5, a=0.05 to 3.5, b=0.01 to 1.0, c=0.25 to 5.0, d=0.0 to 2.0, and e=0.01 to 0.5, CoₓLi_{y}Mn_{z}NₐP_{b}Ti_{c}O_{d} Ag_{d} where the molar range of each element can be: x=0.0 to 2.0, y=0.0 to 5.0, z=0.0 to 3.0, a=0.0 to 2.0, b=0.0 to 3.0, c=0.0 to 2.0, and d=0.0 to 10.0, NaₓZr_{y}Ti_{z}YₐAl_{b}Mg_{c}Li_{d}Oₑ where the molar range of each element can be: x=0.0 to 6.0, y=0.0 to 4.0, z=0.0 to 3.0, a=0.0 to 3.0, b=0.0 to 12.0, c=0.0 to 5.0, d=0.0 to 5.0, and e=0.0 to 22.0, AlₓCo_{y}Ni_{z}YₐZr_{b}O_{c} where the molar range of each element can be: x=0.0 to 6.0, y=0.0 to 5.0, z=0.0 to 3.0, a=0.0 to 2.0, and b=0.0 to 3.0, or a combination thereof.

In one aspect, the ceramic film is a continuous film of β″-Al₂O₃.

In one aspect, the β″-Al₂O₃ is doped with at least one of Mg and Ti.

In one aspect, the continuous film includes ZrO₂, such that the ceramic film is a ceramic composite film.

In one aspect, the ceramic film is a Na ion conductor.

In one aspect, the ceramic film includes a plurality of ceramic layers, wherein each layer of the plurality has a thickness of less than or equal to about 100 μm.

In one aspect, the ceramic film is a continuous film of sintered Na_{0.67}Al_{10.33}Mg_{0.67}O₁₇ (NAMO), ZrO₂, and TiO₂ having a thickness of less than or equal to about 75 nm.

In one aspect, the ceramic film is a ceramic-metal composite film including LiCoO₂—Li₄SiO₄—Li₃PO₄ (LSPO)-Ag.

In one aspect, the ceramic-metal composite film is a cathode for a lithium battery.

In one aspect, the film is a ceramic-metal composite film including LiNi_{0.33}Mn_{0.33}Co_{0.33}O₂ (NMC)/xLi₄SiO₄-(1−x)Li₃PO₄ (LSPO)/Ag where 0≤x≤1.

In one aspect, the ceramic-metal composite film is a cathode for a lithium battery.

In one aspect, the film is a ceramic-metal composite film including Li₃VO₄(LVO)/Li_{6.25}Al_{0.25}La₃Zr₂O₁₂(Al:LLZO)/Ag.

In one aspect, the ceramic composite film is an anode for a lithium battery.

In one aspect, the ceramic film includes 12CaO-7Al₂O₃ (Ca12A7).

In one aspect, the ceramic film is an electron conductor.

In one aspect, the ceramic film is a ceramic composite film including Mg_{0.5}CeₓZr₂₋ₓ(PO₄)₃ (MZPCeₓ), wherein 0<x≤0.5.

In one aspect, the ceramic composite film is a Mg ion conductor.

In one aspect, the electrochemically active component is a battery anode, a battery cathode, a battery ion conductor, a battery electron conductor, a thermal electric generator, a high temperature fuel cell, or a gate dielectric.

In various aspects, the current technology provides a battery component including a ceramic film having a thickness of less than or equal to about 100 nm, wherein the ceramic film includes β″-Al₂O₃, LiCoO₂—Li₄SiO₄—Li₃PO₄ (LSPO)-Ag, LiNi_{0.33}Mn_{0.33}Co_{0.33}O₂ (NMC)/xLi₄SiO₄-(1−x)Li₃PO₄ (LSPO)/Ag where 0≤x≤1, Li₃VO₄(LVO)/Li_{6.25}Al_{0.25}La₃Zr₂O₁₂(Al:LLZO)/Ag, 12CaO-7Al₂O₃ (Ca12A7), or Mg_{0.5}CeₓZr₂₋ₓ(PO₄)₃ (MZPCeₓ), wherein 0<x≤0.5.

In various aspects, the current technology provides a method of making a ceramic film, the method including combining ceramic precursor nanoparticles having an average diameter of less than or equal to about 500 nm, an additive component, and a solvent to generate a nanopowder suspension; casting a layer of the suspension onto a substrate; drying the layer to form a green film; debindering the green film to form a debindered green film; and sintering the compressed and debindered green film to form the ceramic film, wherein the ceramic film has a thickness of less than or equal to about 100 nm and includes Na-β″-Al₂O₃, Na_{1.67}Al_{10.33}Mg_{0.67}O₁₇ (NAMO), 0.4Li₄SiO₄-0.6Li₃PO₄ (LSPO), Mg_{0.5}Zr₂(PO₄)₃ (MZP), La₃Ta₂O₁₂, Li₂₊₂ₓZn₁₋ₓGeO₄ (LISICON), Li₅La₃Ta₂O₁₂, Li_{0.5}La_{0.5}TiO₃, Li₇₋ₓLa₃Zr₂₋ₓTaₓO₁₂ where 0<x<2 (e.g., Li₇La₃ZrO₁₂), Li₆La₃SnMO₁₂, Li_{6.75+x}La₃₋ₓSrₓZr_{1.75}Nb_{0.25}O₁₂ where 0.05≤x≤0.25 (LLSZN), Li₂B₄O₇, LiCoO₂ (LCO), LiFePO₄ (LFP), LiNiCoAlO₂ (NCA), LiMn₂O₄ (LMO), LiNi_{0.5}Mn_{1.5}O₄ (LNMO), Li₃VO₄ (LVO), Li₄Ti₅O₁₂, 12CaO-7Al₂O₃ (C12A7), InₓSn₁₋ₓO₂ where 0<x<1 (ITO), and ZnO, Y₂O₃, ZrO₂, NiAl₂O₄, NiO, Fe₂O₃, HfO₂, SiO₂, SrSnO₃, ZnSnO₃, BaSnO₃, RE₂O₃, AlxByPᵤLaₘLi_{z}RE1ₐSi_{b}RE2_{c}Zr_{d}YₑO_{f} where RE is a rare earth element, and the molar range of each element can be: x=0.05 to 0.99, y=0.00 to 0.99, u=0.0 to 3.0, m=2.0 to 3.5, z=2.5 to 10.5, a=0.05 to 3.5, b=0.01 to 1.0, c=0.25 to 5.0, d=0.0 to 2.0, and e=0.01 to 0.5, CoₓLi_{y}Mn_{z}NₐP_{b}Ti_{c}O_{d} Ag_{d} where the molar range of each element can be: x=0.0 to 2.0, y=0.0 to 5.0, z=0.0 to 3.0, a=0.0 to 2.0, b=0.0 to 3.0, c=0.0 to 2.0, and d=0.0 to 10.0, NaₓZr_{y}Ti_{z}YₐAl_{b}Mg_{c}Li_{d}Oₑ where the molar range of each element can be: x=0.0 to 6.0, y=0.0 to 4.0, z=0.0 to 3.0, a=0.0 to 3.0, b=0.0 to 12.0, c=0.0 to 5.0, d=0.0 to 5.0, and e=0.0 to 22.0, AlₓCo_{y}Ni_{z}YₐZr_{b}O_{c} where the molar range of each element can be: x=0.0 to 6.0, y=0.0 to 5.0, z=0.0 to 3.0, a=0.0 to 2.0, and b=0.0 to 3.0, and combinations thereof.

In one aspect, the ceramic precursor nanoparticles are made by liquid-feed flame spray pyrolysis (LF-FSP).

In one aspect, the ceramic precursor nanoparticles are made from a precursor selected from the group consisting of, carboxylate salts including Li, Na, Ca, Mg, Ba, Zr, Ce, Co, Mn, Dy, Er, Gd, Ho, La, Lu, Nd, Pr, Pm, Sm, Sc, Tb, Tm, Yb, and Y; alumatrane (N(CH₂CH₂O)₃Al); alkoxy phosphites and phosphates; alkoxysilanes; nickel acetate tetrahydrate; and combinations thereof.

In one aspect, the additive component includes at least one dispersant, at least one binder, at least one plasticizer, or a combination thereof.

In one aspect, the at least one dispersant is selected from the group consisting of polyacrylic acid, bicine, citric acid, steric acid, fish oil, phenylphosphonic acid, phosphoric acid, ammonium polymethacrylate, organosilanes, and combinations thereof.

In one aspect, the at least one binder is selected from the group consisting of polyvinyl butyral, polyvinyl acetate, methyl cellulose, ethyl cellulose, polyacrylate esters, polyurethane, polyethylene glycol, acrylic compounds, polystyrene, polyvinyl alcohol, polymethylmethacrylate, polybutylmethacrylate, and combinations thereof.

In one aspect, the at least one plasticizer is selected from the group consisting of benzyl butyl phthalate, acetic acid alkyl esters, bis[2-(2-butoxyethoxy)ethyl] adipate, 1,2-Dibromo-4,5-bis(octyloxy)benzene, dibutyl adipate, dibutyl itaconate, dibutyl sebacate, dicyclohexyl phthalate, diethyl adipate, diethyl azelate, di(ethylene glycol) dibenzoiate, diethyl sebacate, diethyl succinate, diheptyl phthalate, diisobutyl adipate, diisobutyl fumarate, diisobutyl phthalate, diisodecyl adipate, diisononyl phthalate, dimethyl adipate, dimethyl azelate, dimethyl phthalate, dimethyl sebacate, dioctyl terephthalate, diphenyl phthalate, di(propylene glycol) dibenzoate, dipropyl phthalate, ethyl 4-acetylbutyrate, 2-(2-ethylhexyloxy)ethanol, isodecyl benzoate, isooctyl tallate, neopentyl glycol dimethylsulfate, 2-nitrophenyl octyl ether, poly(ethylene glycol) bis(2-ethylhexanoate), poly(ethylene glycol) dibenzoate, poly(ethylene glycol) dioleate, poly(ethylene glycol) monolaurate, poly(ethylene glycol) monooleate, poly(ethylene glycol) monooleate, sucrose benzoate, 2,2,4-trim ethyl-1,3-pentanediol dibenzoate, trioctyl timelitate, and combinations thereof.

In one aspect, the method further includes ball milling the nanopowder suspension prior to the casting.

In one aspect, the substrate is selected from the group consisting of polyethylene terephthalate (PET), biaxially-oriented polyethylene terephthalate (BoPET), polytetrafluoroethylene (PTFE), a plastic, rubber, metal, steel, stainless steel, graphite foil, glass, and a combination thereof.

In one aspect, the casting is performed by bar coating, wire wound rod coating, drop casting, spin coating, doctor blading, dip coating, or spray coating.

In one aspect, the drying the layer to form the green film removes substantially all of the solvent and includes incubating the layer at a temperature of greater than or equal to about 20° C. to less than or equal to about 200° C. for a time of greater than or equal to about 30 minutes to less than or equal to about 24 hours.

In one aspect, the method further includes removing the green film from the substrate prior to the debindering.

In one aspect, the method further includes compressing the green film at a pressure of greater than or equal to about 5 MPa to less than or equal to about 300 MPa, wherein the compressing is performed immediately before or immediately after the debindering.

In one aspect, the debindering is performed by subjecting the green film to a temperature of greater than or equal to about 300° C. to less than or equal to about 700° C. for a time of greater than or equal to about 0.25 hours to less than or equal to about 10 hours.

In one aspect, the sintering includes heating the debindered green film to a temperature of greater than or equal to about 700° C. to less than or equal to about 1700° C. for a time of greater than or equal to about 1 hour to less than or equal to about 48 hours.

In one aspect, the method further includes, prior to the sintering, disposing a second green film onto either the green film or the ceramic film, the second green film having the same or a different composition than the green film; and sintering the second green film to form the ceramic film, wherein the ceramic film is a composite ceramic film.

In one aspect, the ceramic film is at least one of flexible and transparent.

In one aspect, the ceramic film is configured to be a battery cathode, catholyte, electrolyte, anolyte, or anode.

In one aspect, the nanopowder suspension further includes nanoparticle dopants, and the ceramic film is a composite film including a ceramic material generated from the ceramic precursor nanoparticles and the nanoparticle dopants.

In one aspect, the ceramic film is a cathode material selected from the group consisting of LiCoO₂ (LCO), LiNiₓMn_{y}Co_{z}O₂ (NMC) where 0≤x≤1, 0≤y≤1, 0≤z≤1, LiFePO₄ (LFP), LiNiCoAlO₂ (NCA), LiMn₂O₄ (LMO), and LiNi_{0.5}Mn_{1.5}O₄ (LNMO) and combinations thereof.

In one aspect, the ceramic film is an electrolyte material selected from the group consisting of Na-β″-Al₂O₃, Na_{1.67}Al_{10.33}Mg_{0.67}O₁₇ (NAMO), 0.4Li₄SiO₄-0.6Li₃PO₄ (LSPO), Mg_{0.5}Zr₂(PO₄)₃ (MZP), La₃Ta₂O₁₂, Li₂₊₂ₓZn₁₋ₓGeO₄ (LISICON), Li₅La₃Ta₂O₁₂, Li_{0.5}La_{0.5}TiO₃, Li₇₋ₓLa₃Zr₂₋ₓTaₓO₁₂ where 0<x<2 (e.g., Li₇La₃Zr₂O₁₂), Li₆La₃SnMO₁₂, Li_{6.75+x}La₃₋ₓSrₓ Zr_{1.75}Nb_{0.25}O₁₂ where 0.05≤x≤0.25 (LLSZN), Li₂B₄O₇ and combinations thereof.

In one aspect, the ceramic film is an anode material selected from the group consisting of Li₃VO₄ (LVO), Li₄Ti₅O₁₂, and combinations thereof.

In one aspect, the ceramic film is an electrical conductor selected from the group consisting of 12CaO-7Al₂O₃ (C12A7).

In various aspects, the current technology provides a thin ceramic film made by the method.

In various aspects, the current technology provides a battery including a ceramic film made by the method according to claim 20.

In various aspects, the current technology provides a ceramic film including Na-β″-Al₂O₃, Na_{1.67}Al_{10.33}Mg_{0.67}O₁₇ (NAMO), 0.4Li₄SiO₄-0.6Li₃PO₄ (LSPO), Mg_{0.5}Zr₂(PO₄)₃ (MZP), La₃Ta₂O₁₂, Li₂+₂ₓZn₁₋ₓGeO₄ (LISICON), Li₅La₃Ta₂O₁₂, Li_{0.5}La_{0.5}TiO₃, Li₇₋ₓLa₃Zr₂₋ₓTaₓO₁₂ where 0≤x≤2 (e.g., Li₇La₃Zr₂O₁₂), Li₆La₃SnMO₁₂, Li_{6.75+x}La₃₋ₓSrₓZr_{1.75}Nb_{0.25}O₁₂ where 0.05≤x≤0.25 (LLSZN), Li₂B₄O₇, LiCoO₂ (LCO), LiFePO₄ (LFP), LiNiCoAlO₂ (NCA), LiMn₂O₄ (LMO), LiNi_{0.5}Mn_{1.5}O₄ (LNMO), Li₃VO₄ (LVO), Li₄Ti₅O₁₂, 12CaO-7Al₂O₃ (C12A7), In_{y}Sn_{1-y}O₂ where 0<x<1 (ITO), and ZnO, Y₂O₃, ZrO₂, NiAl₂O₄, NiO, Fe₂O₃, HfO₂, SiO₂, SrSnO₃, ZnSnO₃, BaSnO₃, RE₂O₃, AlxByPᵤLaₘLi_{z}RE1ₐSi_{b}RE2_{c}Zr_{d}YₑO_{f} where RE is a rare earth element, and the molar range of each element can be: x=0.05 to 0.99, y=0.00 to 0.99, u=0.0 to 3.0, m=2.0 to 3.5, z=2.5 to 10.5, a=0.05 to 3.5, b=0.01 to 1.0, c=0.25 to 5.0, d=0.0 to 2.0, and e=0.01 to 0.5, CoₓLi_{y}Mn_{z}NₐP_{b}Ti_{c}O_{d} Ag_{d} where the molar range of each element can be: x=0.0 to 2.0, y=0.0 to 5.0, z=0.0 to 3.0, a=0.0 to 2.0, b=0.0 to 3.0, c=0.0 to 2.0, and d=0.0 to 10.0, NaₓZr_{y}Ti_{z}YₐAl_{b}Mg_{c}Li_{d}Oₑ where the molar range of each element can be: x=0.0 to 6.0, y=0.0 to 4.0, z=0.0 to 3.0, a=0.0 to 3.0, b=0.0 to 12.0, c=0.0 to 5.0, d=0.0 to 5.0, and e=0.0 to 22.0, AlₓCo_{y}Ni_{z}YₐZr_{b}O_{c} where the molar range of each element can be: x=0.0 to 6.0, y=0.0 to 5.0, z=0.0 to 3.0, a=0.0 to 2.0, and b=0.0 to 3.0, and combinations thereof, wherein the ceramic film has a thickness of less than or equal to about 100 μm.

In one aspect, the ceramic film is a composite ceramic film further including a dopant selected from the group consisting of Al, Ga, In, Mn, Ca, Ba, Sr, Y, Nb, Ta, Si, Mo, RE rare earth elements (scandium (Sc), yttrium (Y), lanthanum (La), cerium (Ce), praseodymium (Pr), neodymium (Nd), promethium (Pm), samarium (Sm), europium (Eu), gadolinium (Gd), terbium (Tb), dysprosium (Dy), homium (Ho), Erbium (Er), thulium (Tm), ytterbium (Yb), and lutetium (Lu)), actinides, lanthanides, or combinations thereof.

In one aspect, the ceramic film further includes a conductive additive selected from the group consisting of silver (Ag), gold (Au), palladium (Pd), platinum (Pt), copper (Cu), lead (Pb), tungsten (W), titanium (Ti), and combinations thereof.

In one aspect, the ceramic film includes at least one additional layer including a second ceramic film having a thickness of less than or equal to about 100 μm.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a flow chart showing a method for making a thin film according to various aspects of the current technology.

FIG. 2 is a process flow chart for manufacturing thin ceramic films according to various aspects of the current technology.

FIG. 3A shows SEM images of as-produced NAMO, TiO₂, and ZrO₂ NPs.

FIG. 3B shows XRD patterns of as-produced and calcined NAMO NPs and of standard γ-Al₂O₃, Na₇Al₃O₈, and β″-Al₂O₃.

FIG. 3C shows XRD patterns of as-produced ZrO₂ and TiO₂ nanopowders with reference to m-ZrO₂, t-ZrO₂, a-TiO₂, and r-TiO₂.

FIG. 3D shows TGA plots of NAMO, ZrO₂, and TiO₂ NPs.

FIG. 4 shows SEM fracture surface images of NAMO-xTiO₂ (x=0, 1, 2, 3) sintered to selected temperatures (Scale bar=2 μm).

FIG. 5A shows XRD patterns of NAMO-xTiO₂ (x=0, 1, 2, 3) sintered to 1400° C./2 hours with reference to β″-Al₂O₃ and β-Al₂O₃. Peaks that do not overlap and are commonly used for differentiating β″/β-Al₂O₃ are labeled.

FIG. 5B is a graph showing trace of a β″-Al₂O₃ fraction of sintered NAMO-xTiO₂ (x=0, 1, 2, 3).

FIG. 6 shows SEM fracture surface images of sintered NAMO-xTiO₂-10ZrO₂ (x=2, 3).

FIG. 7 shows XRD patterns of NAMO-xTiO₂ (x=2, 3) and NAMO-xTiO₂-10ZrO₂ (x=2, 3) sintered to 1360° C./2 hours with reference to β″-Al₂O₃, β-Al₂O₃, m-ZrO₂, and t-ZrO₂.

FIG. 8 shows Nyquist plots of NAMO-xTiO₂ (x=2, 3) and NAMO-xTiO₂₋₁₀ZrO₂ (x=2, 3) sintered to 1360° C./2 hours.

FIG. 9A shows an optical image of 1320° C./2 hours sintered NAMO-2TiO₂-10ZrO₂. Samples are roughly 2×2 cm.

FIG. 9B is a SEM fracture surface image of 1320° C./2 hours sintered NAMO-2TiO₂-10ZrO₂ (50 μm thick).

FIG. 9C is a micrograph of a film having a thickness of about 29 μm.

FIG. 9D is a fracture surface of a 17 μm thick film with the same conductivities as the 50 μm thick film at 2-3 mScm⁻¹.

FIG. 10A shows galvanostatic cycling of a Na/NAMO-2TiO₂-10ZrO₂/Na symmetric cell.

FIG. 10B shows galvanostatic cycling of a Na/NAMO-3TiO₂-10ZrO₂/Na symmetric cell.

FIG. 11A is a SEM fracture surface image of sintered LiCoO₂/Li₄SiO₄—Li₃PO₄/Ag at a first magnification.

FIG. 11B is a SEM fraction surface image of the sintered LiCoO₂/Li₄SiO₄—Li₃PO₄/Ag of FIG. 10A at a second magnification.

FIG. 11C is an XRD pattern of sintered LiCoO₂/Li₄SiO₄—Li₃PO₄/Ag.

FIG. 12 shows a LiCoO₂/Li_{3.4}Si_{0.4}P_{0.6}O₄/Ag composite cathode 950° C./1 hour sintered.

FIG. 13A shows SEM fracture surface images of NMC/LSP/Ag sintered to 900° C./1 h/air at various magnifications.

FIGS. 13B-13F show SEM fracture surface images of NMC/LSP/Ag film sintered to 900° C./1 h/air. With some closed porosity, trans-granular fracture surfaces reveal high relative densities. The film thickness is 37±0.3 μm. EDX mapping shows that the elements are well distributed without noticeable phase segregation.

FIG. 14A is a micrograph of a NMC/Li₄SiO₄—Li₃PO₄/Ag film at a first magnification.

FIG. 14B is a micrograph of the NMC/Li₄SiO₄—Li₃PO₄/Ag film of FIG. 14A shown at a second magnification.

FIG. 15A is a micrograph of a Li₃VO₄/Al:LLZO/Ag (69:29:2) composite anode sintered to 850° C./1 hour (N₂) at a first magnification.

FIG. 15B is a micrograph of the composite anode shown in FIG. 15A at a second magnification.

FIG. 15C is a micrograph of the composite anode shown in FIG. 15A at a third magnification.

FIG. 16 shows nanopowder XRDs of LF-FSP C12A7, C12A7+5%, and C12A7+10%.

FIG. 17 is a SEM micrograph of as-produced C12A7+10% nanopowders.

FIG. 18A shows a TGA/DSC of LF-FSP as-produced C12A7.

FIG. 18B shows a TGA/DSC of LF-FSP as-produced C12A7+5%.

FIG. 18C shows a TGA/DSC of LF-FSP as-produced C12A7+10%.

FIG. 19 shows FTIR spectra of as-produced nanopowders.

FIG. 20A is a SEM fracture surface image of a C12A7+10% green film.

FIG. 20B is a TGA of the C12A7+10% green film of FIG. 20A.

FIG. 21 shows XRD patterns of C12A7 films heated at selected temperatures.

FIG. 22 shows XRDs of C12A7, C12A7+5%, and C12A7+10% films sintered at 1300° C./3 hours.

FIG. 23 shows a SEM fracture surface image of sintered C12A7 with 10% excess calcium.

FIG. 24 is a Nyquist plot of sintered C12A7 film.

FIG. 25A shows a SEM fracture surface image of C12A7 sintered at 1300° C./3h at a first magnification.

FIG. 25B shows a SEM fracture surface image of C12A7 sintered at 1300° C./3h at a second magnification.

FIG. 25C shows a SEM fracture surface image of C12A7+5% sintered at 1300° C./3h at a first magnification.

FIG. 25D shows a SEM fracture surface image of C12A7+5% sintered at 1300° C./3h at a second magnification.

FIG. 25E shows a SEM fracture surface image of C12A7+10% sintered at 1300° C./3h at a first magnification.

FIG. 25F shows a SEM fracture surface image of C12A7+10% sintered at 1300° C./3h at a second magnification.

FIG. 26 shows Nyquist plots of C, 12A7+10% films hydrogen treated to 1050° (squares), 1100° (circles), and 1200° C. (triangles) for 1 hour. C12A7:H+10% films were illuminated by UV-light for 1 hour before measured by impedance spectroscopy at 25° C.

FIG. 27A is a SEM image of as-produced MZPCe_{0.2} powders. A speckled coating on particle surfaces is sputtered gold added to aid imaging.

FIG. 27B is a XRD pattern of the as-produced MZPCe_{0.2} powders.

FIG. 28 is a thermal analysis showing continuous, significant mass losses (until around 550° C.) accompanied by exotherms arising at 320° and 500° C., due mainly to decomposition of polymer additives.

FIG. 29 shows XRD patterns of MZPCeₓ pellets after sintering at 1200° C./1 h/air.

FIG. 30A is a SEM fresh fracture surface of MZPCe_{0.1} after sintering at 1200° C./1 h/air.

FIG. 30B is a SEM fresh fracture surface of MZPCe_{0.2} after sintering at 1200° C./1 h/air.

FIG. 30C is a SEM fresh fracture surface of MZPCe_{0.3} after sintering at 1200° C./1 h/air.

FIG. 31A is a representative Nyquist plot for MZPCe_{0.2} pellets tested at 100° C. The insert is an equivalent circuit used for fitting. R and CPE denote resistors and constant phase elements, respectively.

FIG. 31B is a representative Nyquist plot for MZPCe_{0.2} pellets tested at 200° C.

FIG. 32 shows XRD patterns of MZPCe_{0.2} films after sintering at 1000-1200° C. in air.

FIG. 33A is a SEM of a fractured MZPCe_{0.2} film after sintering in air at 1000° C./1 hour.

FIG. 33B is a SEM of a fractured MZPCe_{0.2} film after sintering in air at 1100° C./1 hour.

FIG. 33C is a SEM of a fractured MZPCe_{0.2} film after sintering in air at 1200° C./1 hour.

FIG. 33D is a SEM of a fractured MZPCe_{0.2} film after sintering in air at 1200° C./3 hour.

FIG. 34A is a representative TEM of the as-sintered MZPCe_{0.2} films at 1200° C./3 hours in air.

FIG. 34B shows a representative TEM image indicating the presence of secondary ZrP₂O₇ phases with AGSs of ca. 200 nm.

FIG. 35A is a representative Nyquist plot for MZPCe_{0.2} film samples tested at 100° C. The insert is an equivalent circuit used for fitting, the same as that for pellets in FIG. 31A.

FIG. 35B is a representative Nyquist plot for MZPCe_{0.2} film samples tested at 200° C.

FIG. 36 is an Arrhenius plot for MZPCe_{0.2} films based on the data in Table 15.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of.” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first,” “second,” and other numerical terms when used herein do not imply a sequence or order unless clearly indicated by the context. Thus, a first step, element, component, region, layer or section discussed below could be termed a second step, element, component, region, layer or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges. As referred to herein, ranges are, unless specified otherwise, inclusive of endpoints and include disclosure of all distinct values and further divided ranges within the entire range. Thus, for example, a range of “from A to B” or “from about A to about B” is inclusive of A and B.

Example embodiments will now be described more fully with reference to the accompanying drawings.

The present technology relates to a method for manufacturing metal oxide and metal oxide/metal oxide and metal oxide/metal oxide/metal single and multilayer thin films (for example, 5-150 μm thin) by casting single layer polymer/nanopowder composite films and, where desirable, laminating layers of the same or different oxides. The resulting polymer films are heated to first remove binder and then, to sinter them to partially porous or dense single metal oxide films, multilayer metal oxide films, metal oxide/metal composite films, or thin film laminates. The resulting films or laminates offer valuable electrical or electrochemical properties not easily accessible by other means. The nanopowders used for such processes are typically produced using liquid feed-flame spray pyrolysis (LF-FSP) processes as a non-limiting example of a nanopowder source. Such LF-FSP techniques are described in U.S. Pat. No. 7,220,398 to Sutorik et al., which is incorporated herein by reference in its entirety.

There is a continual search for materials and methods that offer access to very thin ceramic films and/or multilayer laminates that are dense, partially porous, or porous for multiple applications ranging from membranes for oxygen separation from air, solid oxide fuel cell electrodes and electrolytes, solid electrolytes for sodium and magnesium batteries as cathodes and anodes for solid state batteries, and as electrically conductive thin films for multiple applications.

One of the major problems with producing very thin films arises because commercially available ceramic powders typically have average particle sizes of 1-10 μm and only in rare instances is it possible to find powders with particle sizes below about 500 nm. Even in instances where such particles are available, there remain serious obstacles to producing thin, dense, or partially porous or porous films that offer sufficient mechanical strength because the process of densifying these films often leads to the growth of very large grains (greater than 3 μm) in the final film, making them very susceptible to brittle failure, especially in ceramic films thinner than about 30 μm because such large grains have relatively long grain boundaries that offer low energy avenues for crack propagation, greatly limiting their utility in manufacturing products where structural integrity during manufacture and use is paramount.

Furthermore, most methods of processing thin to very thin films either work poorly or are expensive. Thus, ceramic films thinner than about 40 μm are very difficult to make using doctor blading, in part because of the starting particle sizes, but also in part because of the high viscosities generated when the loading of ceramic particles in the slip becomes very high. In these instances, the slip is pushed across the surface to be coated, creating drag and compression, and as a consequence, uneven film surfaces and thicknesses can result due to die swell issues.

In accordance with the current technology, the use of nanopowders overcomes the issues of particle size and the use of wire-wound roller coating, wherein a dispersed powder coating system is dragged across a substrate as opposed to being pushed across a substrate in doctor blading, avoids, for example, die swell problems, which seems to offer a significant processing advantage, allowing processing of ceramic thin films at thicknesses below 10 μm, but most commonly between 10 and 40 μm. Furthermore, the use of nanopowders provides dense films where final grain sizes are less than 3 μm and often less than 500 nm.

Also, the use of LF-FSP provides a method of incrementally varying nanopowder compositions with very exacting control of element compositions, enabling very fine control of final thin film properties.

The current technology provides methods for processing sets of thin ceramic films, composites, and laminates, such as, for example, ion conducting ceramic materials.

Nanopowders synthesized using LF-FSP can be used directly to formulate suspensions that can be cast to form polymer/nanopowder thin films. These thin films can be laminated at this stage to form multilayer composites or heat treated to undergo binder burnout and then laminated or sintered and then laminated and heated to form interfaces resulting in ceramic thin films of desired characteristics. Target compositions of nanopowders are produced by combusting aerosols of alcoholic solutions of selected metalorganic precursors in an oxidizing atmosphere.

Example precursors in the synthesis/processing of ceramics precursor nanoparticles include, but are not limited to, carboxylate salts comprising Li, Na, Ca, Mg, Ba, Zr, Ce, Co, Mn, Dy, Er, Gd, Ho, La, Lu, Nd, Pr, Pm, Sm, Sc, Tb, Tm, Yb, and Y; alumatrane (N(CH₂CH₂O)₃Al); alkoxy phosphites and phosphates; alkoxysilanes; nickel acetate tetrahydrate; and combinations thereof. Non-limiting examples of carboxylate salts include Li propionate, Na propionate, Ca propionate, Mg propionate, Ba propionate, zirconium isobutyrate, cerium isobutyrate, cobalt isobutryate, cerium propionate, dysprosium propionate, erbium propionate, gadolinium propionate, holmium propionate, lanthanum propionate, lutetium propionate, neodymium propionate, praseodymium propionate, promethium propionate, samarium propionate, scandium propionate, terbium propionate, thulium propionate, ytterbium propionate, yttrium propionate, and combinations thereof. These precursors are processed, e.g., by LF-FSP, to form nanoparticles or a powder of nanoparticles. Nanopowders, e.g., ceramic precursor nanoparticles, with average particle sizes below 100 nm can be produced by combusting aerosols of precursor solutions at concentrations of 1 to 20 wt. % ceramic yields, but preferably less than 5 wt. %. In some embodiments, conductive additives are added to the nanopowders. The conductive additives can also be in the form of nanopowders. Non-limiting examples of conductive metals include silver (Ag), gold (Au), copper (Cu), platinum (Pt), and palladium (Pd).

Non-limiting examples of ceramic precursor nanoparticles made from the above exemplary precursors include the electrolytes Na-β″-Al₂O₃, Na_{1.67}Al_{10.33}Mg_{0.67}O₁₇ (NAMO), Li₇La₃Zr₂O₁₂ (LLZO), 0.4Li₄SiO₄-0.6Li₃PO₄ (LSPO), Mg_{0.5}Zr₂(PO₄)₃ (MZP), Li_{1+x+y}AlₓTi₂₋ₓSi_{y}P_{3-y}O₁₂ (LATSP), La₃Ta₂O₁₂, Li₂₊₂ₓZn₁₋ₓGeO₄ (LISICON; “lithium super ionic conductor”), Li₅La₃Ta₂O₁₂, Li₇₋ₓLa₃Ta₂TiO₃, Li₇₋ₓLa₃Zr₂₋ₓTaₓO₁₂ where 0<x<2 (e.g., Li₇La₃Zr₂O₁₂), Li₆La₃SnMO₁₂, Li_{6.75+x}La₃₋ₓSrₓZr_{1.75}Nb_{0.25}O₁₂ where 0.05≤x≤0.25 (LLSZN), and Li₂B₄O₇; the cathode materials LiCoO₂ (LCO), LiFePO₄ (LFP), LiNiCoAlO₂ (NCA), LiMn₂O₄ (LMO), and LiNi_{0.5}Mn_{1.5}O₄ (LNMO); the anode materials Li₃VO₄ (LVO), and Li₄Ti₅O₁₂; the electrical conductors 12CaO-7Al₂O₃ (C12A7), InₓSn₁₋ₓO₂ where 0<x<1 (ITO), and ZnO; and also Y₂O₃, ZrO₂, NiAl₂O₄, NiO, Fe₂O₃, HfO₂, SiO₂, SrSnO₃, ZnSnO₃, BaSnO₃, RE₂O₃, AlxByPᵤLaₘLi_{z}RE1ₐSi_{b}RE2_{c}Zr_{d}YₑO_{f} where RE is a rare earth element, and the molar range of each element can be: x=0.05 to 0.99, y=0.00 to 0.99, u=0.0 to 3.0, m=2.0 to 3.5, z=2.5 to 10.5, a=0.05 to 3.5, b=0.01 to 1.0, c=0.25 to 5.0, d=0.0 to 2.0, and e=0.01 to 0.5, but preferably x=0.2 to 0.3, y=0.0 to 0.3, u=0.0 to 0.3, m=2.0 to 3.0, z=6.5 to 10.5, a=0.0 to 0.3, b=0.0 to 0.3, c=0.0 to 0.3, d=1.0 to 2.0, and e=0.01 to 0.2, CoₓLi_{y}Mn_{z}NₐP_{b}Ti_{c}O_{d}Ag_{d} where the molar range of each element can be: x=0.0 to 2.0, y=0.0 to 5.0, z=0.0 to 3.0, a=0.0 to 2.0, b=0.0 to 3.0, c=0.0 to 2.0, and d=0.0 to 10.0, NaₓZr_{y}Ti_{z}YₐAl_{b}Mg_{c}Li_{d}Oₑ where the molar range of each element can be: x=0.0 to 6.0, y=0.0 to 4.0, z=0.0 to 3.0, a=0.0 to 3.0, b=0.0 to 12.0, c=0.0 to 5.0, d=0.0 to 5.0, and e=0.0 to 22.0, and AlₓCo_{y}Ni_{z}YₐZr_{b}O_{c}, where the molar range of each element can be: x=0.0 to 6.0, y=0.0 to 5.0, z=0.0 to 3.0, a=0.0 to 2.0, and b=0.0 to 3.0. These ceramic precursor nanoparticles are processed into thin films in accordance with the present technology. Additional exemplary ceramic materials are described herein.

The ceramics can be at least one of doped or combined with conductive additives to form composites. Non-limiting examples of composites include Na-β″-Al₂O₃ can be doped with Ti, Zr, Mg, Mn, or Li; LLZO can be doped with Al to yield Li_{6.25}Al_{0.25}La₃Zr₂O₁₂ (Al:LLZO); MZP can be doped with Ce to yield Mg_{0.5}CeₓZr₂₋ₓ(PO₄)₃; LCO can be doped with Ni and/or Mn to yield LiNiₓMn_{y}Co_{z}O₂ (NMC) where 0≤x≤1, 0≤y≤1, 0≤z≤1, (e.g., LiNi_{0.33}Mn_{0.33}Co_{0.33}O₂ and LiNiₓMnCoO₂); LiCoO₂/Li₄SiO₄—Li₃PO₄/Ag; and LiNi_{0.33}Mn_{0.33}Co_{0.33}O₂/Li₄SiO₄—Li₃PO₄/Ag; C12A7 doped with rare earths; and SrSnO₃, ZnSnO₃, and BaSnO₃ doped with rare earths. Therefore, non-limiting examples of dopants include Al, Ga, In, Mn, Ca, Ba, Sr, Y, Nb, Ta, Si, Mo, RE rare earth elements (scandium (Sc), yttrium (Y), lanthanum (La), cerium (Ce), praseodymium (Pr), neodymium (Nd), promethium (Pm), samarium (Sm), europium (Eu), gadolinium (Gd), terbium (Tb), dysprosium (Dy), homium (Ho), Erbium (Er), thulium (Tm), ytterbium (Yb), and lutetium (Lu)), actinides, lanthanides, or combinations thereof. Non-limiting examples of conductive additives include silver (Ag), gold (Au), palladium (Pd), platinum (Pt), copper (Cu), lead (Pb), tungsten (W), titanium (Ti), and combinations thereof. These dopants and conductive additives can be provided by way of various of the above exemplary precursors. Additional dopants and conductive additives are described herein. In some embodiments, the ceramic is a composite comprising a first ceramic film having a thickness of less than or equal to about 100 μm and a second ceramic film having a thickness of less than or equal to about 100 μm stacked on top of the first ceramic film. In yet other embodiments, the current technology provides a composite ceramic film comprising a plurality of ceramic layers, each layer of the plurality having a thickness of less than or equal to about 100 μm, and wherein each layer of the plurality is individually the same or different from the remaining layers. As described in more detail below, synthesized nanopowders are dispersed in ethanol or other solvent with ball milling, where needed, with 1 to 5 wt. % of appropriate dispersant. These dispersions are settled for from 4 to 30 hours and then, the supernatant containing the stable dispersion is decanted, solvent is removed, and the resulting powders are dried at 20° to 100° C. in ambient air, nitrogen, argon, or under vacuum.

The recovered powders are used to formulate suspensions that are then cast onto a flexible substrate and subsequently dried and peeled off. The green films can be used as is or laminated; thermo-compressed to improve green densities; and sintered in a controlled ramp rate, peak temperature, dwell time, and atmosphere to induce, in some instances, reduction/nitridation of selected components of the nanopowders and to sinter to a desired characteristic partial or complete density of ceramic or composite thin films.

In some embodiments the dense sintered film can be coated with a thin layer of less than or equal to about 1 μm of a second ceramic materials to modify the electric or electrochemical properties, improve ionic or electric conductivity, or as a prelude to introducing a second or tertiary layer as part of a multilamination process.

In some embodiments, the thin ceramic films are free of or substantially free of pores. By “substantially free,” it is meant that less than or equal to about 15% or less than or equal to about 10% of the surface area of the thin ceramic films define pores. However, in other embodiments, the thin ceramic films are porous, i.e., from greater than or equal to about 1% to less than or equal to about 50% of the surface area of the thin ceramic films define pores. Here, the pores are optionally filled with a polymer, e.g., an ion conducting phase, that connects to an interface for increasing transfer speeds of ions, such as Li, Na, and Mg as non-limiting examples, or an electron conducting phase for increasing electronic conduction.

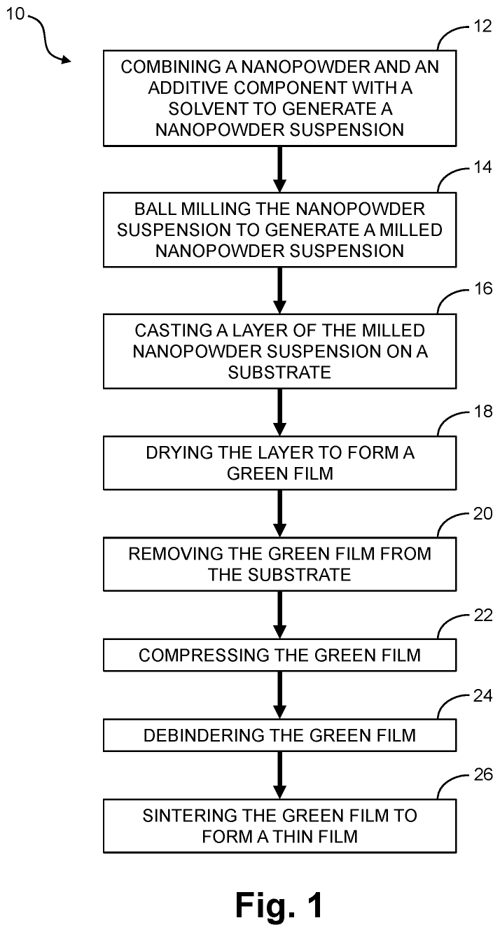

As shown in FIG. 1, the current technology provides a method 10 for making a thin film. The thin film comprises a single layer or a plurality of layers, i.e., composite films. As shown in FIG. 1, in block 12, the method 10 comprises combining a nanopowder and an additive component with a solvent to generate a nanopowder suspension. The nanopowder suspension has a nanopowder concentration of greater than or equal to about 1 vol. % to less than or equal to about 75 vol. % or greater than or equal to about 5 vol. % to less than or equal to about 50 vol. %.

As described further below, the nanopowder comprises nanoparticles having an average diameter of less than or equal to about 500 nm, less than or equal to about 250 nm, less than or equal to about 100 nm, or less than or equal to about 50 nm. The nanoparticles are composed of a material selected from the group consisting of oxides, carbonates, carbides, nitrides, oxycarbides, oxynitrides, oxysulfides, and combinations thereof. The nanoparticles can include components selected from the group consisting of group IA elements, group IIA elements, group IIIA elements, transition metals, lanthanide metal, actinide metals, group MB elements, group IVA elements, group VA elements, oxides thereof, phosphates thereof, nitrides thereof, carbides thereof, and combinations thereof. In some aspects, the nanoparticles are composed of compositions of the formula [MO]_{0.y}[Al₂O₃]_{1.0-y}, where M is selected from the group consisting of group IA elements, group IIA elements, group IIIA elements, transition metals, lanthanide metal, actinide metals, group IIIB elements, group IVA elements, and group VA elements; and y is a number from 0 to 1. As non-limiting examples, the nanopowder can includes nanoparticles of Li_{6.25}Al_{0.25}La₃Zr₂O₁₂, LiMn₂O₄, Li₂B₄O₇, Al₂O₃, Y₂O₃, ZrO₂, NiAl₂O₄, NiO, Fe₂O₃, HfO₂, SiO₂, RE₂O₃ (rare earth, lanthanide, actinide), and combinations thereof. The nanopowder can be made by liquid-feed flame spray pyrolysis (LF-FSP), co-precipitation, or sol-gel synthesis. However, LF-FSP consistently generates nanopowders that are suitable for generating thin films. Although not shown in FIG. 1, in some aspects of the current technology, the method 10 comprises generating the nanopowder by LF-FSP. Nanopowder generation by LF-FSP is described in further detail below.

In various embodiments, the nanopowder suspension includes a dopant. The dopant can be a second nanopowder, i.e., a doping nanopowder, or a doping material (also referred to as a “doping element”). The dopant can also be a plurality of dopants. Doping results, as non-limiting examples, in the addition of Al³⁺, Ga³⁺, In³⁺, Mn²⁺, Ba²⁺, Sr²⁺, Y³⁺, Nb⁵⁺, Ta⁵⁺, Si⁴⁺, Mo⁵⁺, RE³⁺ rare earth, actinides, lanthanides, or combinations thereof into the thin film. Therefore, non-limiting examples of dopants include Al, Ga, In, Mn, Ca, Ba, Sr, Y, Nb, Ta, Si, Mo, rare earth metals, actinides, lanthanides, and combinations thereof. Rare earth metals include cerium (Ce), dysprosium (Dy), erbium (Er), europium (Eu), gadolinium (Gd), holmium (Ho), lanthanum (La), lutetium (Lu), neodymium (Nd), praseodymium (Pr), promethium (Pm), samarium (Sm), scandium (Sc), terbium (Tb), thulium (Tm), ytterbium (Yb), and yttrium (Y).

The solvent can be any solvent that suspends the nanopowder. Therefore, the solvent does not solubilize the nanopowder. Non-limiting examples of suitable solvents include water, methanol, ethanol, propanol, butanol, xylene, hexane, methyl ethyl ketone, acetone, toluene, or combinations thereof. When the solvent includes two components, such as, for example, ethanol and xylene, ethanol and methyl ethyl ketone, ethanol and acetone, or ethanol and toluene, the two components are present at a ratio of from about 10:90 to about 90:10, or from about 30:70 to about 70:30. However, it is understood that the solvent can include one, two, or more than two components.

The additive component includes at least one of a dispersant, a binder, and a plasticizer. However, it is understood that the nanopowder suspension can contain at least one dispersant, at least one binder, and/or at least one plasticizer.

The dispersant is soluble in the solvent and lowers the viscosity of the suspension. Non-limiting examples of suitable dispersants include polyacrylic acid, bicine, citric acid, steric acid, fish oil, phenylphosphonic acid, phosphoric acid, ammonium polymethacrylate, organosilanes, and combinations thereof. When present, the dispersant has a concentration in the nanopowder suspension of greater than or equal to about 0.1 wt. % to less than or equal to about 5 wt. % or greater than or equal to about 1 wt. % to less than or equal to about 3 wt. %.

In some aspects of the current technology, the dispersant is added at the time the nanopowder is combined with the binder and plasticizer. In other aspects, the dispersant is associated with the nanopowder when the nanopowder is combined with the binder and plasticizer. For example, the nanopowder can be washed prior to being combined with a solvent. Washing the nanopowder includes suspending the nanopowder in a solvent that comprises a dispersant to generate a primary suspension. The solvent is a solvent or mixture of solvents described above. The primary suspension is mixed, such as, for example, by ball milling, and the primary suspension is then settled for greater than or equal to about 30 minutes to less than or equal to about 30 hours (or longer). Settling causes larger powders and impurities, if any, to settle and for the solvent to generate a supernatant. After the settling, the supernatant is removed, for example, by decanting, and the resulting washed nanopowder is dried at ambient temperature or a temperature of greater than or equal to about 20° C. to less than or equal to about 100° C. in ambient air, in an environment comprising an inert gas, such as, for example, nitrogen, helium, neon, argon, or xenon, or under vacuum. The dried nanopowder remains associated with the dispersant.

The binder is provided to bind the nanoparticles together. Non-limiting examples of suitable binders include polyvinyl butyral, polyvinyl acetate, methyl cellulose, ethyl cellulose, polyacrylate esters, polyurethane, polyethylene glycol, acrylic compounds, polystyrene, polyvinyl alcohol, polymethylmethacrylate, polybutylmethacrylate, and combinations thereof.

When present, the binder has a concentration in the nanopowder suspension of greater than or equal to about 30 wt. % to less than or equal to about 50 wt. % or greater than or equal to about 35 wt. % to less than or equal to about 45 wt. %.

The plasticizer is added to promote plasticity and flexibility. Non-limiting examples of plasticizers include benzyl butyl phthalate, acetic acid alkyl esters, bis[2-(2-butoxyethoxy)ethyl] adipate, 1,2-Dibromo-4,5-bis(octyloxy)benzene, dibutyl adipate, dibutyl itaconate, dibutyl sebacate, dicyclohexyl phthalate, diethyl adipate, diethyl azelate, di(ethylene glycol) dibenzoiate, diethyl sebacate, diethyl succinate, diheptyl phthalate, diisobutyl adipate, diisobutyl fumarate, diisobutyl phthalate, diisodecyl adipate, diisononyl phthalate, dimethyl adipate, dimethyl azelate, dimethyl phthalate, dimethyl sebacate, dioctyl terephthalate, diphenyl phthalate, di(propylene glycol) dibenzoate, dipropyl phthalate, ethyl 4-acetylbutyrate, 2-(2-ethylhexyloxy)ethanol, isodecyl benzoate, isooctyl tallate, neopentyl glycol dimethylsulfate, 2-nitrophenyl octyl ether, poly(ethylene glycol) bis(2-ethylhexanoate), poly(ethylene glycol) dibenzoate, poly(ethylene glycol) dioleate, poly(ethylene glycol) monolaurate, poly(ethylene glycol) monooleate, poly(ethylene glycol) monooleate, sucrose benzoate, 2,2,4-trimethyl-1,3-pentanediol dibenzoate, trioctyl timelitate, and combinations thereof. When present, the plasticizer has a concentration in the nanopowder suspension of greater than or equal to about 30 wt. % to less than or equal to about 50 wt. % or greater than or equal to about 35 wt. % to less than or equal to about 45 wt. %.

Referring back to FIG. 1, in block 14, the method 10 comprises ball milling the nanopowder suspension to generate a milled nanopowder suspension. Ball milling is performed in a sealed container containing milling media. In various aspects of the current technology, the milling media is composed of a material that is present in the nanopowder. Non-limiting examples of milling media, which are chosen depending on the nanopowder being milled, include ZrO₂, Al₂O₃, SiC, Y:ZrO₂, agate, and combinations thereof. Ball milling is performed for a time of greater than or equal to about 0.5 hours to less than or equal to about 72 hours, greater than or equal to about 6 hours to less than or equal to about 48 hours, or greater than or equal to about 12 hours to less than or equal to about 24 hours. In some embodiments, ball milling is substituted with sonication with an ultrasonic horn. In yet other embodiments, both ball milling and sonication are performed.

After ball milling, in block 16, the method 10 comprises casting a layer of the milled nanopowder suspension on a substrate. The casting includes disposing or applying the milled nanopowder suspension directly onto a substrate to form a layer, wherein the layer comprises the milled nanopowder suspension. The casting can be performed by any method known in the art, such as for example, by bar coating, wire wound rod coating, drop casting, spin coating, doctor blading, dip coating, or spray coating. However, bar coating and wire wound rod coating provide thin layers with consistent thicknesses. The layers can have, for example, a thickness of greater than or equal to about 1 μm to less than or equal to about 500 μm, greater than or equal to about 1 μm to less than or equal to about 400 μm, greater than or equal to about 1 μm to less than or equal to about 300 μm, greater than or equal to about 1 μm to less than or equal to about 200 μm, or greater than or equal to about 1 μm to less than or equal to about 100 μm.

The substrate material is limited only by the intended use of the thin film. In some embodiments, the substrate can be composed of any material from which the layer can be removed. Put another way, the substrate cannot be composed of a material that sticks to the layer to such an extent that (after drying as described below) the layer cannot be removed from the substrate without damaging the layer. In other embodiments, the thin film is permanently bound to the substrate. For example, the substrate can be a thin material, which along with the thin film, form a bilayer. As non-limiting examples, the substrate can be composed of polyethylene terephthalate (PET; “polyester”), biaxially-oriented polyethylene terephthalate (BoPET, also known as MYLAR® BoPET), polytetrafluoroethylene (PTFE, also known as TEFLON® PTFE), plastics, including polystyrene, polypropylene, polyvinyl chloride, nylon, poly(methyl methacrylate), rubber, metal, steel, stainless steel, thin sheets of metal or steel (such as a foil), graphite foil (also known as Grafoil® graphite foil), and glass.

In block 18, the method 10 comprises drying the layer. The drying is performed by incubating the layer at ambient temperature or room temperature, or a temperature of greater than or equal to about 20° C. to less than or equal to about 200° C. Incubating is performed for a time of greater than or equal to about 30 minutes to less than or equal to about 24 hours, or greater than or equal to about 2 hours to less than or equal to about 10 hours. The drying rate can be controlled by providing a solvent rich atmosphere. The drying removes at least a portion of the solvent and results in a dried nanopowder/polymer composite layer, also referred to herein as a “green film.” In some embodiments, the drying removes all or substantially all, i.e., at least about 90%, at least about 95%, at least about 98%, or at least about 99%, of the solvent to form the green film.

In block 20, the method 10 comprises removing the green film from the substrate. However, it is understood that that removing the green film from the substrate is optional. For example, when the substrate is to become a layer of a bilayer, then substrate is not removed. Removing can be performed by any method that does not damage the green film. For example, the removing can be performed manually (i.e., by hand), by using a prying object, or by using a gripping object, such as forceps. After it has been removed from the substrate, the dried layer (or bilayer when the substrate is not removed) can optionally be cut into any predetermined or desired shape and size. Cutting can be performed by any method, such as, for example, by using a die, a stamp, a scissors, a patterned silhouette, or a knife.

In block 22, the method 10 comprises compressing the green film to form a compressed green film. The compressing is performed at a pressure of greater than or equal to about 5 MPa to less than or equal to about 300 MPa, greater than or equal to about 50 MPa to less than or equal to about 200 MPa, or greater than or equal to about 75 MPa to less than or equal to about 150 MPa. In some embodiments, the compressing is performed with heat, i.e., by thermo-compressing. Compressing is performed, for example, by compressing between dies, flat platens (such as with a straight press), or calendars (such as with a roll press) at a temperature of greater than or equal to about 20° C. to less than or equal to about 250° C., or greater than or equal to about 50° C. to less than or equal to about 200° C. Compressing or thermo-compressing removes pores and aligns polymer molecules. In some embodiments, the compressing is optional.

In block 24, the method 10 includes debindering (binder burnout) the dried nanopowder/polymer composite layer (the green film). When the method includes compressing, the debindering can be performed before or after the compressing. Nonetheless, it is preferred that debindering is performed after compressing. Debindering is performed by subjecting the green film to a temperature of greater than or equal to about 300° C. to less than or equal to about 700° C. for a time of greater than or equal to about 0.25 hours to less than or equal to about 10 hours. Debindering burns out the additive components to yield a debindered film.

In block 26, the method 10 comprises sintering the debindered film, to densify and form the film, i.e., a film. Sintering comprises heating the debindered film to a temperature of greater than or equal to about 700° C. to less than or equal to about 1700° C. for a time of greater than or equal to about 1 hour to less than or equal to about 48 hours. In various aspects, the sintering is performed in a controlled environment, such as an environment comprising an inert gas (e.g., nitrogen, helium, neon, argon, and xenon), CO₂, or a combination thereof. The sintered thin film has a thickness of greater than or equal to about 500 nm to less than or equal to about 500 μm, or greater than or equal to about 1 μm to less than or equal to about 250 μm, such as a thickness of less than or equal to about 500 μm, less than or equal to about 400 μm, less than or equal to about 300 μm, less than or equal to about 200 μm, less than or equal to about 100 μm, or less than or equal to about 50 μm. and the sintered thin film also has an average grain size of less than or equal to about 15 μm, less than or equal to about 10 μm, less than or equal to about 7.5 μm, less than or equal to about 5 μm, less than or equal to about 2.5 μm, less than or equal to about 2 μm, less than or equal to about 1 μm, or less than or equal to about 0.1 μm. Because of the thin size, the film is at least one of visibly transparent (with or without tint) and flexible. In some embodiments, the debindering of block 24 and the sintering of block 26 are performed at the same time.

The method 10 can also be used to generate a multilayered thin film. Therefore, in various embodiments, the thin film is a multilayered thin film. For example, a first green film can be disposed onto a second green film before or after the second green film is removed from the substrate. The first green film and the At least one of the first and second green films can optionally be compressed. In some embodiments, the first and second green films are compressed at the same time, i.e., they are co-compressed. Moreover, the first and second green films can be composed of the same or different nanopowder including or not including a dopant. Additional green films can be added in a predetermined order, such as in an alternating order. The stacked green films are then optionally co-compressed and co-sintered to generate a composite thin film. In some aspects, a first dried film is disposed onto a second dried film, wherein one of the first or second dried films has previously been sintered.

In some embodiments, the nanopowder suspension includes a rare earth element dopant and the method 10 generates a ceramic thin film doped with the rare earth element. Rare earth elements include cerium (Ce), dysprosium (Dy), erbium (Er), europium (Eu), gadolinium (Gd), holmium (Ho), lanthanum (La), lutetium (Lu), neodymium (Nd), praseodymium (Pr), promethium (Pm), samarium (Sm), scandium (Sc), terbium (Tb), thulium (Tm), ytterbium (Yb), and yttrium (Y). Prior to sintering, a green or debindered ceramic thin film doped with the rare earth element is disposed onto a metal material, such as a metal foil, or a green metal film made according to the current technology to form a bilayer. Alternatively, the green or debindered ceramic thin film doped with the rare earth element is permanently made on a metal substrate (such as a metal foil) as a bilayer, i.e., there is no removing. If green, the ceramic thin film doped with the rare earth element is debindered. The bilayer is then sintered after optionally being thermo-compressed. The result is a composite bilayer thin film having a ceramic side (doped with the rare earth element) and an opposing metal side. By way of the metal side, the composite bilayer thin film can be disposed onto a material that conducts heat, such as metal, steel, or a thermally conductive polymer. When heat is transferred through the metal side of the composite bilayer thin film to the ceramic side (doped with the rare earth element), the ceramic side emits light as thermo-luminescence. Accordingly, various aspects of the current technology provide composite thin films that thermo-luminesce when heated.

The current technology also provides thin films, including composite multilayered thin films, made according to the method 10 of FIG. 1. The thin films are configured to be a battery cathode, catholyte (i.e., a cathode and electrolyte combination), electrolyte, anolyte (i.e., an anode and electrolyte combination), or an anode.

Casting is a process in which a suspension of well dispersed particles of oxides or composites in a selected aqueous or non-aqueous solvent containing additives such as binders, plasticizers and dispersants is spread onto a substrate at a fixed thickness to provide thin films or sheets, several microns to several hundred microns thick, of powder filled polymer composites. It is crucial to formulate a homogeneous suspension by carefully selecting compatible ingredients that stabilize the suspension over an extended period of time, such that particles remain well dispersed during the casting and drying processes.

MYLAR® BoPET is typically used as a substrate film, but any common flexible commercial polymer or metal film can be used as long as it is compatible with the formulated suspension, such that it does not react or hinder the uniform spreading of the suspension.

The cast green films can be rolled and stored for later use or for use in roll-to-roll processing of laminates or cut to desired shapes and thermo-compressed between dies, especially in continuous processes or flat platens heated at typical temperatures of 50°−200° C. to remove pores and align polymer molecules, especially using axial or biaxial calendaring of the green film. Based on the polymer volume fraction and polymer molecular weight and entanglement, the green films may or may not spread during pressing/calendaring; however, there will always be a reduction in thickness on compression. In instances where only high volume fraction polymer green films can be obtained due to constraints during suspension formulations, pressing/calendering may prevent spreading during further processing.

Rolled or cut green films can also be used to construct materials with discrete alternating layers of selected compositions by compressing two or more different green films.

The green body can then be subjected to an oxidizing binder burnout at 300°-700° C. to remove residual solvent, binder, plasticizer, and dispersant. Debindered films can also be laminated with polymer films, for example, containing materials that limit interfacial diffusion and/or subsequently sintered at 700°−1700° C. to produce target characteristic phases and densities, either fully dense or porous. They can also be treated in reducing atmospheres to transform one or more component to the metal or metal nitride, depending on conditions.

Compared to conventional casting, in which submicron to micron particle feedstocks are used, the current technology uses flame made nanoparticles, as described above, typically having sub-100 nm average diameters. Nanoparticles have very high surface area to volume ratios resulting in a large fraction of atoms residing at or near the surface of the powder, which are in higher energy compared to the bulk material. Hence, nanoparticles are known to have lower sintering temperature compared to sub-micron or micron particles, meaning full density can be reached at lower temperatures and with finer grain sizes on densification. Also, smaller grain sizes, below 3 μm but preferably below 500 nm, can be obtained by controlling sintering atmospheres or temperatures to modify microstructural evolution imparting higher mechanical strength compared to larger grained materials (greater than 5 μm) obtained when processing sub-micron or micron particles.

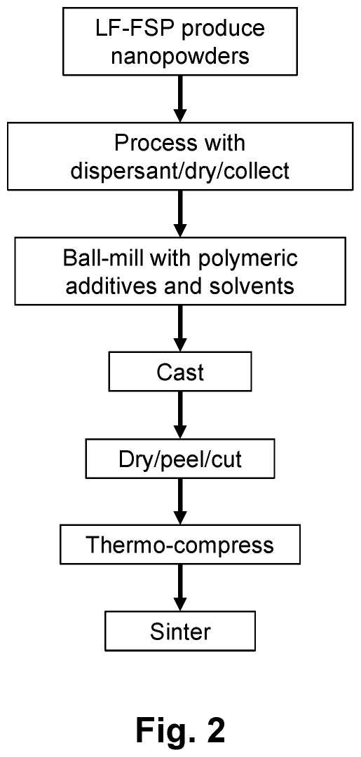

An exemplary method for preparing a film according to various aspects of the current technology is shown in FIG. 2. Nanoparticles that can be used for the current technology can be made by but are not limited to flame spray pyrolysis, co-precipitation, and sol-gel synthesis. However, it is preferred to start with liquid-feed flame spray pyrolysis made nanoparticles as they are typically spherical and have log normal size distributions that improve the packing density of green films, which in turn results in lower sintering temperature and allows minimization of residual porosity where so desired. Liquid-feed flame spray pyrolysis offers the added benefit of scalability, such that any developed process can be relatively easily transformed to industrial scale. Also, the selection of starting materials for green film formulation is easier, as similar chemicals can be used for processing a wide range of nanopowders with different compositions.

The suspension preferably contains a dispersant to lower the viscosity of the mix, either functioning by electrostatic or electrosteric hindrance. Suitable dispersants may be soluble in the selected solvent system. Examples include but are not limited to polyacrylic acid, bicine, citric acid, steric acid, fish oil, and phosphoric acid. Dispersants may be anchored (chemically bonded) to the surface hydroxyl of the powders before suspension formulation, or may be simply added at selected wt. %, preferably 1-3 wt. %, during suspension formulation. The suspension preferably contains a solvent or a mixture of solvents, either aqueous or non-aqueous, to impart low viscosity to the final mix. Suitable solvent systems will disperse the powders easily in the presence of a dispersant. Examples include but are not limited to mixtures of ethanol/xylene, ethanol/methyl ethyl ketone, ethanol/acetone, and ethanol/toluene. The volume ratio of solvents can range from 10/90-90/10, but preferably are 30/70-70/30.

The suspension preferably contains a binder that provides mechanical or green strength to the formed powder after solvent removal. Examples include but are not limited to polyvinyl butyral and polyethylene glycol. The binder should be soluble in the selected solvent system and should not hinder dispersion of the powder.

The suspension preferably contains a plasticizer, which alters the plasticity of the binder or the resulting green film. Examples include, but are not limited to, benzyl butyl phthalate.

The suspension preferably has solids loading of 40-60 vol. % (60-90 wt. %), but preferably 45-55 vol. % after solvent removal for easy handling, as well as high enough green density to reach 90+% relative densities on sintering. Lower solids loading green films may be intentionally processed if very thin films or low density or high porosity final sintered films are of interest.

The formulated suspension is ball-milled for 6-48 hours, but preferably 12-24 hours, in a sealed container using ZrO₂, Al₂O₃, or SiC milling media. Any commercial milling media may be used as long as the milling media is composed in part of the elements comprising the processed material to prevent any possible contamination.

The cast green film may be dried at room temperature or at elevated temperatures of 40° C. to about 200° C., as long as it does not diminish green strength or powder dispersion during drying. It may also be air dried or a dried in a solvent rich atmosphere to control evaporation rates to prevent formation of surface skins that may hinder evaporation of solvent from the bulk resulting in extended drying time and or film distortion or cracking. It is also possible to dry films in a reactive atmosphere, such as CO₂ or partial CO₂, to produce some carbonate for use as a sintering aid.

The current technology can be used to process oxide solid electrolyte thin films for all-solid state batteries or solid oxide fuel cell components. In particular, materials and battery configurations are sought that offer performance superior to state-of-the-art (SOA) sodium batteries currently extant. Na-β″-Al₂O₃ based Na⁺ ion conductor ceramic oxides, in particular, have gained much attention due to their high electrochemical stability window (up to 6 V), stability in contact with sodium metal, and high ionic conductivities (10⁻⁴-10⁻³ S cm⁻¹ at ambient, depending on doping elements), making it a good candidate to use in solid state batteries that currently can only operate at temperatures in excess of 200° C. Also, use of a Na metal anode provides significant improvements in the energy densities of a given cell and is inherently safer than Li based batteries.

Na-β″-Al₂O₃ has mainly been produced in pellet forms, in which powders produced by solid-state reaction, co-precipitation, or sol-gel synthesis are calcined, ball-milled, and subsequently sintered at 1100-1200° C. for 10-40 hours covered in mother powder to obtain greater than 90% relative density samples. The powders can also be shaped into tubes prior to sintering. Another approach is to hot-press the powders at 1000-1100° C. for 1-4 hours at 40-60 MPa to achieve high densities greater than 95%.

All of these processes are energy intensive and have not previously appeared to provide viable thin films (10-50 μm). A further issue is that such films are anticipated to have such large grain sizes that they will be too fragile to further process into solid-state batteries. In contrast, it has been anticipated that hot-pressing may provide access to thin films with good mechanical properties, but the practical utility of such an approach for mass production of solid state batteries has yet to be proven economical and access to films 10-30 μm has not been demonstrated.

Other alternative processing routes to films include aerosol deposition, sol-gel dip coating, or pulsed later deposition, where film thicknesses range from several hundred nanometers to 10's of microns, although they suffer from low ionic conductivities of 10⁻⁸-10'S cm⁻¹. Scalability for films 10-20 μm is also questionable.

To date, no one has succeeded in producing dense Na-β″-Al₂O₃ (greater than 90% of theory) thin (10-30 μm thick) mechanically strong films with ionic conductivities equivalent to bulk (pellet, greater than 10⁻⁴ cm⁻¹) counterparts. However, it should be noted that Ionotec Ltd. produces pellets of Na-β″-Al₂O₃ that offer conductivities of 1.67 mS cm⁻¹ and that have been used in a Na battery that can function at room temperature. Unfortunately, only pellets 1-2 mm thick are produced, which is somewhat less than three orders of magnitude thicker than the films provided here.

In one embodiment, ceramic thin films of Na-β″-Al₂O₃ doped with selected elements are processed. The Al site can be partially replaced with Li⁺, Mg²⁺, Ti⁴⁺, and Mn²⁺. Multiple doping elements can replace two or three sites at a time to give optimal sintering behavior and electrochemical properties. The doping elements may be introduced in the precursor solution as a metalloorganic precursor, such that as-produced powders are doped with the selected elements. The doping elements may also be introduced by means of solid-state reactions, in which dopant nanopowders are separately produced by flame spray pyrolysis processes and introduced during suspension formulation. The current technology provides electrochemically active components made according to the methods described herein. As used herein, “electrochemically active components” are components that conduct electrons or ions. The electrochemically active components are ceramic thin films or ceramic composite thin films. In some embodiments, an active material layer is a composite of active material, solid electrolyte, and current collector. Combinations in which no or minimal reaction byproducts are produced during sintering are selected so that the sintered product is dense, maintains the original or achieves the target phases, and shows good thermodynamic and electrochemical stability. Each component or precursors of each component can be ball-milled together to form a stable suspension, which is then cast, sintered, and debindered. Non-limiting examples of active materials, either cathode, anode, or electrolyte include LiNiₓMn_{y}Co_{z}O2 (0≤x≤1, 0≤y≤1, 0≤z≤1), Li_{1+x+y}AlₓTi₂₋ₓSi_{y}P_{3-y}O₁₂ (0≤x≤1 and 0≤y≤1; LATSP), Li₃VO₄, and combinations thereof. Non-limiting examples of solid electrolyte include Li₃PO₄₋₍₁₋ₓ₎Li₄SiO₄ solid solution (x=0-1), doped Li₇La₃Zr₂O₁₂ based materials, and combinations thereof. Non-limiting examples of current collectors include Ag, Au, Pd, Pt, Cu, Pb, W, Ti, and combinations thereof. The electrochemically active component can be a battery (lithium ion, sodium ion, magnesium ion, or other), a thermal electric generator, a high temperature fuel cell, a gate dielectric or other device.

The current technology may be used to produce cathode thin films for lithium and sodium ion battery applications. There is a drive to process thin films of lithium (sodium) ion battery cathode materials at lower sintering temperatures to minimize inter-diffusion when adjoining with the electrolyte layer.

In one embodiment, composite battery cathode thin films are processed, rather than simple thin films, allowing the introduction of current carrying components. As an example, thin films of LiCoO₂ mixed with nano-silver powder and xLi₄SiO₄-(1−x)Li₃PO₄ (0≤x≤1) solid solution are processed where Co sites may be replaced with selected doping elements to improve cycle-ability and/or capacity. Dopants can be introduced in the same manner as described in doping of Na-β″-Al₂O₃.

The process of this current technology may be used to produce ceramic-metal (cermet) composites as noted above for nano-silver composites. Such composites are of interest due to their utility in cathode and anode materials, in that the metal can serve as a conduit for electrons leaving or returning during charge/discharge, complementing the movement of Na⁺ or even Li⁺. The ceramic and metal may also be intermixed to grant isotropic properties. Metals used here are introduced during forming of the green films. Alternately, it may be useful to use metal oxide nanopowders that on reduction in flowing hydrogen, form a conducting phase.

The process of the current technology may be used to produce oxide composites, in which more than one oxide are intermixed within the bulk of the film, for example LiCoO₂/Li₄SiO₄—Li₃PO₄/Ag and LiMn_{0.33}Ni_{0.33}CO_{0.33}O₂/Li₄SiO₄—Li₃PO₄/Ag. Such examples are meant to be illustrative and not limiting. Individual oxides may be produced and mixed at a selected ratio during the suspension formulation or metalloorganic precursors corresponding to the final composition may be dissolved in alcohol and combusted, such that the as-produced powder has the final composition.

In accordance with the current technology, a nanopowder or nanopowder mixture of single or multiple metal oxides/carbonates/metal is mixed with a polymer binder and a solvent such that sufficient viscosity is achieved to permit forming a thin film using, for example, a doctor blade, a wire wound roller coater, or any other method described herein. The nanopowders can include mixtures of group IA, IIA, IIIA, transition metal, lanthanide and/or actinide metals, group IIIB, IVA and VA elements or their oxides, phosphates or combinations thereof. The polymer binder can be any polymer or mixture of polymers including, for example, polymethylmethacrylate, polybutylmethacrylate, polyacrylic acid, benzyl butyl phthalate, polyvinyl butyral, and combinations thereof, where these examples are exemplary but not meant to be limiting, and solvents including, for example, water, acetone, ethanol, propanol, ethylene glycol or other polar solvents including methylethyl ketone, and combinations thereof, such that drying occurs sufficiently slowly to limit or eliminate cracking.

Thereafter, the film can be warm pressed or calendared, especially with another film of another material or two more films of the same or different nanopowder/polymer composites, as needed, to form laminated green films. The second material can be a thin film of an interfacial precursor prior to adding an optional third film. The resulting films can then be heated or photochemically treated to further crosslink polymers or additives or both and thereafter heated to between 300° and 700° C. at heating rates that gently decompose the binder and additives in air, argon, nitrogen or other gas to control the rate of and mechanism of decomposition to ensure that the resulting films have sufficient mechanical strength to be further processed. Resulting debindered films can then be laminated with a second film, coated with a interfacial coating of a ceramic precursor or a ceramic powder to control or limit interfacial diffusion of undesirable ions or to dope the first layer or a second layer laminated above this middle layer with the goal of passivating the interface against degradative processes that can occur during further processing or when the multilayer ceramic is used in specific applications, as exemplified by fuel cell or lithium, sodium, or sulfur battery electrolyte. It is understood that these examples are non-limiting.

Thereafter, the debindered film or laminate can be heated in a controlled atmosphere of, for example, nitrogen, argon, air and in the absence of air up to about 20 vol. % H₂, for example, to aid in the densification of the thin films, while also selectively converting one or more metal oxides to the metal, while keeping other metal oxides intact during the densification process. In some instances, excess of one oxide component in multiple chemical forms can be introduced at the outset as a sacrificial component that will be lost as, for example, P₂O₅ or B₂O₃ or Na₂O during processing, such that the final composition is targeted. As an alternative, a coating of this type of sacrificial material may be added prior to sintering to minimize outgassing of the same component to ensure that the final stoichiometry is that targeted. It is also possible to add an interfacial coating at this stage prior to mating films or laminates to make thicker multilayer films, while protecting against interdiffusion. Sintering can be undertaken by heating samples at rates of 1° to 30° C./min to temperatures that promote densification, while also minimizing loss of volatile components. In particular, it is possible to heat rapidly to a temperature above the most desirable sintering temperature for a very short time to initiate formation of a liquid sintering aid and then rapidly cool to a lower temperature to continue densification, where loss of volatile components are reduced or eliminated. It is also possible to heat under gas pressure to further promote densification if all open porosity has been eliminated.

In some embodiments, the nanopowder compositions comprise either single or multi-element oxide nanoparticles and mixtures thereof with the general composition AlxByPᵤLaₘLi_{z}RE1ₐSi_{b}RE2_{c}Zr_{d}YₑO_{f} where RE is a rare earth element, and the molar range of each element can be: x=0.05 to 0.99, y=0.00 to 0.99, u=0.0 to 3.0, m=2.0 to 3.5, z=2.5 to 10.5, a=0.05 to 3.5, b=0.01 to 1.0, c=0.25 to 5.0, d=0.0 to 2.0, and e=0.01 to 0.5, but preferably x=0.2 to 0.3, y=0.0 to 0.3, u=0.0 to 0.3, m=2.0 to 3.0, z=6.5 to 10.5, a=0.0 to 0.3, b=0.0 to 0.3, c=0.0 to 0.3, d=1.0 to 2.0, and e=0.01 to 0.2.

The choice of ratios is defined by the sintering conditions required to produce thin films of Na-β″-Al₂O₃ with densities greater than 90%, grain sizes less than about 10 μm, and preferably less than 5 μm, and most preferably smaller than about 3 μm, where the films are less than about 50 μm thick, and preferably less than 40 μm thick, and most preferably less than about 20 μm thick, but with sufficient mechanical properties to be layered into laminates or coated with polymer films or used in the production of all solid state batteries without undergoing brittle failure.

In some embodiments, the nanopowder compositions comprise either single or multi-element oxide nanoparticles and mixtures thereof with the general composition, CoₓLi_{y}Mn_{z}NₐP_{b}Ti_{c}O_{d} Ag_{d}, where the molar range of each element can be: x=0.0 to 2.0, y=0.0 to 5.0, z=0.0 to 3.0, a=0.0 to 2.0, b=0.0 to 3.0, c=0.0 to 2.0, and d=0.0 to 10.0.

In some embodiments, the nanopowder compositions comprise either single or multi-element oxide nanoparticles and mixtures thereof with the general composition, NaₓZr_{y}Ti_{z}YₐAl_{b}Mg_{c}Li_{d}Oₑ where the molar range of each element can be: x=0.0 to 6.0, y=0.0 to 4.0, z=0.0 to 3.0, a=0.0 to 3.0, b=0.0 to 12.0, c=0.0 to 5.0, d=0.0 to 5.0, and e=0.0 to 22.0.

On sintering, two or three phases are generated in the resulting thin film, including β″ alumina and yttria stabilized zirconia.

In some embodiments, the nanopowder compositions comprise either single or multi-element oxide nanoparticles and mixtures thereof with the general composition, AlₓCo_{y}Ni_{z}YₐZr_{b}O_{c}, where the molar range of each element can be: x=0.0 to 6.0, y=0.0 to 5.0, z=0.0 to 3.0, a=0.0 to 2.0, and b=0.0 to 3.0.

In some embodiments, the thin films are produced using wire wound roller coating and thereafter debindering and then sintering in a controlled atmosphere with a heating rate of less than 25° C./min, and preferably less than 15° C./min, such that the final grain sizes are preferably less than about 5 μm for 50 μm thick films, and most preferably smaller than about 3 μm for 20 μm thick films, and where any residual pores are less than 1 μm, and preferably less than 0.5 μm, in diameter.

In some embodiments, the thin films are heated on a substrate that is inert to the film being processed including zirconia, yttrium aluminum garnet, graphite and diamond-like carbon, where the atmosphere is non-oxidizing but can be reducing and where the sintering temperature is below the decomposition or melting temperature of the substrate.

In some embodiments, the sintering temperature can be as high as 1400° C. for 30 minutes and then held at 1200° C. for 1 hour, or more preferably to 1150° C./30 minutes and held at 1060 for 1 hour, and most preferably to 1100° C. for 20 minutes or less and then at 1080° C. for 1 hour.

In some embodiments, rapid heating to temperatures between 850° C. and 1300° C., preferably between 950° C. and 1250° C., occurs at ramp rates of 5 to 30° C./min, but preferably 10-20, and most preferably 10-15.

In some embodiments, rapid heating in an atmosphere of 02, synthetic air, Ar, N₂, or H₂/N₂ mixtures 5:95 to 20:80 is appropriate.

Embodiments of the present technology are further illustrated through the following non-limiting examples.

### Example 1

Summary

Commercial β″-Al₂O₃ solid electrolytes for Na⁺ batteries are produced at very high temperatures and are typically 1-3 mm thick. High sintering temperatures combined with Na₂O loss and excessive grain growth complicates processing of β″-Al₂O₃ thin films (less than or equal to about 100 μm), which can potentially reduce cell resistance and even permit room temperature operations. Here, high surface area flame made nanopowders at selected compositions are utilized to drive densification to produce β″-Al₂O₃ thin films with controlled microstructures and Na₂O loss to maintain a high β″-Al₂O₃ fraction. Through processing optimization, dense (greater than or equal to about 95%) and thin (greater than or equal to about 50 μm) β″-Al₂O₃ films offering superionic conductivity (greater than or equal to about 1 mS cm⁻¹) are obtained.

Experimental

Precursor synthesis and powder production.

Sodium propionate [NaO₂CCH₂CH₃] is synthesized by reacting sodium hydroxide (80 g, 2 mole) with propionic acid (445 g, 6 mole) in a 1 L round bottom flask equipped with a still head at 130° C. in N₂ atmosphere. Once transparent liquid is obtained, heat is removed and sodium propionate crystallized on cooling is filtered out. Magnesium propionate [Mg(O₂CCH₂CH₃)₂] is synthesized by reacting magnesium hydroxide (58 g, 1 mole) with propionic acid (445 g, 6 mole), following the same procedure. Alumatrane [Al(OCH₂CH₂)₃N], titanatrane {Ti(OCH₂CH₂)₃N[OCH₂CH₂N(CH₂CH₂OH)₂]}, and zirconium isobutyrate {Zr[O₂CCH(CH₃)₂]₂(OH)₂} are also synthesized.

Sodium propionate, alumatrane, and magnesium propionate are dissolved in ethanol at a selected molar ratio, resulting in a Na_{1.67}Al_{10.33}Mg_{0.67}O₁₇ (NAMO) composition with 50 wt. % excess sodium. The precursor solution with 3 wt. % ceramic loading is aerosolized and combusted to generate nanoparticles using the liquid-feed flame spray pyrolysis (LF-FSP) apparatus. Nanopowders of TiO₂ and ZrO₂ are also prepared by aerosol combusting titanatrane and zirconium isobutyrate, respectively.

Powder and Film Processing.

All as-produced nanopowders (NPs) are dispersed in EtOH (200 proof, Decon Labs) with 4 wt. % bicine (Sigma-Aldrich) dispersant, using an ultrasonic horn (Vibra cell VC-505, Sonics and Materials, Inc.) at 100 W for 10 minutes. After 4 hours of settlement, supernatant is decanted and dried. TiO₂ and ZrO₂ at selected wt. % are added to NAMO during the initial suspension formulation. Table 1 lists target compositions of the mixed nanopowder systems used.

TABLE 1
Compositions studied (wt. %).

| | TiO₂ | ZrO₂ |
|---|---|---|
| NAMO | 0 | 0 |
| NAMO-1TiO₂ | 1 | 0 |
| NAMO-2TiO₂ | 2 | 0 |
| NAMO-2TiO₂—10ZrO₂ | 2 | 10 |
| NAMO-3TiO₂ | 3 | 0 |
| NAMO-3TiO₂—10ZrO₂ | 3 | 10 |

Table 2 lists components that are used for formulating NAMO-2TiO₂-10ZrO₂ green films, shown as a representative example. All components are added to a 20 ml vial and ball-milled with 3.0 mm diameter spherical ZrO₂ beads for 24 hours to homogenize the suspension. Suspensions are cast on a MYLAR® polyethylene terephthalate substrate using a wire wound rod coater (Automatic Film Applicator-1137, Sheen Instrument, Ltd.). Dried green films are manually peeled off the MYLAR® polyethylene terephthalate substrate, cut to selected sizes, and thermo-compressed at 80-100° C. with a pressure of 30-40 MPa for 5 minutes using a heated bench top press (Carver, Inc.) to improve packing density. Resulting green films are 80±2 μm thick.

TABLE 2
Example of suspension formulation (NAMO-2TiO₂—10ZrO₂).

| | Role | Wt. ratio |
|---|---|---|
| NAMO (with bicine) | Ceramic (dispersant) | 25.5 |
| ZrO₂ (with bicine) | Ceramic (dispersant) | 2.95 |
| TiO₂ (with bicine) | Ceramic (dispersant) | 0.58 |
| Polyvinyl Butyral | Binder | 4.69 |
| Benzyl Butyl Phthalate | Plasticizer | 4.69 |
| Propanol | Solvent | 30.9 |
| Acetone | Solvent | 30.4 |

Green films are heated to selected temperatures and dwell times in a box furnace (KSL-1700X, MTI Corporation), placed in between Al₂O₃ disks (AdValue Technology) to prevent sample warping.

Characterization

X-ray diffraction measurements are carried out using a Rigaku Rotating Anode Goniometer. Scans are made from 5 to 70° 2θ, using Cu Kα radiation (1.541 Å) operating at 40 kV and 100 mA. The Jade program 2010 (Materials Data, Inc.) is used for analysis.

Specific surface areas (SSAs) are obtained using a Micromeritics ASAP 2020 sorption analyser. Samples (300 mg) are degassed at 150° C./5 hours. Each analysis is run at −196° C. (77 K) with N₂. The SSAs are determined by the BET multipoint method using ten data points at relative pressures of 0.05-0.30. SSA is then converted to average particle sizes (APS) using the equation APS=6/(SSA×ρ). The net density (ρ) of the as-produced NP is approximated by rule of mixtures.

Scanning electron microscopy (SEM) micrographs are taken using FEI NOVA Nanolab SEM and Philips XL-30 SEM. Powder samples are used as is and sintered films are fractured for imaging. All samples are sputter coated with Au/Pd using a SPI sputter coater.

TGA/DTA characterization is performed using a Q600 simultaneous TGA/DSC (TA Instruments, Inc.) that is used to observe thermal decomposition of NPs and green films. Samples (15-25 mg) are loaded in alumina pans and ramped to 900° C. at 10° C. min⁻¹ under constant air flow at 60 ml min⁻¹.

Room temperature AC impedance data is collected with SP-300 (Bio-Logic LLC) in a frequency range of 7 MHz to 1 Hz. Concentric Au/Pd electrodes, 3 mm in diameter, are deposited using a SPI sputter coater on both surfaces of the films using a deposition mask. “EIS spectrum analyser” software is used for extracting total resistance. Equivalent circuits consisting of (RₜₒₜₐₗQₜₒₜₐₗ)(Q_{electrode}) are used. R and Q denote resistance and constant phase elements, respectively. SEM fracture surface images are taken to measure sample thicknesses.

Final sintered film densities are determined by the Archimedes method using ethanol.

Results and Discussion

Na-β″-Al₂O₃ thin (less than 25 μm), dense (greater than 95%) flexible films that also exhibit superior Na⁺ conductivity are processed as described above. Li⁺ conducting ceramic electrolytes of the same or similar dimensions and with ionic conductivities equal or superior to previously published properties can also be processed according to the above methods.

To establish the suitable through optimal processing conditions, it is necessary to fully characterize the starting NPs produced as described in the experimental section. Thereafter, the sintering behavior of the processed green films with selected wt. % of TiO₂ and ZrO₂ additions is characterized. The effects of sintering temperatures and additives on the microstructures and ionic conductivities are then compared.

Flame Made Nanopowders (NPs).

Na_{1.67}Al_{10.33}Mg_{0.67}O₁₇ (NAMO) is selected, as it is one of the standard compositions used in β″-Al₂O₃ synthesis and processing. Mg²⁺ dopant promotes the β″-Al₂O₃ phase formation, as excess Na is required to maintain charge neutrality.

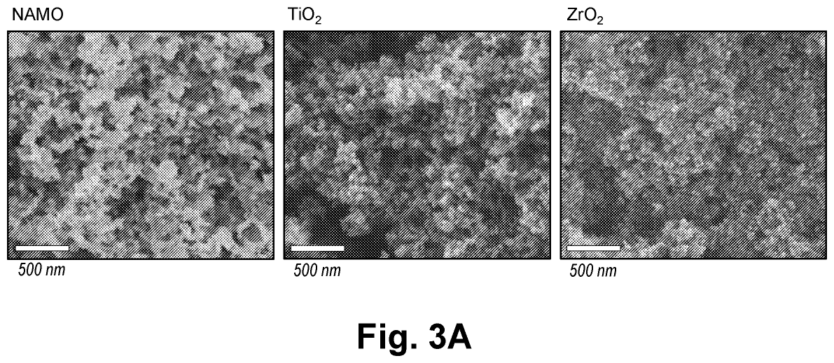

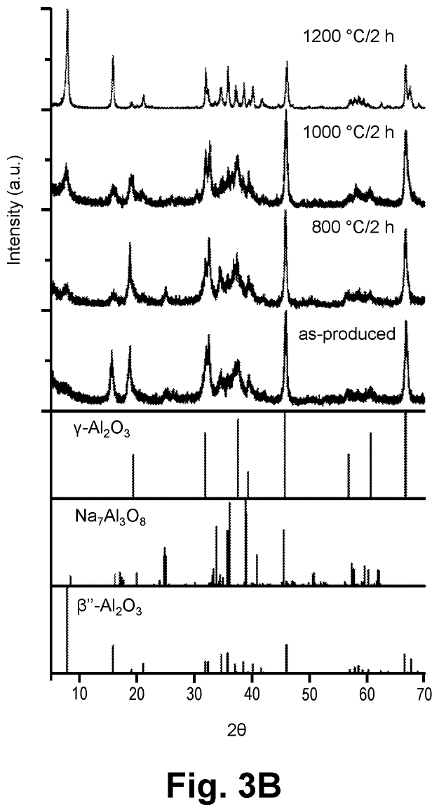

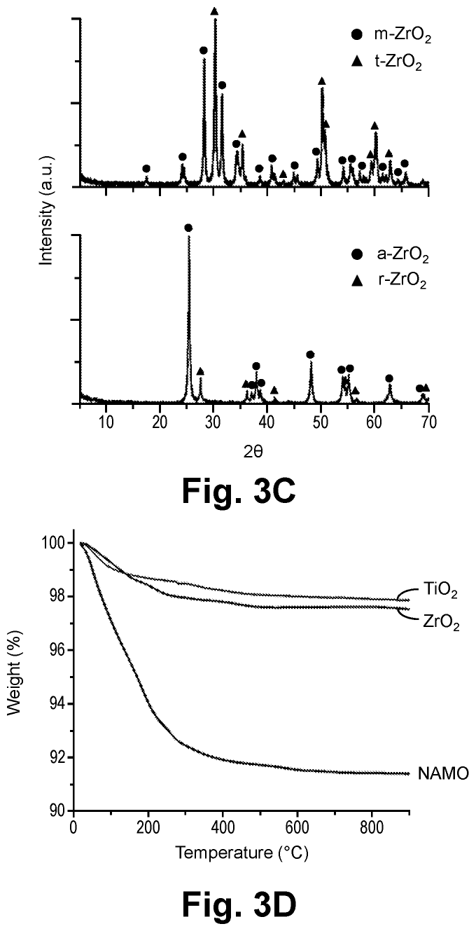

As-produced NPs are characterized by SEM, XRD, BET, and TGA-DTA to confirm particle sizes and morphologies, crystallographic phases present, and thermal stability. FIG. 3A shows the SEM images of the synthesized NPs. Specific surface areas (SSAs) that are obtained by BET are 52, 55, and 32 m² g⁻¹ for NAMO, TiO₂ and ZrO₂, corresponding to average particle sizes (APSs) of 36, 28, and 32 nm, respectively. Particles show narrow particle size distribution and rather spherical morphologies, typical of flame made NPs.

XRD patterns of the as-produced and calcined NAMO at selected temperatures are shown in FIG. 3B. The as-produced powder is a mixture of γ-Al₂O₃, β″-Al₂O₃, and Na₇Al₃O₈. Provided that LF-FSP produces kinetic, rather than thermodynamic phases, due to rapid pyrolysis and quenching involved, as-produced NPs are not single phase, but a mixture. Furthermore, the relative peak intensities of β″-Al₂O₃ are also disproportionate compared to the reference pattern. However, on heating, peaks that can be ascribed to γ-Al₂O₃ and Na₇Al₃O₈ gradually grow smaller and eventually disappear at 1200° C. as they react to form β″-Al₂O₃. Single-phase β″-Al₂O₃ forms at 1200° C. and the relative peak intensities align well with the reference pattern.

FIG. 3C depicts XRD patterns of as-produced ZrO₂ and TiO₂ NPs. It also shows a mixture of two phases, m-ZrO₂ (monoclinic) and t-ZrO₂ (tetragonal) for ZrO₂, and a-TiO₂ (anatase) and r-TiO₂ (rutile) for TiO₂, typical of flame made NPs.

FIG. 3D illustrates TGA curves of the as-produced NPs. The majority of mass loss takes place at less than 250° C., due to physi-/chemi-sorbed water on the powder surfaces. Higher mass loss of NAMO suggests its hygroscopic nature compared to TiO₂ and ZrO₂, consistent with prior studies. Absence of mass loss near the melting point of Na₂CO₃ (850° C.) indicates the as-produced powder contains no or little Na₂CO₃. DTA curves are not shown, as no noticeable endo-/exo-thermic peaks are observed.

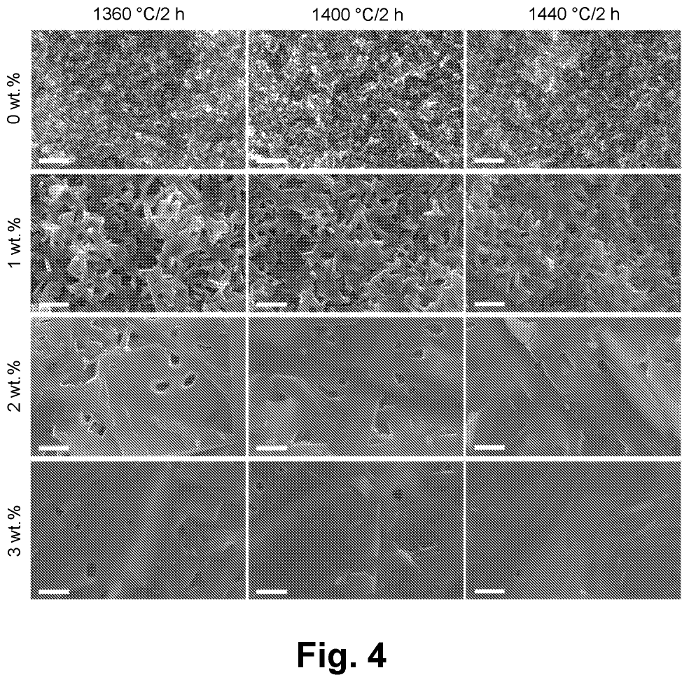

FIG. 4 compares the microstructures of the sintered NAMO with TiO₂ addition. When sintered without any additives, interconnected submicron plate-like grains are observed up to 1440° C. with limited densification. At fixed temperatures, denser microstructures are obtained with increasing TiO₂ additions. Grain sizes increase dramatically with 2 and 3 wt. % TiO₂ addition. The length of some of the plate-like grains surpass the field of the SEM images, whereas a number of grains are observed without TiO₂ addition, but less with 1 wt. % TiO₂.

Clearly, TiO₂ aids sintering. Indeed, Ti⁴⁺ dopant substitutes Al³⁺, thereby generating Al³⁺ vacancies, which enhance Al³⁺ diffusion rates. In addition, a number of low melting point (1030-1130° C.) TiO₂—Na₂O line compounds, such as Na₄TiO₄, Na₈Ti₅O₁₄, and Na₂Ti₃O₇ may form to induce liquid phase sintering.

High density microstructures are achieved at as low as 1360° C./2 hours. For example, NAMO with 3 wt. % TiO₂ addition sintered to 1360° C./2 hours is 98.4±1.0% dense, as determined by the Archimedes method. Here, the properties of the starting powder, particularly the nm length scale, must be a key factor driving densification when combined with proper sintering additives and sintering at the temperatures described herein.

In FIG. 4, at a fixed TiO₂ content, higher sintering temperatures lead to denser microstructures. Also, there are no macroscopic pores, but rather uniformly sized submicron pores due to small and uniform particle sizes of the starting powder. This is very important as the presence of macroscopic pores (greater than 10 um) at sample thicknesses of less than 100 um can result in non-uniform ion transport that local inhomogeneity can form during charge/discharge of a cell.

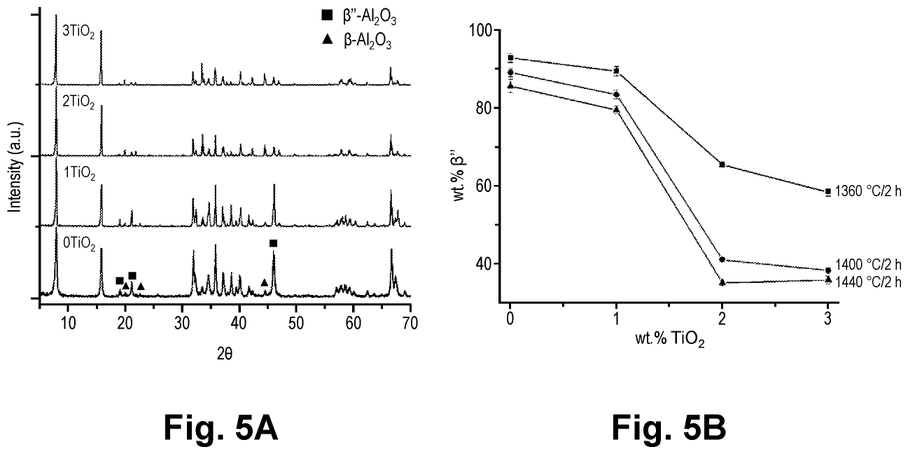

FIG. 5A shows XRD data for NAMO with various amounts of TiO₂, each sintered to 1400° C./2 hours. This data suggests that doping with TiO₂ promotes the β-Al₂O₃ phase. FIG. 5B shows that the β″-Al₂O₃ phase decreases with increasing temperature. As such, processing parameters must be tuned with care to maximize β″-Al₂O₃ phase content.

Effect of TiO₂ and ZrO₂ Addition on the Sintering Behavior of NAMO.

ZrO₂ NPs at 10 wt. % are introduced to NAMO-xTiO₂ (x=2, 3) with the object of controlling the final sintered microstructures. ZrO₂ or yttria-stabilized zirconia (YSZ; wherein yttria is Y₂O₃ and zirconia is ZrO₂) are mixed with β″-Al₂O₃ to increase the fracture toughness by mechanisms of stress induced phase transformation toughening (tetragonal to monoclinic ZrO₂) and crack deflection. Higher fracture toughness relates to higher critical current densities, such that batteries can stably operate at higher currents. ZrO₂ addition also promotes densification of β″-Al₂O₃, which in turn can increase the β″-Al₂O₃ fraction, as less Na₂O is lost at lower sintering temperatures or due to faster pore closure reducing sample surface areas. Furthermore, ZrO₂ can pin grain boundaries and prohibit grain growth, resulting in smaller, more equiaxed grain sizes. Briefly, ZrO₂ addition is an efficient method to produce strong and tough materials. However, since ZrO₂ does not conduct Na⁺, excessive addition results in higher resistance. Introduction of greater than 10 wt. % ZrO₂ can be associated with significant conductivity drops.

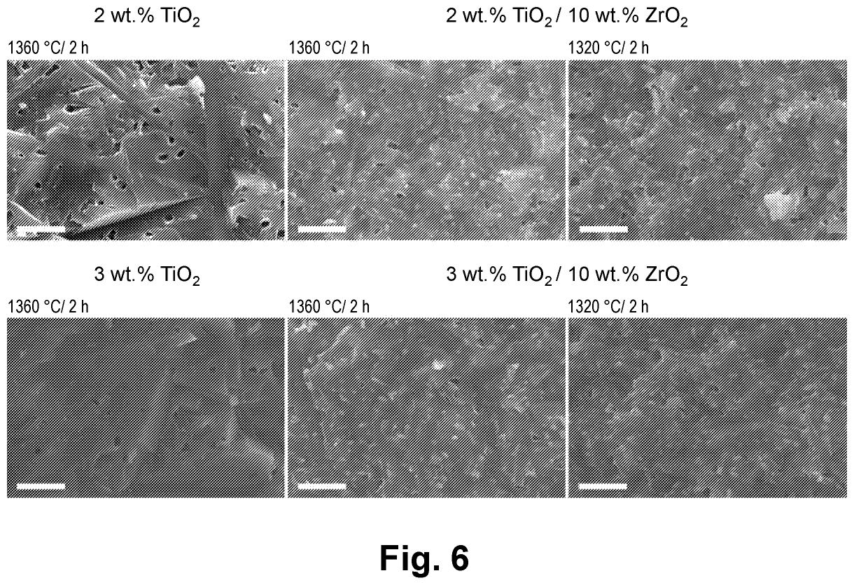

FIG. 6 compares SEM fracture surface images of the sintered NAMO-xTiO₂-10ZrO₂ (x=2, 3). With ZrO₂ addition, high density microstructures can be achieved at as low as 1320° C./2 hours. Compared to samples sintered without ZrO₂ additive, no large grains are observed, suggesting ZrO₂ successfully prohibits grain growth. The majority of ZrO₂ grains are 400-600 nm in size and well distributed within the β″-Al₂O₃ matrix, providing uniform properties throughout the material.

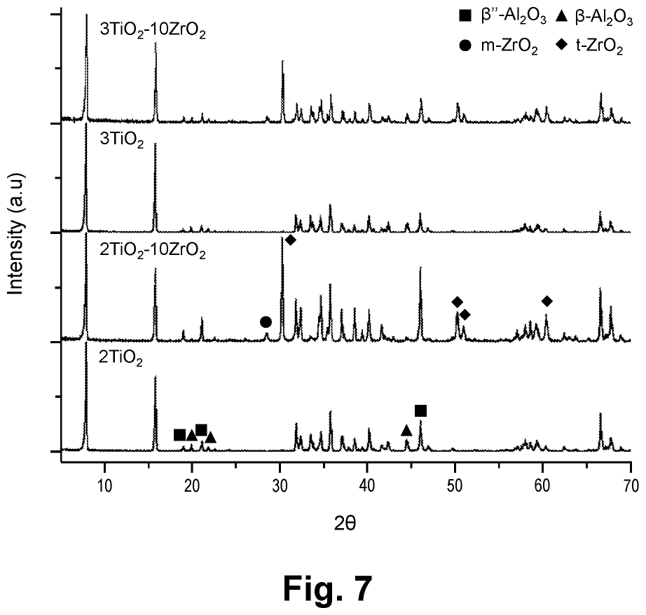

XRD patterns of the NAMO-xTiO₂ (x=2, 3) and NAMO-xTiO₂-10ZrO₂ (x=2, 3) sintered to 1360° C./2 hours are compared in FIG. 7. For samples with ZrO₂ addition, monoclinic and tetragonal ZrO₂ are present at 2-3 wt. % and 9-10 wt. %, respectively. Part of the introduced Ti⁴⁺ seems to have diffused into ZrO₂, stabilizing the tetragonal phase. Comparing NAMO-2TiO₂ and NAMO-2TiO₂-10ZrO₂, peak intensities of β″-Al₂O₃ relative to β-Al₂O₃ substantially increase with ZrO₂ addition. Preferred orientation attenuates as well, as evidenced by weaker relative peak intensities for peaks at approximately 8° and approximately 16° 2θ peaks compared to others. A similar trend it not observed for the 3TiO₂ counterpart. It appears ZrO₂ hosts TiO₂ and at 3 wt. % TiO₂, the amount of TiO₂ is still enough to induce preferred orientation through liquid phase sintering, although no large grains were observed.

Ionic Conductivities.

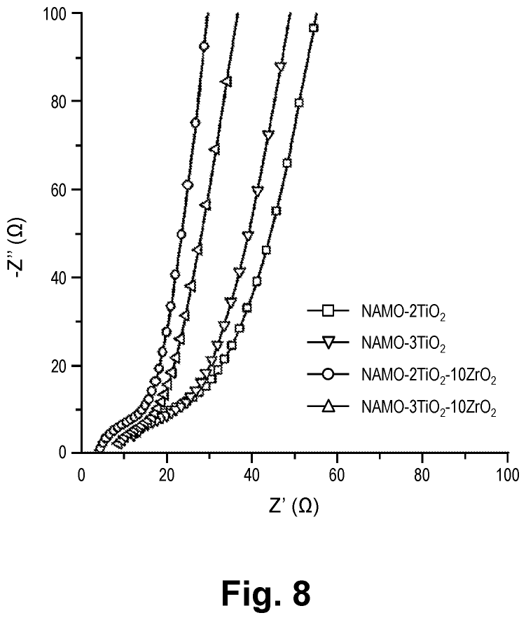

Table 3 compares the relative densities, ionic conductivities, and β″-Al₂O₃ fractions of high density samples. FIG. 8 is a Nyquist plot of NAMO-xTiO₂ (x=2, 3) and NAMO-xTiO₂-10ZrO₂ (x=2, 3) sintered to 1360° C./2 hours. All compositions show high conductivities greater than 1 mS cm⁻¹. Among them, conductivities of NAMO-2TiO₂ and NAMO-3TiO₂ sintered to 1360°/2 hours are on the lower end due to lower relative density and a lower β″-Al₂O₃ fraction, respectively. NAMO-2TiO₂-10ZrO₂ sintered to 1320 and 1360° C./2 hours show the highest ionic conductivities of 4-6 mS cm⁻¹ as a result of high relative densities and high β″-Al₂O₃ fractions. Note that 10-12 wt. % of ZrO₂ is present, suggesting a low β-Al₂O₃ fraction. NAMO-3TiO₂-10ZrO₂ sintered to 1320 and 1360° C./2 hours have slightly lower ionic conductivities of 3-4 mS cm⁻¹ due to lower β″-Al₂O₃ fractions. No reports on room temperature β″-Al₂O₃ are available, but the obtained conductivities are 3-6 fold higher compared to ambient conductivity of polycrystalline β-Al₂O₃. It is also comparable to those of NASICON.

TABLE 3
Summary of physical and electrochemical properties of high density films.

| | Sintering | Density | Relative | σ | β″ fraction |
|---|---|---|---|---|---|
| | schedule | (g cm⁻³) | density (%) | (mS cm⁻¹) | (wt. %) |
| NAMO-2TiO₂ | 1360° C./2 h | 3.07 ± 0.02 | 93.8 ± 0.6 | 2.2 ± 0.4 | 65.4 ± 0.9 |
| NAMO-2TiO₂—10ZrO₂ | 1360° C./2 h | 3.34 ± 0.04 | 96.0 ± 1.1 | 4.1 ± 0.7 | 82.3 ± 0.9 |
| | 1320° C./2 h | 3.32 ± 0.02 | 95.5 ± 0.7 | 5.4 ± 0.9 | 83.5 ± 0.9 |
| NAMO-3TiO₂ | 1360° C./2 h | 3.23 ± 0.03 | 98.4 ± 1.0 | 2.7 ± 0.1 | 58.4 ± 0.9 |
| NAMO-3TiO₂—10ZrO₂ | 1360° C./2 h | 3.40 ± 0.02 | 98.4 ± 0.7 | 3.7 ± 0.2 | 61.0 ± 0.9 |
| | 1320° C./2 h | 3.33 ± 0.03 | 96.5 ± 0.9 | 3.3 ± 0.1 | 70.0 ± 0.8 |

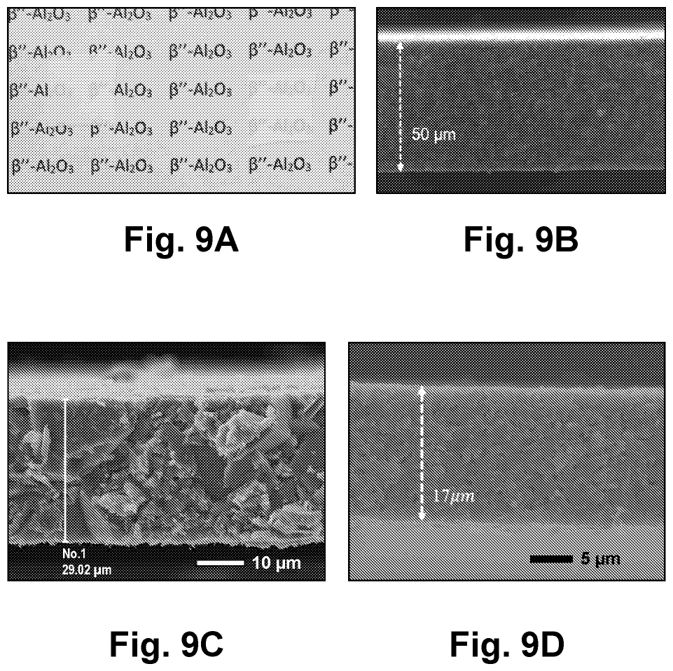

FIG. 9A is a photographic image of typical dense sintered films that are produced with dimensions of approximately 2×2 cm. Translucency is a result of high density and low thickness. All dense samples had sintered thickness of approximately 50 μm as shown in FIG. 9B. The film shown in FIG. 9C is about 29 μm thick and its conductivity is measured giving the surface an uneven cast due to electrode deposition. A second uncoated film having a thickness of about 17 μm is shown in FIG. 9D.

Galvanostatic Measurements of Na/NAMO/Na Symmetric Cell.

The cells used in this experiment are symmetric Na/NAMO/Na cells that are assembled in the fume hood using N₂ flow as a “semi-closed” environment. Before cell assembly, the metallic Na is scrapped to expose a clean surface. Na is pressed between a MYLAR® BoPET sheet to get a smooth and flat surface (approximately 0.9×0.9 mm² and 0.6 mm thickness). After MYLAR® BoPET removal, Na is rinsed in methanol and hexane solutions. Symmetric cells are constructed using the standard procedure in a coin cell. The coin cells are compressed using an approximately 300 kPa uniaxial pressure.

The symmetric cells are cycled at room temperature using a potentiostat/galvanostat (BioLogic SP300). The cell is tested for charge and discharge using DC steady state method at which a constant current is held (28 μA) and the resulting potential is measured over time. The Na-NAMO interface stability is characterized as a function of current density using galvanostatic cycling.

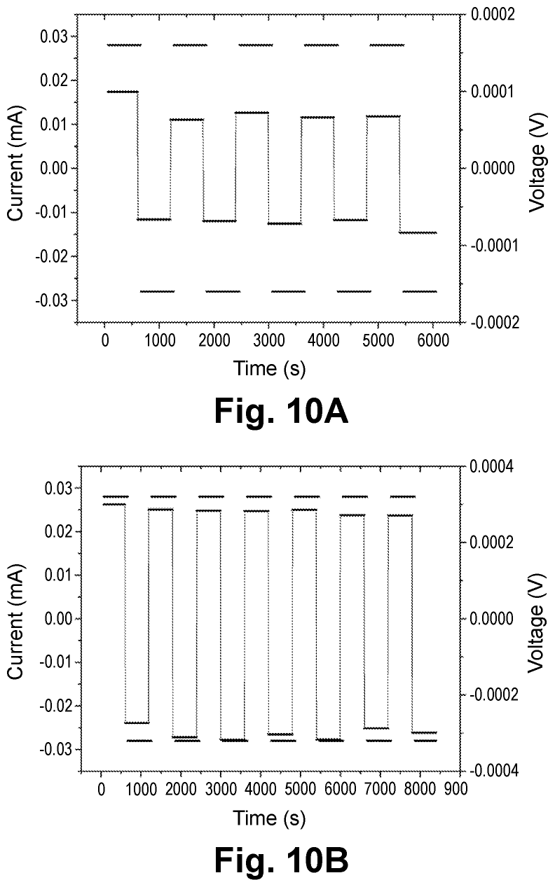

FIGS. 10A-10B show galvanostatic cycling of symmetrical cells with sodium electrolyte at the current density of 46 μA cm⁻². Minimal and stable polarization potentials of 0.1 mV and 0.3 mV are obtained for symmetric cells with NAMO-2TiO₂-10ZrO₂ and NAMO-3TiO₂-10ZrO₂ electrolytes, respectively.

Conclusions from the Above Non-Limiting Example

Through compositional control of flame made nanopowders, conditions whereby β″-Al₂O₃ sintering temperatures can be reduced by nearly 300° C. compared to conventional approaches have been identified. Increasing TiO₂ dopant levels dramatically enhances sintering, but at the cost of excessive grain growth. However, introducing a secondary immiscible phase, ZrO₂, provides excellent microstructural control. Sintered films 20-50 μm thick and 96-98% dense with 60-80 wt. % of β″-Al₂O₃ fractions can be produced using the approach here. Thus, the combination of high densities and β″-Al₂O₃ fractions results in ionic conductivities of 3-5 mS cm⁻¹ in these very thin films.

These processes are easily translatable to mass production, and with the availability of β″-Al₂O₃ thin films, novel battery designs in flat geometries are realized. This technology can be used to fabricate Na solid state batteries that operate at ambient temperatures.

### Example 2

A suspension is made by mixing LiCoO₂ powder (Aldrich) (0.84 g) as active material, 0.4Li₄SiO₄-0.6Li₃PO₄ (LSPO; 0.2 g) as electrolyte, Ag nanopowders (Aldrich) (0.15 g) as current collector, Li₂B₄O₇ (LBO; 0.01 g) as sintering aid, benzyl butyl phthalate (0.12 g) as a plasticizer, poly acrylic acid (0.01 g) as a dispersant, and polyvinyl butyral (0.12 g) as a binder, dissolved in anhydrous ethanol (1.2 ml) and acetone (1.2 mL). The mixture (3.35 g) is placed in a 20 mL vial and milled with spherical zirconia beads (6 g) with 3 mm diameter media overnight to homogenize the suspension. The suspension is cast on a substrate using a wire wound rod coater (Automatic Film Applicator 1137, Sheen Instrument, Ltd). After solvent evaporation, dried green films are uniaxially pressed in between stainless steel dies at 100° C. with a pressure of 50-70 MPa for 5 minutes using a heated bench (Carver, Inc.) top press to improve packing density. The resulting LiCoO₂—Li₄SiO₄—Li₃PO₄ (LSPO)-Ag composite cermet film is suitable, for example, as a cathode for a lithium battery.

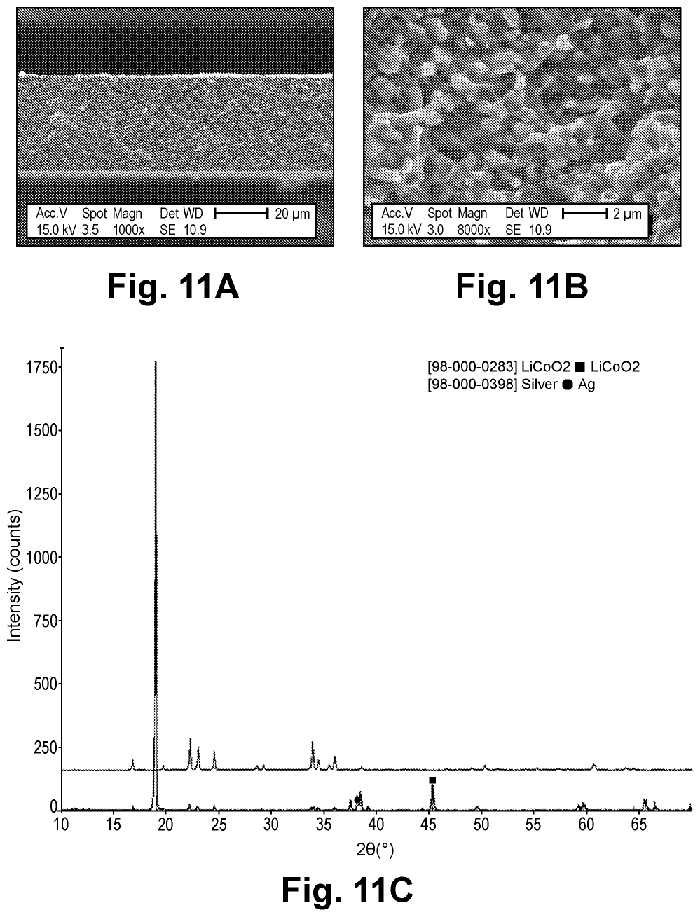

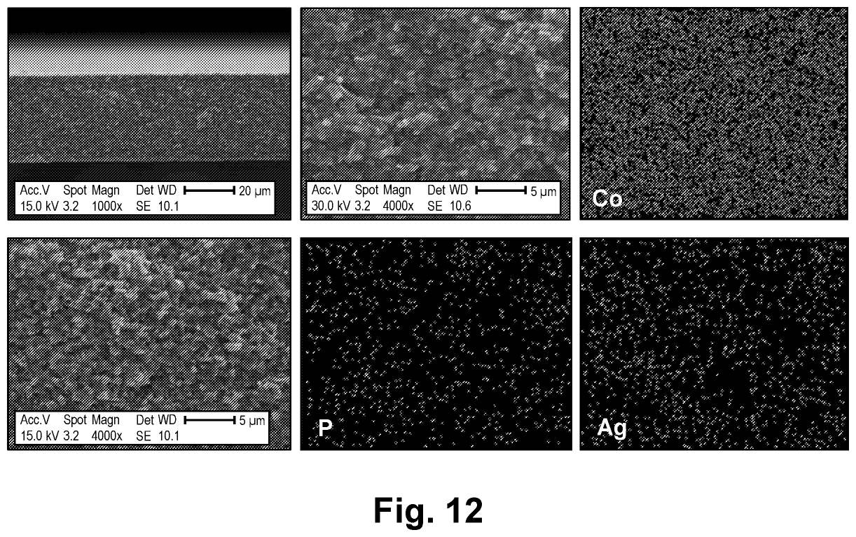

FIGS. 11A-11B show electron micrographs of the resulting LCO/LSP/Ag composite cermet film. With some closed porosity, fracture surfaces reveal high relative densities. The film thickness is approximately 35 μm. FIG. 11C shows a XRD pattern of the resulting composite matching the target phases, suggesting no or minimal reaction among each material during sintering. In FIG. 12, EDX mapping shows that the elements are well distributed without noticeable phase segregation.

### Example 3

Sintered LiNi_{0.33}Mn_{0.33}Co_{0.33}O₂ (NMC)/0.4Li₄SiO₄-0.6Li₃PO₄/Ag films are now described. Table 4 lists components used for making a suspension of NMC/LSP/Ag with target volume fractions of 67/27/6 respectively. All the components are added to a 20 mL vial and ball-milled with 3.0 mm diameter ZrO₂ beads (6 g) for 24 hours to homogenize the suspension. The suspension is cast using a wire wound rod coater. Dried green films are thermo-pressed at 100° C. with a pressure of 100 MPa for 5 minutes using a heated bench top press.

TABLE 4
Suspension formulation for (NMC/LSP/Ag)

| | Role | Mass(g) |
|---|---|---|
| NMC | Ceramic(cathode) | 0.82 |
| LSP | Ceramic (electrolyte) | 0.21 |
| Ag | Metal(current collector) | 0.16 |
| Polyvinyl Butyral | Binder | 0.11 |
| Benzyl Butyl Phthalate | Plasticizer | 0.11 |
| Ethanol | Solvent | 0.95 |
| Acetone | Solvent | 0.95 |
| Polyacrylic acid | Dispersant | 0.01 |
| Li₂B₄O₇ | Ceramic(sintering-aid) | 0.01 |

Resulting composite green films are sintered to 900° C./1 h/air (120 ml min⁻¹) at a ramp rate of 1° C./min.

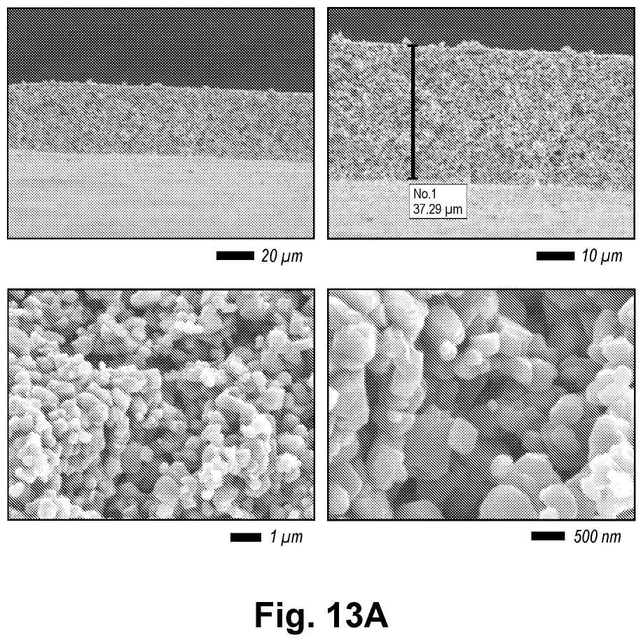

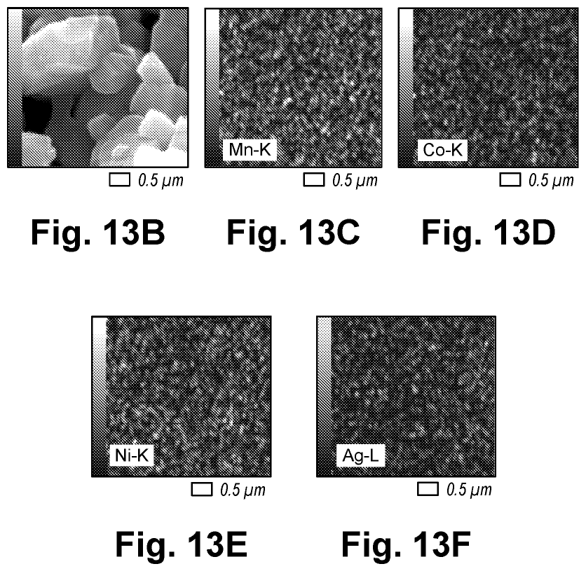

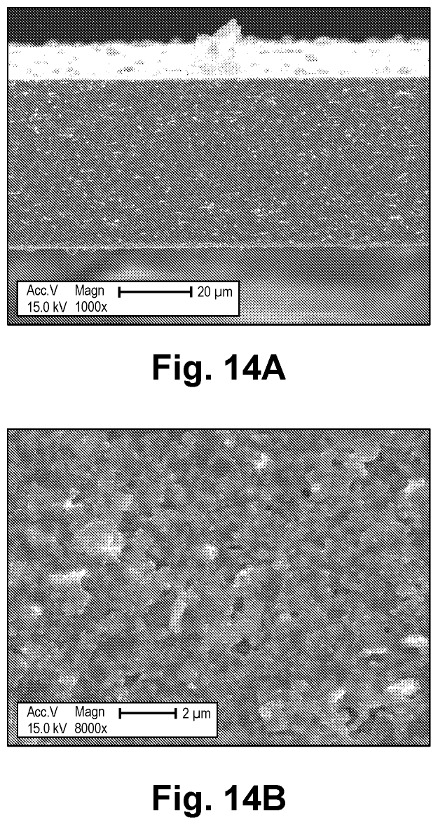

FIG. 13A and FIGS. 14A-14B show electron micrographs of the resulting NMC/LSP/Ag composite cermet film. With some closed porosity, trans-granular fracture surfaces reveal high relative densities. The film thickness is 37±0.3 μm. In FIGS. 13B-13F, EDX mapping shows that the elements are well distributed without noticeable phase segregation.

### Example 4

Sintered Li₃VO₄(LVO)/Li_{6.25}Al_{0.25}La₃Zr₂O₁₂(Al:LLZO)/Ag films are now described. Table 5 lists components used for making a suspension of LVO/Al:LLZO/Ag with target volume fractions of 67/27/6 respectively. All the components are added to a 20 mL vial and ball-milled with 3.0 mm diameter ZrO₂ beads (6 g) for 24 hours to homogenize the suspension. The suspension is cast using a wire wound rod coater. Dried green films are thermo-pressed at 100° C. with a pressure of 100 MPa for 5 minutes using a heated bench top press.

TABLE 5
Suspension formulation for (LVO/Al:LLZO/Ag)

| | Role | Mass(g) |
|---|---|---|
| LVO | Ceramic(anode) | 0.44 |
| Al:LLZO | Ceramic (electrolyte) | 0.41 |
| Ag | Metal(current collector) | 0.15 |
| Polyvinyl Butyral | Binder | 0.10 |
| Benzyl Butyl Phthalate | Plasticizer | 0.10 |
| Ethanol | Solvent | 0.71 |
| Acetone | Solvent | 0.71 |
| Polyacrylic acid | Dispersant | 0.01 |

Resulting composite green films are sintered to 900° C./1 h/air (120 ml min⁻¹) at a ramp rate of 1° C./min.

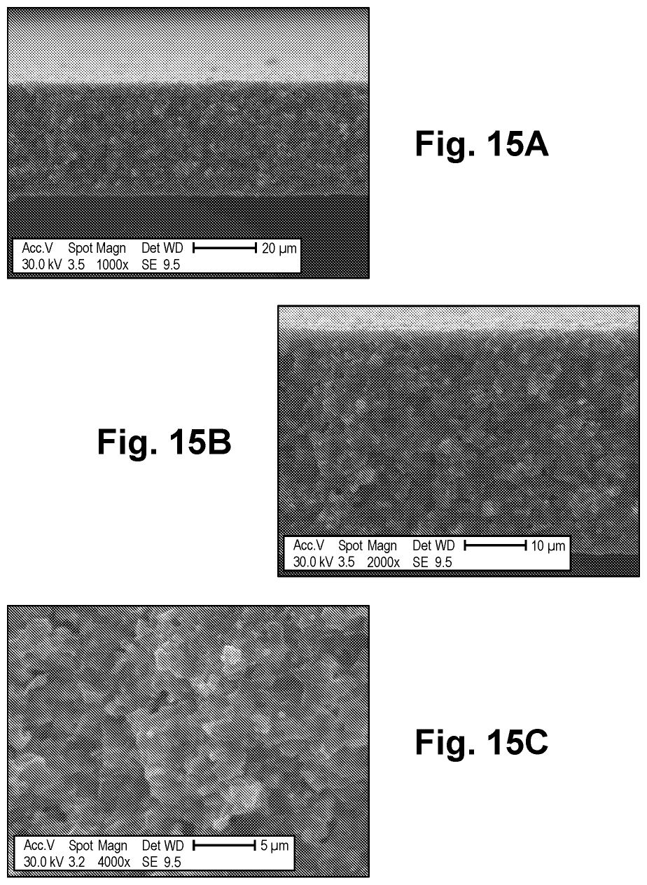

FIGS. 15A-15C show electron micrographs of the resulting LVO/Al:LLZO/Ag composite cermet film. With some closed porosity, trans-granular fracture surfaces reveal high relative densities. The film thickness is approximately 40 μm. The resulting LVO-Al:LLZO-Ag composite cermet film is suitable, for example, as a anode for a lithium battery.

### Example 5

Here, 12CaO-7Al₂O₃ (Ca12A7) is described with dopants. The LF-FSP process also allows doping and provides access to C12A7 nanopowders with rare earth dopants (e.g., Ce³⁺, Nd³⁺). Rare earth doped C12A7 phosphors are useful in field emission devices. In addition, nanopowders offer potential access to finer final grain sizes potentially crucial for obtaining transparent and dense thin films.

Summary

Traditionally, C12A7 materials have been processed using solid-state reactions followed by pulsed laser deposition (PLD) or floating zone (Fz) crystallization methods as high temperature, high cost approaches to single-phase films. These techniques require a significant number of process steps to generate C12A7:e⁻. Demonstrated here is an effective mass production method by producing C12A7 nanopowders (NPs) via liquid-feed flame spray pyrolysis (LF-FSP). Nearly fully dense, single phase, and transparent C12A7 thin films (less than 30 μm) can be produced by processing these NPs into green films by tape-casting, thermo-compression and then sintering to 1300° C./3 h/02. Subsequent heat treatments in 20% H₂/80% N₂ to replace O²⁻ ions forming C12A7:H⁻ followed by UV irradiation provide C12A7:e⁻ with electrical conductivities of 0.1 S cm⁻¹. C12A7:e⁻ belongs to a new class of TCOs due to its low materials and processing costs, environmental affinity, and natural abundance when processed efficiently.

Introduction

Abundantly found, traditional construction materials, CaO and Al₂O₃ form a variety of compounds of differing stoichiometric ratios including CA, C3A, CA6, C12A7 (C═CaO, A=Al₂O₃). Of these, 12CaO.7Al₂O₃ (C12A7) is the subject of multiple studies for practical applications centered around the fact that it can be transparent and electrically conducting when properly processed. Among the many studies, perhaps the most significant are those demonstrating photo-induced electrical conduction and photoluminescence properties.

C12A7 exhibits cubic morphology (I-43d space group) with a=11:99 Å. The stoichiometry for this 118 atom unit cell (Z=2) is [Ca₂₄Al₂₈O₆₄]⁴⁺+2O²⁻, including two extra O²⁻ ions trapped in Ca—Al—O cages. The unit cell consists of 12 sub-nanometer-sized cages; the cage walls are composed of 8 tetrahedral coordinated Al³⁺, 16 bridging and non-bridging oxygens, and 6 Ca²⁺ ions. The inner cage diameter is approximately 50% larger than the diameter of O²⁻, which can be attributed to the coordination between the Ca²⁺ and O²⁻ ions to be loose. Anionic substitution is possible in the structure because the mean effective charge per cage is ⅓ (4+ charges shared by 12 cages). There is an approximately 0.1 nm gap as channel for ionic exchange, resulting from the interionic distance between free O²⁻ and Ca²⁺, which is about 1.5 times longer than the sum (0.24 nm) of their ionic radii.

The electrical, chemical, and optical properties of C12A7 are possible to alter by replacing some or all of the free O²⁻ ions or doping with other elements. A number of studies have substituted the free O²⁻ by OH⁻, H⁻, O⁻, O₂⁻, F⁻, Cl⁻, e⁻, and Au⁻ for O₂⁻. Rare earth metals (Gd⁺³, Er⁺³, Ce⁺³, Nd⁺³, and Eu⁺³) are the main dopants engaged in the nanocages of C12A7. Like C12A7, these derivatives exhibit the same structures.

As synthesized, C12A7 is insulating; its optical band gap is approximately 5.8 eV. However, electrical conductivity can be introduced simply by replacing the O²⁻ anions with electrons by various chemical and physical processes forming C12A7:e⁻ (C12A7 electride). Transparent conductive oxides (TCOs) with high electrical conductivity are difficult to identify due their intrinsically band gaps. Given the high cost of all Indium based materials that are the most effective and used extensively in commercial applications, there have been intense efforts to discover alternative electron conducting materials that are environmentally friendly and efficient for mass production compared to current industry standard.

C12A7 derivatives have been made. C12A7 has been transformed into a transparent electrical conductor by heating single crystal of C12A7 at 1300° C. for several hours in a mixing gas composed of 20% H₂/80% N₂ followed by irradiation with ultraviolet (UV) light.

Multiple approaches to the synthesis of C12A7 and its derivatives have been explored including solid-state reaction, sol-gel processing, pulsed laser deposition (PLD), and floating zone (FZ). C12A7 solid-state syntheses are most common and start from 12:7 mixtures of CaCO₃ and Al₂O₃ followed by heating in controlled atmospheres at greater than or equal to 1000° C. These techniques require high temperature and high cost approaches with significant number of process steps to produce single-phase, dense C12A7:e⁻ films.

The central goal of this study is to synthesize 12CaO.7Al₂O₃ nanopowders in a single step using liquid-flame spray pyrolysis (LF-FSP), thereby eliminating the glass forming, crushing, and ball milling steps. The LF-FSP process also allows doping and should provide access to C12A7 nanopowders with rare earth dopants (e.g., Ce³⁺, Er³⁺, Nd³⁺). Rare earth doped C12A7 phosphors have a potential application in field emission devices. In addition, nanopowders offer potential access to finer final grain sizes potentially crucial for obtaining transparent and dense thin films. For facilitating applications, efficient fabrication methods are required for both bulk and thin film C12A7:e⁻. One of simplest and lowest-cost route to convert ceramic powders in to free standing, dense monoliths is by castingsintering.

Experimental

Materials. Calcium propionate [(CH₃CH₂CO₂)₂Ca), 97%] is purchased from Alfa Aesar (Ward Hill, Mass.). Triethanolamine [N(CH₂CH₂OH)₃], polyacrylic acid [(C₃H₄O₂)ₙ, Mn 2000], and benzyl butyl phthalate {2-[CH₃(CH₂)₃O₂C]C₆H₄CO₂CH₂C₆H₅, 98%} are purchased from Sigma-Aldrich (Milwaukee, Wis.). Polyvinyl butyral [(C₈H₁₄O₂)n, B-98, Mn 40,000-70,000] is purchased from Butvar (Avon, Ohio). Aluminum tri-sec-butoxide {Al[OCH(CH₃)CH₂CH₃]₃} is purchased from Chattem Chemicals (Chattanooga, Tenn.), and absolute ethanol from Decon Labs (King of Prussia, Pa.).

Alumatrane. Al[OCH(CH₃)CH₂CH₃]₃, 200 ml, 0.8 mole] is reacted with [N(CH₂CH₂OH)₃, 194 ml, 0.96 mole] at a molar ratio of 1 to 1.2, in a 1 L round bottom flask under N₂ flow. [N(CH₂CH₂OH)₃] is added slowly via addition funnel, while the mixture is magnetically stirred constantly over a 4 hour period. The product alumatrane, dissolved in byproduct butanol, is analyzed by TGA, giving a ceramic yield of 7.5%.

C12A7 nanopowder synthesis. Calcium propionate and alumatrane at a molar ratio of 12 to 7 are dissolved in anhydrous ethanol and TEA to give a 3 wt. % ceramic yield solution. The precursor solution is aerosolized with oxygen into a chamber where it is combusted with methane/oxygen pilot torches in an oxygen rich environment. Resulting nanopowders are collected down-stream in rod-in-tube electrostatic precipitators (ESP) operated at 10 kV. Features of liquid-feed flame spray pyrolysis (LF-FSP) apparatus have been described previously.

However, on crystallization, a secondary phase (CaA1₂O₄) is present, ascribed to calcium deficiency due to evaporation of CaO during sintering. To compensate for calcium loss during sintering, 5 and 10 wt. % excess calcium propionate is introduced into the precursor solution, hereafter referred to as C12A7+5%, and C12A7+10% respectively. Table 6 shows the amount of precursors used for each composition, which are dissolved in ethanol and TEA.

TABLE 6
Amount of precursors dissolved in
ethanol (850 ml) and TEA (50 ml).

| | Ca(O₂CCH₂CH₃)₂ (g) | Al[OCH(CH₃)CH₂CH₃]₃ (g) |
|---|---|---|
| C12A7 | 33.5 | 134.5 |
| C12A7 + 5% | 35.18 | 134.5 |
| C12A7 + 10% | 36.85 | 134.5 |

As-produced C12A7 nanopowders (6.5 g, 4.68 mmol) are first dispersed in anhydrous ethanol (300 ml) with 1 wt. % Bicine (65 mg, 400 μmol) dispersant, using an ultrasonic horn at 100 W for 10 minutes. The suspension is left to settle for overnight to allow larger particles to settle. Supernatant is decanted and the recovered solution is poured into a clean beaker and left to dry overnight in the oven (60° C.). The dried powders are ground in an alumina mortar and pestle.

Thin film processing. A suspension is made by mixing collected nanopowder (0.7 g), benzyl butyl phthalate (0.13 g), as a plasticizer, poly acrylic acid (0.01 g) as a dispersant, and polyvinyl butyral (0.13 g) as a binder dissolved in anhydrous ethanol (0.9 ml) and acetone (0.9 ml). The mixture (2.39 g) is placed in a 20 ml vial and milled with spherical alumina beads (6 g) with 3 mm diameter media overnight to homogenize the suspension. Suspension is cast using a wire wound rod coater (Automatic Film Applicator 1137, Sheen Instrument, Ltd.). After solvent evaporation, dried green films are uniaxially pressed in between stainless steel dies at 100° C. with a pressure of 50-70 MPa for 5 minutes using a heated bench (Carver, Inc.) top press to improve packing density.

Sintering studies. Heat treatments are conducted in a High Temperature Vaccum/Gas tube furnace (Richmond, Calif.). Green films of C12A7, C12A7+5%, and C12A7+10% are placed between alumina disks and sintered to 1300° C. for 3 hours in O₂ (100 mL min⁻¹). The films are transparent and have a uniform thickness of 30±2 μm. The polycrystalline films of C12A7+10% are heated at 1300° C. for 3 hours in a mixing gas composed of 20% H₂/80% N₂ (150 mL min⁻¹). The films are transparent after the hydrogen treatment.

Characterization

XRD. As-produced nanopowders and sintered films are characterized using Rigaku Rotating Anode Goniometer (Rigaku Denki., LTD., Tokyo, Japan). For data collection, as-produced powders are prepared by placing approximately 100 mg in XRD sample holders. Cu Kα (λ=1.54 Å) radiation operating at working voltage of 40 kV and current of 100 mA are used. Scans are continuous from 10 to 70° 2θ using a scan rate of 5 min⁻¹ in 0.01 increments. The presence of crystallographic phases, and their wt. fraction is determined by using Jade program 2010 (Version 1.1.5 from Materials Data, Inc.) The JCPDS patterns used for comparison include c-C12A7 (PDF #98-000-0301), and m-CA (PDF #98-000-0139).

Specific Surface Area (SSA) Analyses. Micromeritics ASAP 2020 sorption analyzer is used to obtain SSA data. Samples (400 mg) are degassed at 300° C./5 hours, and each analysis was run at −196° C. (77 K) with nitrogen gas. BET multipoint method using ten data points with relative pressures of 0.05-0.30 is used to determine SSAs. Average particle sizes (APS) of the as-produced nanopowders are determined by converting their respective SSAs using the equation APS=6/(SSA×ρ), where the density of amorphous C12A7, 2.92 g cm⁻³ is used.

Scanning electron microscopy (SEM). Micrographs of as-produced and sintered thin films are taken using JSM-IT300HR In Touch Scope SEM (JEOL USA, Inc.) For imaging purpose, thin films are fractured and powders are used as is. SPI sputter coater (SPI Supplies, Inc.) is used to sputter coat all the samples with gold and palladium.

Thermogravimetric Analysis (TGA) of as-produced nanopowders and green films are done using Q600 simultaneous TGA/DSC (TA Instruments, Inc.) Samples (15-25 mg), hand-pressed in a 3-mm dual action die, are placed in alumina pans and ramped to 1000° C. at 5° C. min⁻¹ under constant air flow (60 mL min⁻¹).

FTIR Spectra analyses run on Nicolet 6700 Series FTIR spectrometer (Thermo Fisher Scientific, Inc.) is used to measure FTIR spectra. 1 wt. % of the samples are mixed with KBr (International Crystal Laboratories), the mixtures are ground rigorously with an alumina mortal pestle, and the dilute samples are packed in the sample holder to be analyzed. Prior to data acquisition in the range of 4000-400 cm⁻¹, the sample chamber is purged with N₂.

UV Treatment. SUNRAY 400 SM (Uvitron International, Inc.) is used as a source of UV-light. Films are illuminated by UV-light for 1 hour before measuring electronic conductivity.

Electronic conductivity measurements. AC impedance data is collected using SP-300 (BioLogic Science Instruments, Knoxville, Tenn.) in a frequency range of 7 MHz to 1 Hz at 25° to xx 100° C. in increments of 20° C. Film surfaces are coated with Au/Pd electrodes, 3 mm in diameter, using a SPI sputter coater. Nyquist plots are obtained using EIS spectrum analyzer software to estimate the total resistance of the films.

Density measurements. Archimedes method is used to determine the densities of sintered films using ethanol.

Results and Discussion

Presented here are the results of C12A7 nanopowders that are synthesized by LF-FSP, followed by XRD, SEM, TGA, and FTIR characterization of green and sintered thin films of C12A7, C12A7+5%, and C12A7+10%; the effects of sintering temperatures and added excess CaO is also studied. Finally, efforts to transform sintered thin films into transparent conductive oxide along with impedance measurements of transparent films are presented.

As-Produced Nanopowders.

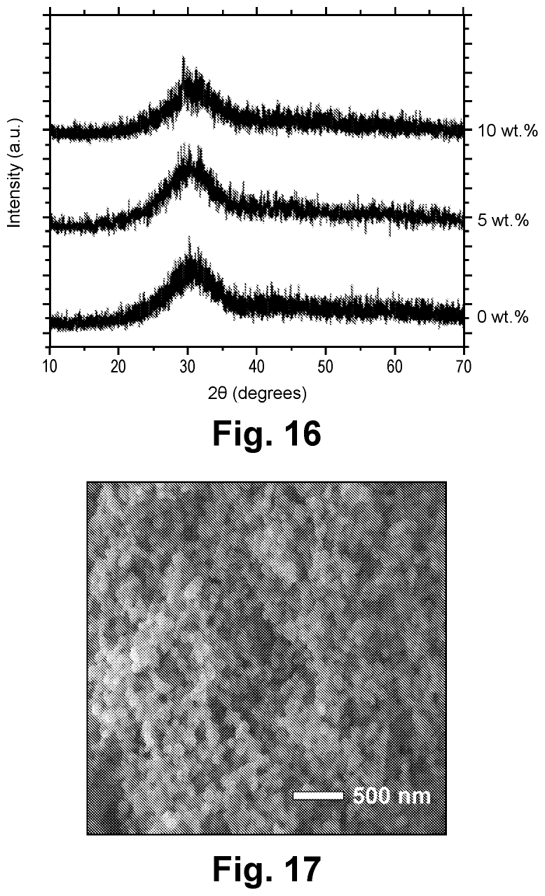

FIG. 16 shows XRDs of as-produced C12A7, C12A7+5%, and C12A7+10% NPs. XRDs of the as-produced NPs are all very similar, offering a broad amorphous hump around approximately 30° 2θ.

FIG. 17 provides SEMs of as-produced powders showing spherical morphologies typical of amorphous NPs with average particle sizes (APSs) less than 100 nm. The specific surface areas (SSAs) and APSs for as-produced C12A7, C12A7+5%, and C12A7+10% NPs are listed in Table 7.

TABLE 7
SSAs and APSs of as-produced powders.

| | SSAs (m²g⁻¹) | APSs (nm) |
|---|---|---|
| C12A7 | 23.4 ± 0.2 | 87 |
| C12A7 + 5% | 27.2 ± 0.4 | 75 |
| C12A7 + 10% | 28.5 ± 0.4 | 72 |

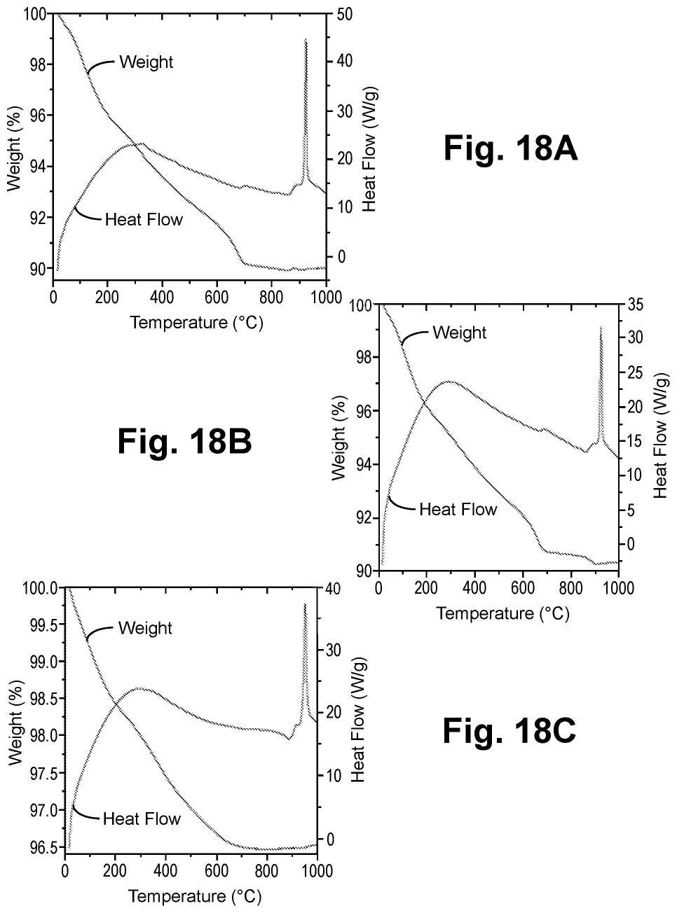

FIGS. 18A-18C provides TGAs of as-produced NPs on heat treatment to 1000° C./5° C./min/air. TGA shows only one exotherm at approximately 950° C. for each sample ascribing to crystallization of CaO, γ-Al₂O₃, and formation of α-Al₂O₃. The mass loss is due to the residual carbonate.

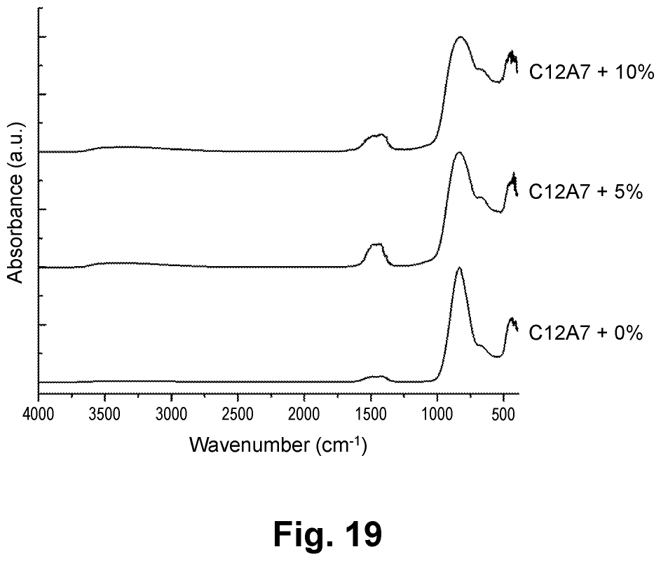

FTIR spectra shown in FIG. 19 show υC═O for carbonates (1400-1600 cm⁻¹) and νMO (less than 600 cm⁻¹) for as-produced NPs. The presence of carbonates is further confirmed by the mass loss shown in TGAs around 200-300° C.

Thin Film Characterization Studies.

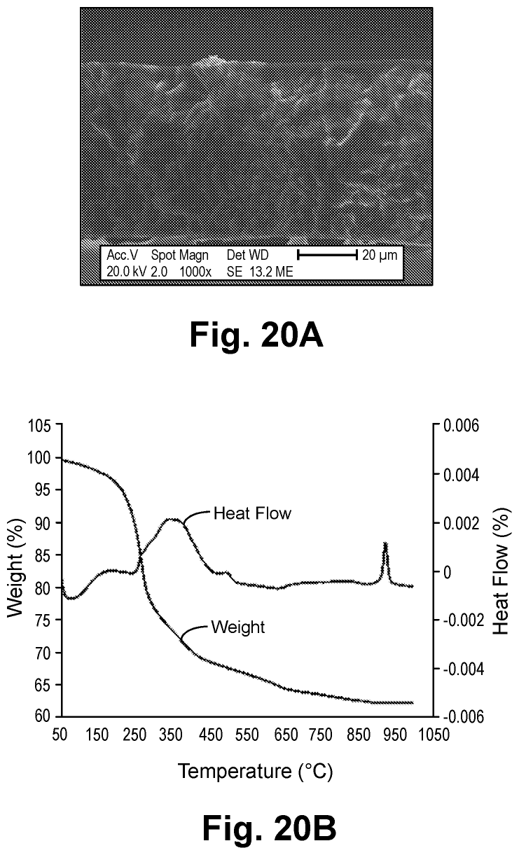

SEM fracture surface images of C12A7, C12A7+5%, and C12A7+10% green films in FIG. 20A show that the nanopowders are well dispersed in the polyacrylic acid. In FIG. 20B, TGA confirms the expected ceramic yields of each green films matches the theoretical ceramic yields of the perspective green films, which was calculated as 72. 8% (50 vol. %), excluding solvents as it evaporates upon drying. The mass loss at the intermediate temperatures is due to polymeric additives.

Crystallization and Sintering.

Green films of C12A7 are heated at 10° C. min⁻¹/O₂ and sintered at 1050°, 1100°, 1200°, 1300° C. for 3 hours. FIG. 21 shows the XRD patterns of green films sintered to selected temperatures. Sample sintered at 1050° C. show phases of C12A7 (84.6%) and CA (15.4%), whereas films sintered at 1100° C. have phases of C12A7 (85.6%) and CA (14.6%). Films sintered 1150° C. are composed of C12A7 (81.7%) and CA (18.3%). Films sintered at 1200° C. show C12A7 (80.9%) and CA (19.1%) phase. Therefore, calcium loss during sintering can be inferred. To get higher densification, higher temperature is required, but this leads to calcium loss, thus, extra calcium is introduced into the precursor solution to compensate for calcium loss.

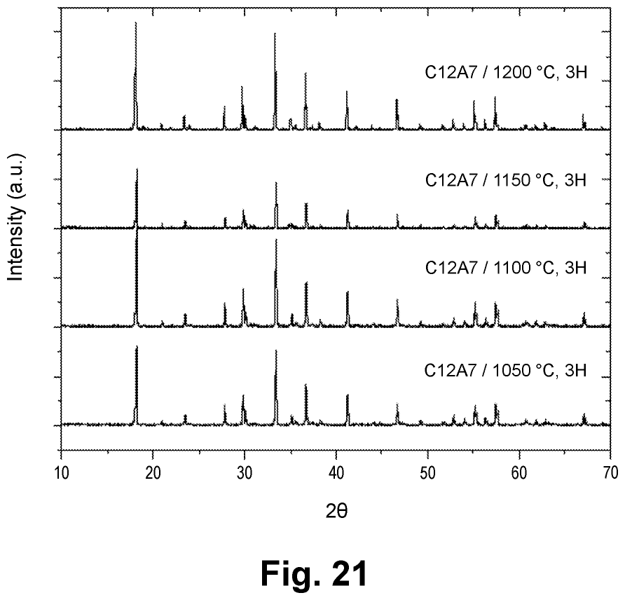

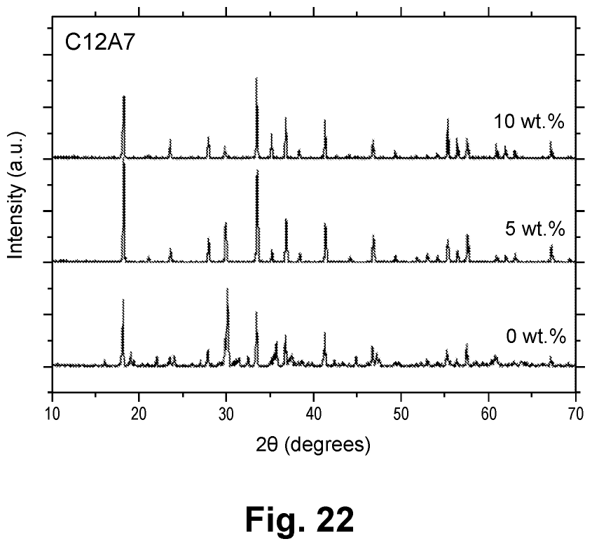

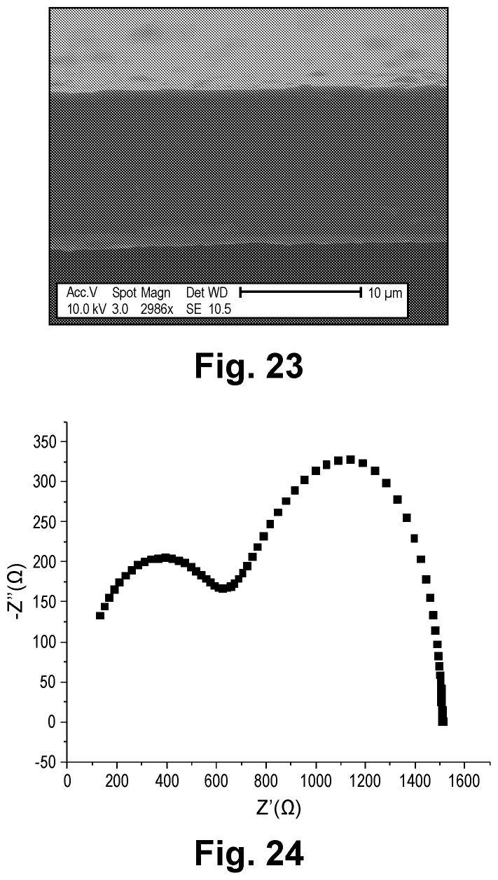

FIG. 22 presents XRD patterns of C12A7, C12A7+5%, and C12A7+10% green films sintered at 1300° C./3 h/02. These C12A7 films show the presence of mayenite (87.4%) and CaAl₂O₄ (12.6%), whereas the C12A7+5% film is composed of mayenite (92.3%) and CaAl₂O₄ (7.7%). The XRD of C12A7+10% film confirms the presence of single phase mayenite. Adding extra calcium has compensated for its loss during sintering, which leads to single phase mayenite. Exceptional control of stoichiometry and phase purity is achieved by using the LF-FSP method to synthesize oxide nanopowders. The final film densities are all approximately 98.8% TD, as determined by Archimedes method. FIG. 23 shows a SEM fracture surface image of sintered C12A7 with 10% excess calcium. Transgranular fractures with no closed pores reveal the sintered film is fully dense. FIG. 24 shows a Nyquist plot of sintered C12A7.

C12A7+10% sintered films are chosen to be treated in (20%) H₂/N₂ since they are only composed of single phase mayenite. The polycrystalline films are heated to 1050°, 1100°, and 1200° C. at a ramp rate of 5° C. min⁻¹ and held for 1 hour in a mixing gas composed of (20%) H₂/N₂. C12A7:H films are illuminated by UV-light for 1 hour. The color of the films change from colorless transparent to light yellow transparent after UV-treatment as shown in FIG. 22.

Microstructures and Electronic Conductivity.

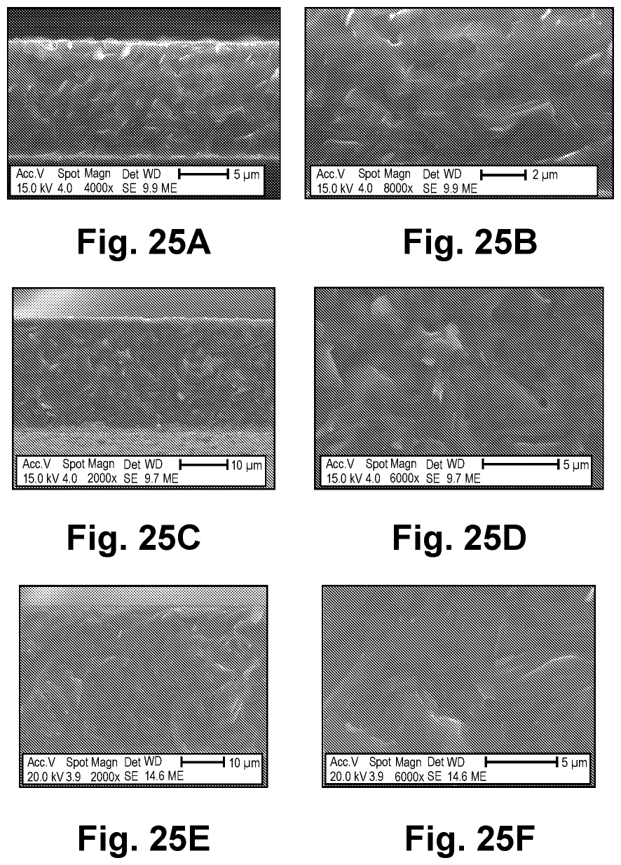

FIGS. 25A-25F show microstructures of sintered C12A7, C12A7+5%, and C12A7+10% films. The fracture surface images of sintered films look very dense as they are nanoporous. Intergranular fracture surfaces reveal very high relative densities. Thermal etching is conducted by manually fracturing and heating the samples to 1200° C. for 1 hour in 02. Average grain sizes determined by the linear intercept method are 1.5±0.2 μm and 2.3±0.2 for C12A7 and C12A7+5%, respectively.

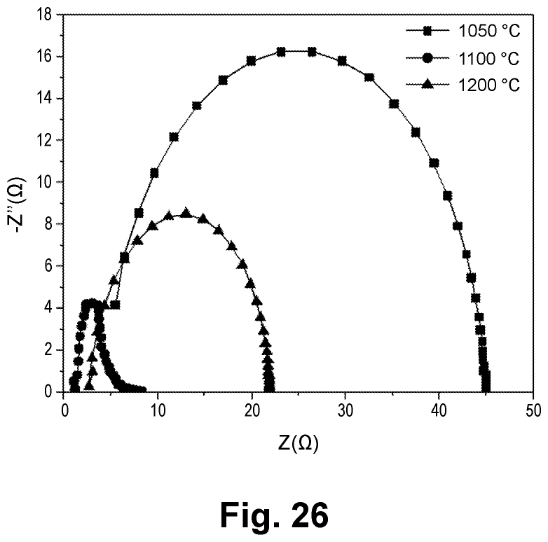

C12A7+10% films heated at selected temperatures (i.e., 1050°, 1100°, and 1200° C./1 h) in (20%) H₂/N₂ atmosphere are exposed to UV-light for 1 hour. FIG. 26 presents a typical complex impedance spectrum of C12A7:e+10% films at 25° C. The resistance values at the intercept with real axis in the high frequency are used for the calculation of conductivity. The obtained total electronic conductivities of the films at selected temperatures are listed in Table 8. The highest approximated electronic conductivity is 0.1 S cm⁻¹, which corresponds to the film hydrogen treated at 1100° C./1 hour at room temperature. By lowering the hydrogen treatment temperature, thermal activation processes of replacing the free O²⁻ ion with hydride ions increase in the structure, and thus, higher conductivity is achieved. Rapid cooling to room temperature after hydrogen heat treatment has been reported as the common condition of clattering the cage with hydride ions.

TABLE 8
Electronic conductivities of C12A7:e⁻ + 10%
films H₂ treated at selected temperatures.

| H₂ heating condition T (° C.) | σ(mS cm⁻¹) |
|---|---|
| 1050/1 h | 20 |
| 1100/1 h | 100 |
| 1200/1 h | 45 |

Table 9 shows total conductivities (σₜ) of C12A7:e⁻+10% samples at selected temperatures. Table 10 compares thickness and room temperature electronic conductivity of C12A7:e⁻ films to what has been previously reported. Some of the techniques used to achieve high electronic conductivities require very expensive and energy extensive processes. Despite the simplicity of solid state reaction method, high sintering temperatures and longer dwell times are required to achieve dense, single phase, C12A7 samples. Therefore, more effective mass production methods continue to be desired.

TABLE 9
Total conductivities (σₜ) of C12A7:e⁻ +
10% samples at selected temperatures.

| T (° C.) | σ(S cm⁻¹) |
|---|---|
| 25 | 7.5 × 10⁻² |
| 45 | |
| 65 | |
| 85 | |
| 105 | |

TABLE 10
Reported room temperature conductivities for C12A7:e⁻.

| Sintering | Processing | | | | |
|---|---|---|---|---|---|
| condition(° C./h) | Step | σₜ(S cm⁻¹) | Thickness | | Reference |
| 1300/3 | LF-FSP/TC | 0.1 | 30 | μm | — |
| 1300/1 | PLD | 1.1 | 0.5 | μm | [25] |
| 1300/6 | SSR/PLD | 0.62 | 500 | nm | [16] |
| 1350/12 | SSR/Fz | 0.3 | 0.3 | mm | [2] |
| 1350/24 | SM/DE | 9 × 10⁻⁴ | 13 | mm | [26] |

| | | | | |
|---|---|---|---|---|
| 1600/1 | MS/GC | 1-10 | — | [5] |

GC = glass-ceramic,
SSR = solid state reaction,
SM = solution mixing,
DE = direct evaporation,
TC = tape casting,
MS = melt solidification

### Example 6

Summary

Despite the intense concentration on lithium-based batteries, safety, ease of construction and cost continue to drive the search for alternatives that do not suffer from such restrictions. Here, the development of thin film Mg²⁺ conducting electrolytes as the key starting point for the development of all-solid-state Mg batteries is presented. Initial studies have explored compositions in the Mg_{0.5}CeₓZr₂₋ₓ(PO₄)₃ (x=0.1, 0.2 and 0.3) system, first as pellets and with somewhat optimized compositions (with x=0.2) as thin films. Introduction of Ce allows sintering to full density at temperatures where Ce free films do not densify completely. This work relies on the synthesis of nanopowders (NPs) using liquid-feed flame spray pyrolysis that offers the potential to reduce processing conditions, to control final average grain sizes (AGSs), and to provide single-phase materials with good to excellent mechanical properties. The pellets and the thin (less than or equal to 50 μm) films produced here show conductivities of up to 3×10⁻³ mS·cm⁻¹ at approximately 300° C., which if extrapolated (using an Eₐ of approximately 30) to 400° C. would be close to 10⁻² mS·cm⁻¹ in keeping with the best previously reported values. The thin films reported here offer nearly full densities beyond what is currently achievable by any other method. The ionic area specific resistance (IASR) values for these thin films are found to be 1400 Ω·cm² at 300° C. and are estimated to drop to 110 Ω·cm² at 400° C., significantly lower than values for pellets reported elsewhere.

Introduction

Electrical energy storage demands of electric devices (including electric vehicles, laptop computers, load leveling for stationary power sources, and cellular phones, for example), coupled with fossil fuel economies and limitations demonstrate the growing need for rechargeable batteries with multiple performance capabilities, including sufficient energy density, appropriate voltage and current capabilities, and perhaps most important, very low safety requirements. Conventional lithium batteries containing liquid electrolytes based on highly volatile and flammable organic solvents suffer significantly from the potential to fail catastrophically via electrolyte leakage, boiling, freezing, combustion or even explosion, which is of particular importance for in vivo applications. There is need to develop batteries with much higher safety and greater energy densities to satisfy growing market demands. Under such circumstance, all-solid-state batteries (ASBs) have been proposed as a fundamental solution. They do not require liquid cell components, relieving this avenue for catastrophic failure. They are also capable of operating over both wide temperature and electrochemical potential ranges. Coincidently, metal anodes and high-voltage cathodes can be used to greatly enhance energy densities, allowing long term operation without need to recharge. Likewise, the much greater operating temperature ranges imply faster charge/discharge properties.

To date, the most successful and widely implemented rechargeable battery technologies rely on lithium. Efforts to develop rechargeable Li ASBs have attracted much attention due to their high voltage and high theoretical energy density of 3500 Wh·kg⁻¹. When perfected, they can play a pivotal role as an advanced electrochemical power source. However, the low accessibility of Li (e.g., low natural abundance of 7 g/Faraday in the earth's crust and 0.04-1.16% in brine ponds) goes against its sustainability. High and rising costs also limit the future use of Li⁺ batteries for large-scale applications.

Given the need for a sustainable supply of large-scale energy storage devices, considerable efforts have been directed towards the development of non-lithium battery systems, especially ASBs. Of the possible alternatives, rechargeable magnesium-ion (Mg²⁺) battery technology offers significant opportunities for the following reasons. First is Mg's high natural abundance in the earth's crust (fifth most abundant element, approximately 10⁴ times that of Li), allowing low-cost incorporation into battery elements. Second, the divalent nature of Mg ions also allows a high volumetric capacity of 3833 mAh/cc (vs. 2046 mAh/cc for lithium). Third, Mg provides a higher atmospheric stability and melting point than Li, making it safer compared to Li. Mg also has a rather low equivalent weight of 12 g per Faraday (F) (vs. 7 g/F for Li, 23 g/F for Na) and low price of ca $2700/ton (currently ca. 24 times cheaper than Li), ensuring a feasible “environmentally-friendly” alternative to the immensely popular Li-ion systems.

Despite these positive attributes, the development of Mg-based ASBs has not kept pace with Li batteries. One critical issue impeding progress is the availability of stable and highly Mg²⁺-conducting solid electrolytes that enable reversible release of Mg²⁺ ions from a magnesium metal anode. To date, there exist only limited reports on Mg²⁺-conducting solid electrolytes. Mg_{0.5}Zr₂(PO₄)₃, MZP, is well-known among them to have a 3-D network linking ZrO₆ octahedra and PO₄ tetrahedra by corner-sharing. MZP has two types of crystal structures. β-Fe₂(SO₄)₃-type MZP (monoclinic symmetry, P2₁/n space group) would offer reduced conductivities at low temperatures due to the distortion behavior of the β-Fe₂(SO₄)₃-type structure. Another type of MZP has a NASICON (Na⁺ super ionic conductor)-type structure (rhombohedral symmetry with hexagonal setting, R3c), where well-ordered Zr₂P₃O₁₂ (lantern) units allow smooth ion migration. Therefore, high ion conductivity is expected even at moderate temperatures (300°−500° C.) due to the low activation energy for ion migration.

Of the available reports on MZP systems, pellet-shaped electrolytes have been synthesized mainly using solid-state synthetic routes and sol-gel methods. Solid MZP electrolytes have been investigated to develop potentiometric sensors. As-processed MZP pellets exhibit the expected Na_{0.5}Zr₂(PO₄)₃ structure with conductivities ranging from 2.9×10⁻² mS·cm⁻¹ (400° C.) to 6.1 mS·cm⁻¹ (800° C.) with activation energies of approximately 80 kJ/mol.

MZP pellets have been prepared by solid state processing, finding Mg²⁺ conductivities are considerably enhanced predominantly due to the microscopic dispersion of a Zr₂O(PO₄)₂ secondary phase in the composite. Additionally, MZP pellets were prepared with pure NASICON-phase by sol-gel processing observing conductivities of 1.0×10⁻³ mS·cm⁻¹ at ambient and 7.1×10⁻² mS·cm⁻¹ at 500° C. with electrochemical stabilities up to 2.50V vs an Mg/Mg²⁺ electrode. A conductivity of 6.9 mS·cm⁻¹ at 800° C. has been reported for dense (ca. 99% TD), single-phase MZP pellets produced using a novel sol-gel approach.

Efforts to improve the performance of MZP compounds have targeted modification of the lattice structures. Thus, substitution of Fe³⁺ (0.65 Δ ionic radius) for Zr⁴⁺ (0.72 Δ) is expected to reduce lattice dimensions providing more suitable channel sizes for Mg²⁺ (0.72 Δ) migration. It also introduces extra interstitial Mg²⁺ ions in the NASICON structure, anticipated to enhance the concentration of available Mg²⁺ ions. Thus, introduction of Fe³⁺ increases charge carrier concentrations and mobile ion concentrations. The partially Fe-substituted MZP, i.e., Mg_{0.9}(Zr_{0.6}Fe_{0.4})₂(PO₄)₃, gives a maximum conductivity of 1.3×10⁻² mS·cm⁻¹ at room temperature and 7.2×10⁻² S·cm⁻¹ at 500° C., an order of magnitude higher than that of the parent MZP compound.

The thicknesses (1-2 mm) of pellet components, including electrodes and electrolytes, limit gravimetric/volumetric energy densities of assembled cells. Thicker components with relatively higher internal resistance cause lower power output (poor rate capability) and an earlier stop of discharge (particularly high rate discharge) due to longer diffusion distances and severe concentration polarization. Compared to pellets, thin (less than or equal to 100 μm) film electrolytes are therefore more competitive and useful in assembling cells with high packing densities and structural stability, ensuring high safety and overall performance of assembled battery systems. One can envision developing solid-state batteries with superior energy densities through significant reductions in the electrolytes and electrode thicknesses, opening a new door for Mg batteries.

Methods of processing dense Li_{1.7}Al_{0.3}Ti_{1.7}Si_{0.4}P_{2.6}O₁₂ pellets with ambient ionic conductivities greater than 1 mS·cm⁻¹ have been described. Significantly, these methods process dense, flexible Li⁺-conducting ceramic electrolyte thin films (less than or equal to 50 um) using tape-casting methods based on liquid-feed flame spray pyrolysis (LF-FSP) nanopowders (NPs). These systems provide high ambient ionic conductivities (e.g., 0.4 mS cm⁻¹ for 50 μm Li_{1.7}Al_{0.3}Ti_{1.7}Si_{0.4}P_{2.6}O₁₂, 0.2 mS·cm⁻¹ for 30 μm c-Li₇La₃Zr₂O₁₂,³³ 1.3 mS cm⁻¹ for 25 μm Ga:LLZO) and high tolerance to heat, improving safety over wide operating temperatures.

Here, the development of Ce-doped MZP thin film electrolytes with chemical compositions near Mg_{0.5}CeₓZr₂₋ₓ(PO₄)₃ (x=0.1, 0.2 and 0.3), hereinafter referred to as MZPCeₓ, are explored. Ce⁴⁺ (0.87 Δ) is expected to substitute for Zr⁴⁺ (0.72 Δ) as an alternative to Fe³⁺ to improve MZP conductivities. MZPCeₓ pellets (Φ12×0.5 mm²) is first studied to optimize compositions, and then thin (less than or equal to 50 μm) films are processed with these optimized compositions. Pellets and thin films with compositions of Mg_{0.5}Ce_{0.2}Zr_{1.8}(PO₄)₃ offer ionic conductivities in line with the best reported values in the literature.

Experimental

Raw materials. Magnesium hydroxide [Mg(OH)₂], propionic acid (CH₃CH₂COOH), isobutyric acid [(CH₃)₂CHCO₂H], isobutyric anhydride [(C₃H₇CO)₂O], zirconium basic carbonate, [Zr(OH)₂CO₃.ZrO₂], triethyl phosphate [(C₂H₅O)₃PO], cerium carbonate [Ce₂(CO₃)₃.xH₂O], methyl ethyl ketone (C₂H₅COCH₃) and benzyl butylphthalate {2-[CH₃(CH₂)₃O₂C]C₆H₄CO₂CH₂C₆H₅, 98%} are purchased from Sigma-Aldrich (Milwaukee, Wis.). Polyvinyl butyral [(C₈H₁₄O₂)ₙ, B-98, Mₙ=40,000-70,000] is purchased from Butvar (Avon, Ohio), and absolute ethanol from Decon Labs (King of Prussia, Pa.).

Precursor synthesis. As-purchased triethyl phosphate, (C₂H₅)₃PO₄, is directly used as P source. The other three types of precursors are required to be synthesized as sources of Mg, Zr, and Ce, respectively.

Magnesium propionate, Mg(O₂CCH₂CH₃)₂, is synthesized by reacting Mg(OH)₂ (157 g, 2.7 mole) with excess CH₃CH₂CO₂H (500 ml, 6.8 mole) in a 1 L round-bottom flask equipped with a still head. The mixture is heated at 130° C. for 2 hours with magnetic stirring, until it became transparent. On cooling to room temperature, magnesium propionate crystallizes, then is filtered off, dried naturally, and ground into powder for use. As-obtained Mg precursor provides a ceramic yield of ca. 42 wt. %, lower than theoretical value (44 wt. %), as determined by TGA. The discrepancy arises mainly from a slight excess of propionic acid.

Zirconium isobutyrate, Zr[O₂CCH(CH₃)₂]₂(OH)₂, is synthesized by reacting zirconium basic carbonate (160 g, 0.52 mole) with isobutyric acid (390 g, 4.4 mole) and isobutyric anhydride (350 g, 2.2 mole) in a 1 L flask equipped with a still head in N₂ atmosphere. The reactants are heated at 110° C. until they became transparent. Zirconium isobutyrate crystallizes on cooling, then is filtered off, dried, and ground into powder for use.

Cerium propionate [Ce(O₂CCH₂CH₃)₃(OH)] is synthesized by reacting cerium carbonate (46 g, 0.1 mole) with excess propionic acid (225 mL, 3 mole) and propionic anhydride (65 mL, 0.5 mole) in a 1 L flask equipped with a still head. The solution is heated at 120° C. for 10 hours with magnetic stirring until a transparent dark orange liquid is obtained. On cooling to room temperature, cerium propionate crystallizes and is filtered out.

Nanopowder (NP) syntheses. Mg_{0.5}CeₓZr₂₋ₓ(PO₄)₃ (x=0.1, 0.2 and 0.3) NPs are synthesized by liquid feed-flame spray pyrolysis (LF-FSP), technology described in detail elsewhere. All the precursors for Mg, Zr, P, Ce are mixed and dissolved in ethanol at designated ratios, providing a solution with 3 wt. % ceramic yield. The as-obtained precursor solution is aerosolized with oxygen into a 1.5 m long combustion chamber and ignited using methane/02 pilot torches. After combustion and cooling, NPs are collected downstream in wire-in-tube electrostatic precipitators operated at 10 kV and then cleaned by dispersing them into EtOH using an ultrasonic horn (Vibra-cell VC-505, Sonics & Mater. Inc.). After sufficient sedimentation, the supernatant suspension is decanted into a container, dried in an oven, and collected for use.

Pellet processing. The dried MZPCeₓ powders are sieved through a 20 μm polymer mesh, uniaxially pressed at 12 MPa in a biaxial-compression WC die (14.2 mm in diam.), and CIPped at 200 MPa for 30 minutes, improving densities of green bodies.

Green pellets are sintered in air at 1100-1200° C. for 1 hour with a ramp rate of 5° C./minute.

Thin film processing. As-synthesized MZPCe_{0.2} NPs are mixed with binder, plasticizer, and solvents with designated ratios (as listed in Table 11), then ball-milled for 24 hours with zirconia beads (99% in purity, 3.0 mm in diam.), homogenizing the suspension.

TABLE 11
Starting chemical components for film casting.

| Components | Roles | Mass (g) | Wt. % | Vol % |
|---|---|---|---|---|
| MZPCe_{0.2} | Powder | 1.00 | 32 | 10 |
| Polyvinyl butyral (PVB) | Binder | 0.13 | 4 | 4 |
| Benzyl butyl phthalate (BBP) | Plasticizer | 0.13 | 4 | 4 |
| Methyl ethyl ketone (MEK) | Solvent | 0.95 | 30 | 41 |
| Ethanol | Solvent | 0.95 | 30 | 41 |

The suspension is cast using a wire-wound rod coater (Automatic Film Applicator-1137, Sheen Instrument, Ltd., UK), producing thin NP filled polymeric films. Film thicknesses are controlled using spacers between the rod and MYLAR® BoPET substrate. After solvent evaporation, dried green films are cut into small pieces, uniaxially pressed at 30 MPa/100° C./3 minutes using a heated bench-top press (Carver, Inc.), then manually peeled off the substrate.

Dried, green MZPCe_{0.2} films are debindered/crystallized in air at 785° C./1 hour with a ramp rate of 5° C./minute, followed by sintering at 1000-1200° C. for selected dwell times. During heating, films are placed between alumina plates to prevent warping.

Thermal etching of as-sintered films. To calculate average grain sizes using the lineal intercept method, as-sintered films are thermally etched to expose separate grains by heating in air for 30 minutes at designated temperatures for 30 minutes in air. The temperatures of thermal etching are usually 100° C. lower than sintering temperatures of films.

Characterization

Specific surface area (SSA) analysis. SSAs of the as-shot MZPCe0.2 NPs are obtained using a Micromeritics ASAP 2010 N₂ adsorption analyzer (Norcross, Ga.). Samples (ca. 200 mg) are degassed at 400° C. until the degas rate was less than 0.005 Torr/min, then analyzed at −196° C. (77 K) in N₂. SSAs are calculated using the BET multipoint (greater than or equal to 10 points) method within the relative pressure range of 0.001-0.20. Additionally, the average particle sizes (APSs), D, can be calculated per the formula:

D=2r=6/(ρ×SSA) (1)

where ρ is the theoretical density of powders, and r is the particle radius.

Thermogravimetric/differential scanning calorimetry (TG/DTA). Thermal decomposition and crystallization of as-cast green films are analyzed using Q600 simultaneous TG/DTA (TA Instruments, Inc.), predicting the progress of film calcination. Samples (ca. 15 mg) are loaded in an alumina pan and heated from ambient temperature to 1200° C., with a ramp rate of 10° C./min in a flowing synthetic air (60 mL/min).

X-ray diffraction (XRD). XRD (Rigaku Denki., LTD., Tokyo, Japan) is operated at 40 kV and 100 mA for phase identification of LF-FSP NPs and sintered films and pellets. The pellets are broken up, ground into powders, and then characterized by XRD. Samples were scanned by Cu Kα radiation (λ=1.541 Å) at 2°/min within the range of 10−70° 2θ with 0.02° intervals. Jade 2010 software (Version 1.1.5 from Mater. Data, Inc.) is used to analyze XRD data, where JCPDS files are used, including Mg_{0.5}Zr₂(PO₄)₃ (04-016-0487), ZrP₂O₇ (04-009-9317) and ZrO₂ s(σₜ), calculated from formula:

σₜ=d/(Aₑ×R) (2)

where d, Aₑ, R denote film thickness, electrode area and total resistance, respectively.

Activation energies, Eₐ, are calculated from Arrhenius equation:

σt=A exp(−Eₐ/R_{g}7) (3)

where A, R_{g}, T mean pre-exponential factor, gas constant and absolute temperature, respectively.

Results and Discussion

As-Produced NPs.

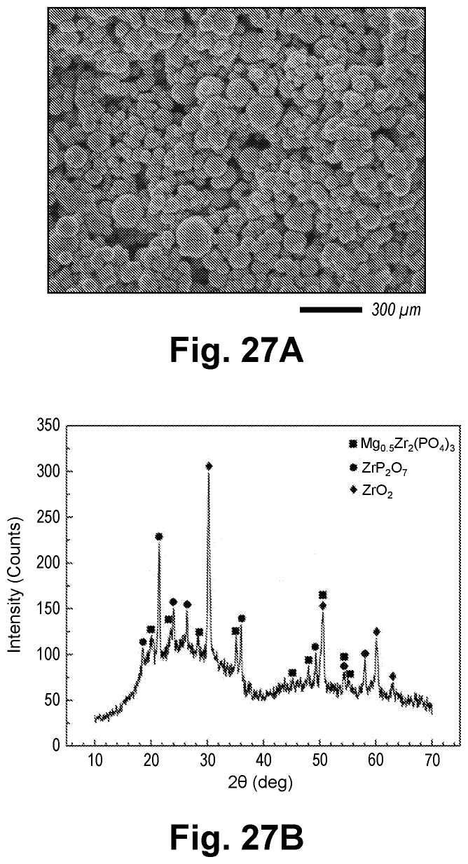

As seen in the SEM shown in FIG. 27A, as-produced MZPCe_{0.2} NPs, typical of MZPₓ (x=0.1, 0.2 and 0.3), consist of agglomerated particles close to spherical in shape, but with few obvious aggregates. Most of the powders consist of particles with average sizes (APSs) less than 100 nm and no micron sized particles. BET studies indicate SSAs of 28 m²/g, allowing calculation of APSs of ca. 66 nm, in accordance with SEM results.

The FIG. 27B XRD indicates these NPs consist primarily of MZP (74 wt. %), with the remaining phases being ZrP₂O₇ (9 wt. %) and ZrO₂ (17 wt. %). The broad XRD peaks are typical of nanoscale particles. The presence of some partially amorphous powders cannot be excluded.

Thermal Analysis of Green Films.

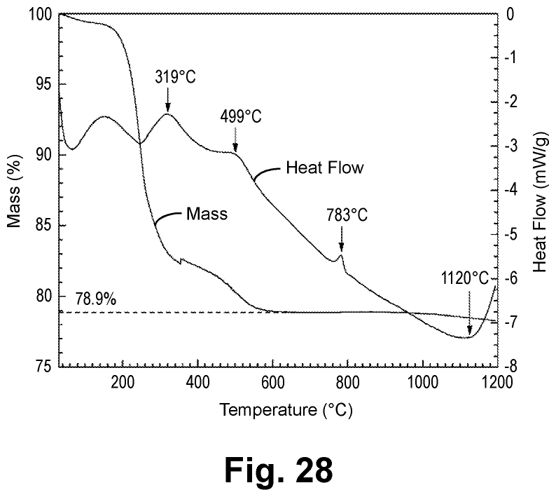

As-cast green films are heated to 1200° C./air with a ramp rate of 10° C./min as a prelude to extensive further studies on sintering films and pellets. Thermal analysis (FIG. 28) shows continuous, significant mass losses (until around 550° C.) accompanied by exotherms arising at 320° and 500° C., due mainly to decomposition of polymer additives as shown in Table 11. Mass losses cease at 550-600° C., corresponding to a ceramic yield of 79 wt. %, almost identical to the theory-derived figure from Table 11. The expected ceramic yields of processed green films can be calculated as 80 wt. % (56 vol. %), excluding solvents (MEK and ethanol) as they would evaporate on drying. The exotherm at 783° C. is likely associated with the crystallization of MZP and ZrP₂O₇ phases. The endotherm seen above 1120° C., accompanied by a slight mass loss, is due to the evaporation of POₓ species.

MZPCeₓ Pellets.

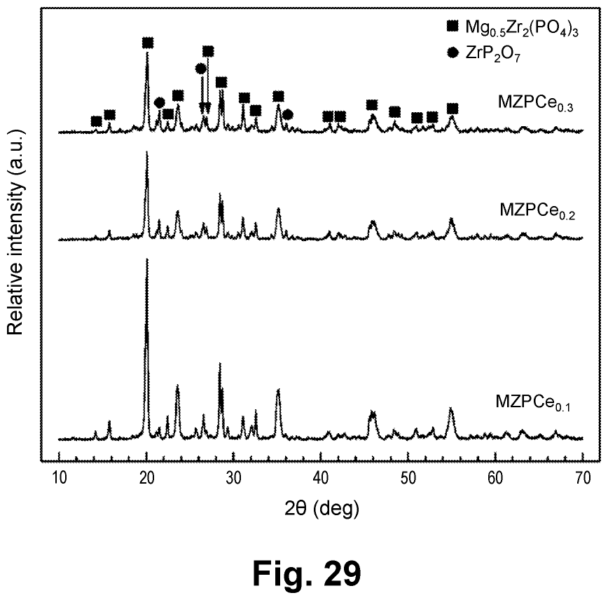

FIG. 29 provides XRDs for MZPCeₓ (x=0.1, 0.2 and 0.3) pellets after sintering at 1200° C./1 h/air. The as-sintered pellets consist mainly of Mg_{0.5}Zr₂(PO₄)₃ and ZrP₂O₇ phases. Zirconium phosphate including Zr₂P₂O₉ and ZrP₂O₇ are typical impurities detected in MZP materials. MZPCe_{0.1} pellets offer ca. 97 wt. % MZP, while for most MZPCe_{0.2} and MZPCe_{0.3} pellets, phase purity is closer to 90 wt. % (as shown in Table 12).

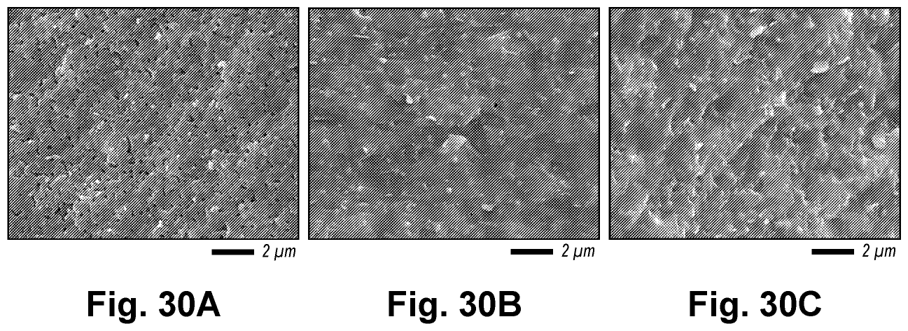

The SEMs shown in FIGS. 30A-30C indicate that sintering MZPCeₓ at 1200° C./1 h/air offers almost fully dense MZPCe_{0.2} and MZPCe_{0.3} pellets, but porous MZPCe_{0.1} pellets with a relative density of approximately 90% (as shown in Table 12).

The MZPCe_{0.2} pellets are also sintered at 1100° C./1 hour, 1200° C./3 hours, respectively. Unfortunately, lower temperatures lead to porous structures and longer dwell times at 1200° C. lead to lower MZP phase contents. Higher temperatures and longer dwell times cause POₓ loss (SEM and EDS not shown), which leads to lower phase purities. Ce-free MZP samples do not densify on sintering at 1000-1200° C. under the same conditions (SEM not shown). Conditions must be further optimized to produce still higher purity pellet electrolytes.

TABLE 12
Densities and phase compositions of
MZPCeₓ pellets after sintering at 1200° C./1 h/air.

| | | | Phases | |
|---|---|---|---|---|
| | Density | Relative density | MZP | ZrP₂O₇ |
| Materials | (g · cm⁻³) | (%) | (wt. %) | (wt. %) |
| MZPCe_{0.1} | 2.95 | 90(±2) | 97 | 3 |
| MZPCe_{0.2} | 3.32 | 100(−2) | 90 | 10 |
| MZPCe_{0.3} | 3.41 | 100(−2) | 87 | 13 |

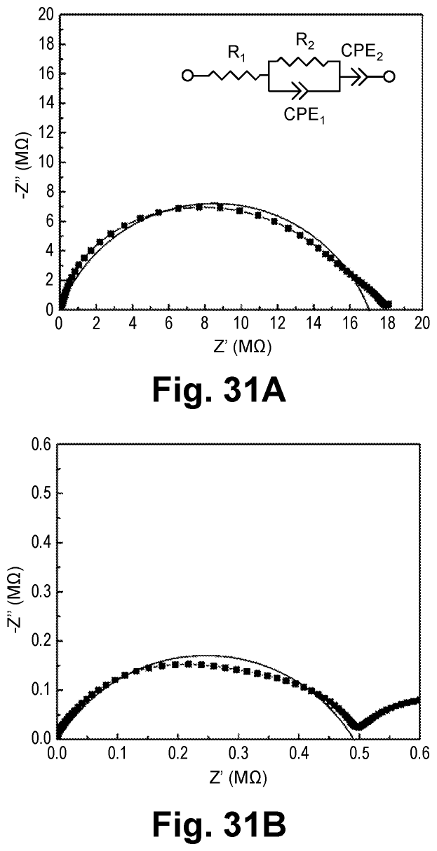

Lower relative densities and phase purity would lead to lower ionic conductivities of Ce-free MZP, MZPCe_{0.1} and MZPCe_{0.3} pellets. Therefore, only the ionic conductivities of fully dense MZPCe_{0.2} pellets with relative densities of at least 90% are investigated. FIGS. 31A-31B provide the Nyquist plots in the high frequency regions for MZPCe_{0.2} pellets tested at 100° and 200° C., respectively. At 100° C., the Nyquist plot shows a nearly perfect semicircle (less than 18 MΩ in impendence). An imperfect semicircle at higher frequencies (less than 0.5 MΩ in impedance) followed by an inclined spike at lower frequencies (greater than 0.5 MΩ in impedance) is observed at 200° C., compared to 100° C.

Both plots are typical of ionic conductors with blocking electrodes. The semicircle and spike are due to the samples' ionic conductivity and polarization of ion-blocking electrodes. Here, since the left intercept of the semicircle with the real axis (Z′) approaches zero, the right intercept is taken as the total resistance (Rₜ=R_{g}+R_{gb}) as a conservative estimate. R_{g} and R_{gb} denote the grain and grain boundary resistances, respectively. A well-recognized equivalent circuit, as presented in the inset in FIG. 31A, is used for fitting, providing the total resistance. The single resistor (R₁) is equal to the left intercept, the parallel resistor (R₂) to a constant phase element (CPE₁) is equal to the diameter of semicircle, and a constant phase element (CPE₂) denotes electrode polarization.

Table 13 lists the ionic conductivities of MZPCe_{0.2} pellets tested at 25-200° C. They offer ionic conductivities of 2.6×10⁻⁶ mS·cm⁻¹ at ambient temperature, greater than 10⁻⁵ mS·cm⁻¹ at 100° C., and 3.8×10⁻⁴ mS·cm⁻¹ at 200° C.

TABLE 13
Ionic conductivities of MZPCe_{0.2} pellets after sintering at 1200° C./1 h/air.

| | T (° C.) | | | | | | | | | |
|---|---|---|---|---|---|---|---|---|---|---|
| | 25 | 40 | 60 | 80 | 100 | 120 | 140 | 160 | 180 | 200 |
| σₜ (×10⁻⁵ mS · cm⁻¹) | 0.26 | 0.53 | 0.63 | 0.79 | 1.2 | 1.9 | 3.8 | 8.4 | 19 | 38 |

MZPCe_{0.2} Films.

Sintered Film Analyses.

Per the investigation of MZPCeₓ pellet sintering, MZPCe_{0.2} films are sintered at 1000-1200° C., aiming to obtain dense, phase-pure films at temperatures as low as possible.

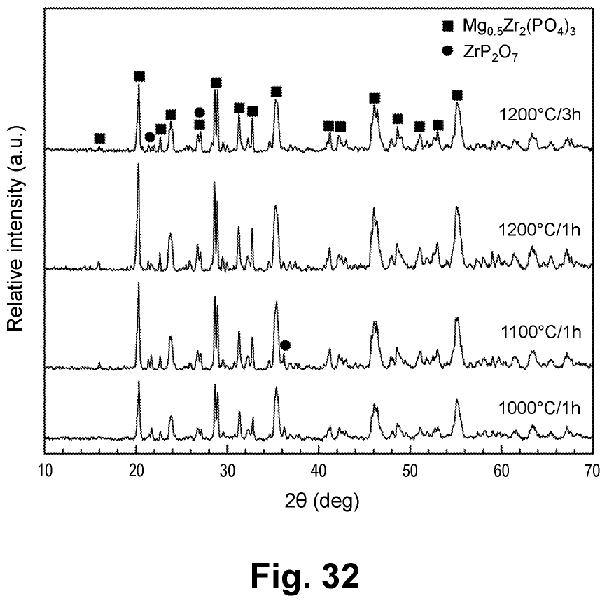

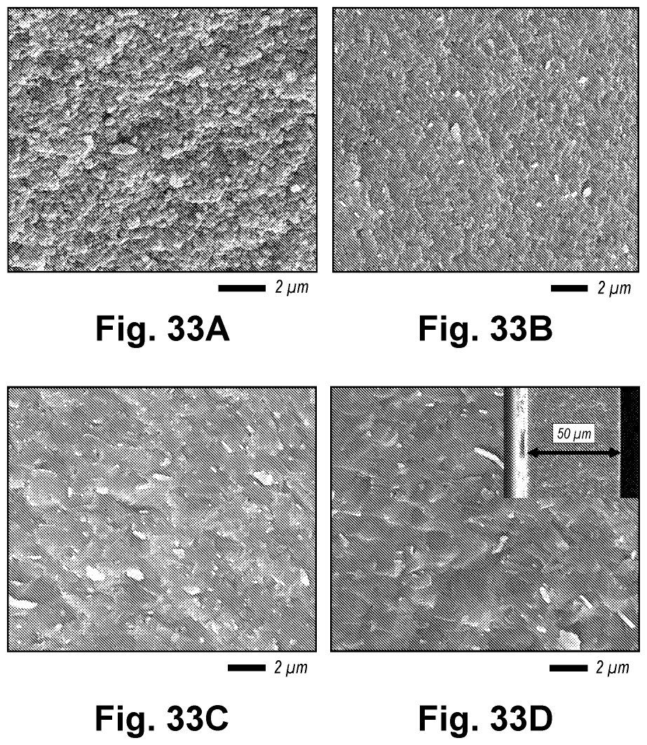

The XRD patterns shown in FIG. 32 reveal phase compositions of the as-sintered MZPCe_{0.2} films. MZP forms in sintered films, as well as ZrP₂O₇ as a minor secondary phase. Increasing sintering temperatures and dwell times leads to increases in Mg_{0.5}Zr₂(PO₄)₃, and decreases in ZrP₂O₇ contents as show in Table 14. High-purity MZPCe_{0.2} films containing greater than 99 wt. % MZP are obtained on sintering at 1200° C./3 hours. The SEMs shown in FIGS. 33A-33D show fracture morphologies for as-sintered MZPCe_{0.2} films. At 1000° C., closed-packed spherical NPs are still observed in fracture surfaces, somewhat similar to as-produced NPs. At 1100° C., these spherical morphologies disappear, accompanied by the formation of irregular-shaped grains. Coincidentally, a large number of pores are distributed uniformly in the films. At 1200° C./1 hour, almost no pores can be observed, suggesting nearly fully dense films. Longer dwell times (3 hours) lead to higher densification and somewhat larger grains. Calculation per Archimedes' method indicates relative densities of 95±2%. The fully dense films (50 μm thick) fracture in an intra-granular mode and show a flat fracture surface. Additionally, the white, plate-like grains in FIGS. 33C-33D correspond to the secondary ZrP₂O₇ phase, as confirmed by TEM as described below.

TABLE 14
Relative contents of phases in sintered MZPCeo.2 films.

| Temperature (° C.)/Time (h) | MZP (wt. %) | ZrP₂O₇ (wt. %) |
|---|---|---|
| 1000/1 | 91.8 | 8.2 |
| 1100/1 | 93.7 | 6.3 |
| 1200/1 | 96.1 | 3.9 |
| 1200/3 | >99.0 | <1.0 |

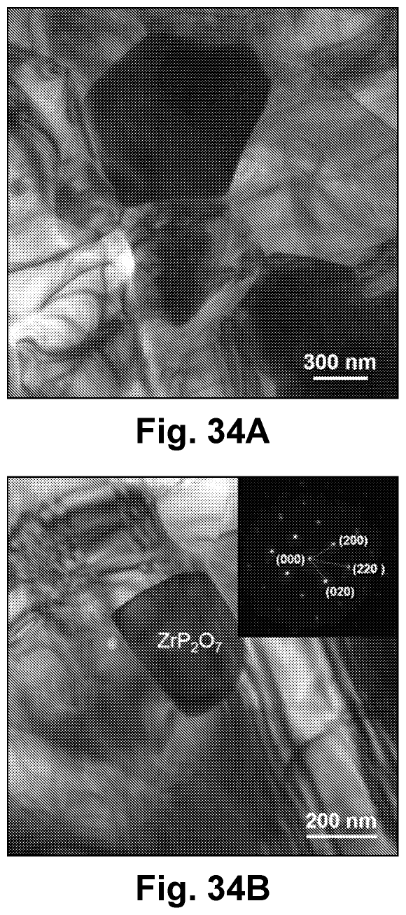

Initial efforts are made to calculate average grains sizes (AGSs) by observing surface and fracture morphologies of thermally etched MZPCe_{0.2} films using SEM. Both the surfaces and fractured surfaces of the as-sintered films at 1200° C./3 hours are thermally etched at 1100±100° C./30 minutes in air. However, only ambiguous grain boundaries or separated grains are observed (SEMs not shown). TEM is then used to investigate AGSs (FIGS. 34A-34B). FIG. 34A provides a representative TEM of the as-sintered MZPCe_{0.2} films at 1200° C./3 hours in air. Grains with clear boundaries are observed. Statistical calculation of dozens of grains based on the lineal intercept method indicates AGSs of 550±100 nm in 45±5 μm thick films. FIG. 34B shows a representative TEM image indicating the presence of secondary ZrP₂O₇ phases with AGSs of ca. 200 nm, which is consistent with the observation of morphologies using SEM (FIGS. 33A-33D).

Different sintering conditions result in diverse microstructures with variations in phase compositions, grain sizes, phase segregation at grain boundaries, and relative densities, thereby significantly influencing the ionic conductivity of electrolytes. Low relative densities of electrolytes and purities of the main phase lead to high values for grain boundary resistance. A single-phase microstructure with full density and small grain sizes is, thus, an essential prerequisite for high-performance ionic conductors. Therefore, the ionic conductivities of fully dense MZPCe_{0.2} films with high phase purities (greater than 99%) are investigated.

Ionic Conductivities.

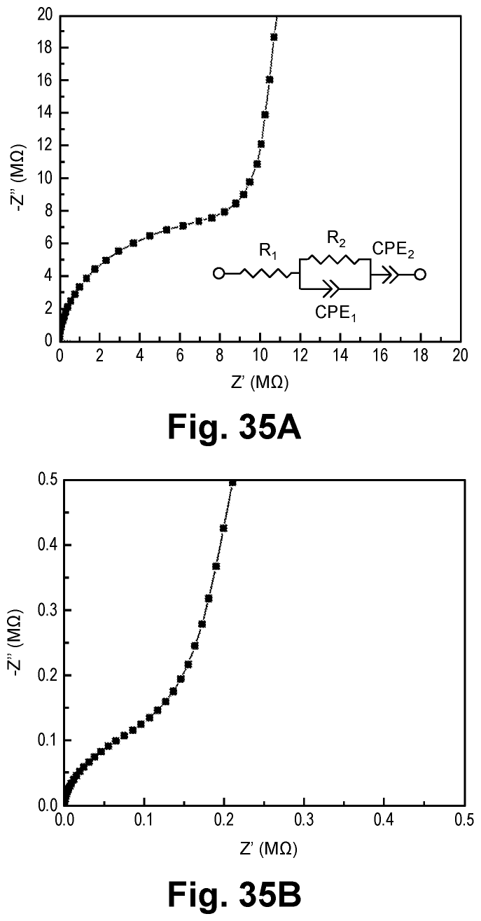

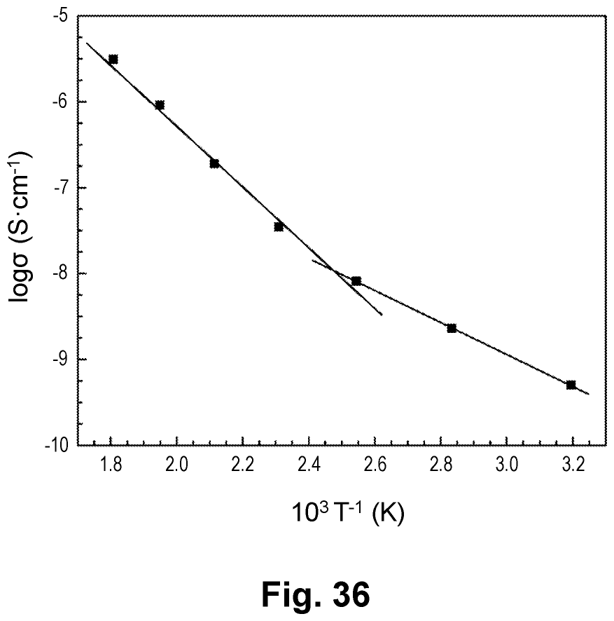

Here, six samples of MZPCe_{0.2} films sintered at 1200° C./3 hours in air are used to measure ionic conductivities. Conservative results with reproducibility are adopted. FIGS. 35A-35B depict representative Nyquist plots for MZPCe_{0.2} films tested at 100° and 200° C., respectively. Depressed semicircles at higher frequencies are observed, followed by inclined spikes at lower frequencies. The equivalent circuit presented in the inset of FIG. 35A is used for fitting to get the total resistance. The calculated ionic conductivities of MZPCe_{0.2} films measured at 25-280° C. are listed in Table 15. MZPCe_{0.2} films provide conductivities of 1.3×10⁻⁶ mS·cm⁻¹ at 60° C., increasing to 10⁻⁴ mS·cm⁻¹ at 200° C. and of 3.1×10⁻³ mS·cm⁻¹ at 280° C. The calculated activation energy is 29.6 kJ/mol (greater than or equal to 60° C.). derived from the slope of Arrhenius plot shown in FIG. 36. Lower activation energies lead to higher conductivities, while higher activation energies lead to reduced conductivities at lower temperatures. (Mg_{0.1}Hf_{0.9})_{4/3.8}Nb(PO₄)₃ pellet electrolytes have activation energies of 64 kJ/mol, coincident with ionic conductivities of 2.1×10⁻³ mS·cm⁻¹ at a moderate temperature of 300° C., 20 times higher than that (1.1×10⁻⁴ mS·cm⁻¹) of Mg_{0.7}(Zr_{0.85}Nb_{0.15})₄P₆O₂₄ pellets with higher activation energies of 92 kJ/mol.

TABLE 15
Total conductivities (σₜ) of MZPCe_{0.2}films (43 ± 2 μm thick).

| | T (° C.) | | | | | | | | | | |
|---|---|---|---|---|---|---|---|---|---|---|---|
| | 25 | 40 | 60 | 80 | 100 | 120 | 140 | 160 | 200 | 240 | 280 |
| σₜ (×10⁻⁵ mS · cm⁻¹) | 0.02 | 0.05 | 0.13 | 0.23 | 0.43 | 0.81 | 1.4 | 3.5 | 19 | 91 | 310 |

Per the Arrhenius plot shown in FIG. 36, ionic conductivities of MZPCe_{0.2} films at higher temperatures are estimated by extrapolation and listed in Table 16. Table 17 compares the ionic conductivities of MZPCe_{0.2} films and pellets to other MZP counterparts reported elsewhere. MZPCe_{0.2} pellets offer conductivities of 3.8×10⁻¹ mS·cm⁻¹ at 20° C., twice as high as that of MZPCe_{0.2} films. The films have relative densities of 95%, almost as high as that (98%) of pellets, and phase purities of 99%, higher than that (90%) of pellets. The pellet surfaces are polished to obtain a mirror finish before measurement of conductivities. However, the thin films could not be polished easily because they are quite fragile compared to pellets. The low smoothness and possible surface impurities are likely reasons for the lower conductivities of films as compared to pellets. The reasonably small AGSs (550±100 nm) of MZPCe_{0.2} films may also lead to lower conductivities.

TABLE 16
Estimated total conductivities (σₜ) of MZPCe_{0.2} films based
on the Arrhenius plot shown in FIG. 36, using the extension method.

| T ( C.) | 400 | 500 | 600 | 700 | 800 |
|---|---|---|---|---|---|
| σₜ (×10⁻² mS · cm⁻¹) | 4 | 19 | 63 | 166 | 365 |

TABLE 17
Found and estimated^{†} conductivities (σₜ) for MZP electrolytes reported here and elsewhere.

| | | | Processing | | |
|---|---|---|---|---|---|
| Chemical compositions | T (° C.) | σₜ(mS · cm⁻¹) | methods | Shapes | Refs. |
| MZPCe_{0.2} | 25 | 2.0 × 10⁻⁷ | LF-FSP/TC/S | Films/45 ± 5 μm thick | this work |
| | 200 | 1.9 × 10⁻⁴ | | | |
| | 280 | 3.1 × 10⁻³ | | | |
| | 500^{†} | 1.9 × 10⁻¹ | | | |
| | 800^{†} | 3.65 | | | |
| MZPCe_{0.2} | 25 | 2.6 × 10⁻⁶ | LF-FSP/CIP/S | Pellets/0.5 mm thick | this work |
| | 200 | 3.8 × 10⁻⁴ | | | |
| Mg_{0.5}Zr₂(PO₄)₃ | 25 | 1.0 × 10⁻³ | SG/C/S | Pellets | |
| | 500 | 7.1 × 10⁻² | | | |
| Mg_{0.5}Zr₂(PO₄)₃ | 400 | 2.9 × 10⁻² | G/C/HP | Pellets/1-2 mm thick | |
| | 800 | 6.1 × 10⁻¹ | | | |
| Mg_{0.5}Zr₂(PO₄)₃ | 800 | 6.9 × 10⁻¹ | SG/C/S | Pellets | |
| Mg_{1.4}Zr₄P₆O_{24.4} + 0.4Zr₂O(PO₄)₂ | 800 | 2.9 | G/C/S | Pellets | |
| Mg_{0.9}(Zr_{0.6}Fe_{0.4})₂(PO₄)₃ | 25 | 1.3 × 10⁻² | SG/C/S | Pellets | |
| | 500 | 7.2 × 10⁻² | | | |
| Mg_{0.5}Si₂(PO₄)₃ | 25 | 1.8 × 10⁻² | SG/C/S | Pellets | |
| (Mg_{0.1}Hf_{0.9})_{4/3.8}Nb(PO₄)₃ | 300 | 2.1 × 10⁻³ | CP/C/S | Pellets | |

Note:
TC—tape casting, S—sintering at atmospheric pressure, CIP—cold isostatic pressing, SG—sol-gel, C—calcination, G—grinding mixed powders in a mortar, HP—hot pressing, CP—co-precipitation.

The MZPCe_{0.2} pellets and thin (less than or equal to 50 μm) films show conductivities of up to 3×10⁻³ mS/cm² at approximately 300° C., which is line with reported values in the literature. However, conductivities reported in the literature to date are only for MZP electrolyte pellets, whereas the present report is the first to produce thin films. Coincidently, films provide lower ionic area specific resistances (IASR=d/σ), due to the significant reduction in thicknesses.

The calculated IASR for 43 μm MZPCe_{0.2} films is 1400 Ω·cm² at approximately 300° C. If an Eₐ of approximately 30 kJ/mol is used, then it can be extrapolated to suggest that IASR values for 43 μm MZPCe_{0.2} films would be 110 Ω·cm² at 400° C. They are 20⁺ times smaller than values for 1 mm pellets, with almost the same conductivities reported elsewhere. However, this type of extrapolation can only be verified by actual temperature measurements, which are beyond the capability of our current system.

Optimization of Ce-doped MZP NP synthesis, film processing, and sintering leading to values of conductivities beyond those reported in literature and MZP electrolytes with new substitutional dopants, e.g., Y³⁺, continue to be explored.

Conclusions from the Above Non-Limiting Example

Mg_{0.5}CeₓZr₂₋ₓ(PO₄)₃ (x=0.1, 0.2 and 0.3) electrolyte NPs are synthesized using liquid-feed flame spray pyrolysis, then processed to pellets (0.5 mm thick) and thin (less than or equal to 50 μm) films. After sintering at 1200° C., Mg_{0.5}Ce_{0.2}Zr_{1.8}(PO₄)₃ electrolytes, including pellets and films, have full densities and optimized phase purities, thereby offering the highest ionic conductivities among the Mg_{0.5}CeₓZr₂₋ₓ(PO₄)₃ (x=0.1, 0.2 and 0.3) compositions looked at. MZPCe_{0.2} pellets show ionic conductivities of 3.8×10⁻⁴ mS·cm⁻¹ at 200° C., while thin (ca. 45 μthick) films offer values of 1.9×10⁻⁴ mS·cm⁻¹ under the same conditions due to the imperfect smoothness and possible surface impurities. Ce free compositions do not sinter to full density under the conditions used here, indicating the advantage to doping with Ce.

Arrhenius based estimates for ionic conductivities at 400° C. suggest values near or superior to 10⁻² mS·cm⁻¹ in keeping with the best values reported in the literature. An important contribution here is the significant reduction in thickness in these thin film electrolytes compared to pellets which offer IASR values of 1400 Ω·cm² at approximately 300° C. and are estimated to offer IASR values of 110 Ω·cm² at 400° C., providing the ability to fabricate high energy density solid-state batteries. Therefore, thin film electrolytes are useful for development of high-performance all-solid-state Mg-ion batteries operated at medium temperatures.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. An electrochemically active component comprising a ceramic film having a thickness of less than or equal to about 100 μm, wherein the ceramic film comprises Na-β″-Al₂O₃, Na_{1.67}Al_{10.33}Mg_{0.67}O₁₇ (NAMO), 0.4Li₄SiO₄-0.6Li₃PO₄ (LSPO), Mg_{0.5}Zr₂(PO₄)₃ (MZP), La₃Ta₂O₁₂, Li₂₊₂ₓZn₁₋ₓGeO₄ (LISICON), Li₅La₃Ta₂O₁₂, Li_{0.5}La_{0.5}TiO₃, Li₇₋ₓLa₃Zr₂₋ₓTaₓO₁₂ where 0<x<2 (e.g., Li₇La₃Zr₂O₁₂), Li₆La₃SnMO₁₂, Li_{6.75+x}La₃₋ₓSrₓZr_{1.75}Nb_{0.25}O₁₂ where 0.05≤x≤0.25 (LLSZN), Li₂B₄O₇, LiCoO₂ (LCO), LiFePO₄ (LFP), LiNiCoAlO₂ (NCA), LiMn₂O₄ (LMO), LiNi_{0.5}Mn_{1.5}O₄ (LNMO), Li₃VO₄ (LVO), Li₄Ti₅O₁₂, 12CaO-7Al₂O₃ (C12A7), InₓSn₁₋ₓO₂ where 0<x<1 (ITO), and ZnO, Y₂O₃, ZrO₂, NiAl₂O₄, NiO, Fe₂O₃, HfO₂, SiO₂, SrSnO₃, ZnSnO₃, BaSnO₃, RE₂O₃, AlxByPᵤLaₘLi_{z}RE1ₐSi_{b}RE2_{c}Zr_{d}YₑO_{f} where RE is a rare earth element, and the molar range of each element can be: x=0.05 to 0.99, y=0.00 to 0.99, u=0.0 to 3.0, m=2.0 to 3.5, z=2.5 to 10.5, a=0.05 to 3.5, b=0.01 to 1.0, c=0.25 to 5.0, d=0.0 to 2.0, and e=0.01 to 0.5, CoₓLi_{y}Mn_{z}NₐP_{b}Ti_{c}O_{d} Ag_{d} where the molar range of each element can be: x=0.0 to 2.0, y=0.0 to 5.0, z=0.0 to 3.0, a=0.0 to 2.0, b=0.0 to 3.0, c=0.0 to 2.0, and d=0.0 to 10.0, NaₓZr_{y}Ti_{z}YₐAl_{b}Mg_{c}Li_{d}Oₑ where the molar range of each element can be: x=0.0 to 6.0, y=0.0 to 4.0, z=0.0 to 3.0, a=0.0 to 3.0, b=0.0 to 12.0, c=0.0 to 5.0, d=0.0 to 5.0, and e=0.0 to 22.0, AlₓCo_{y}Ni_{z}YₐZr_{b}O_{c} where the molar range of each element can be: x=0.0 to 6.0, y=0.0 to 5.0, z=0.0 to 3.0, a=0.0 to 2.0, and b=0.0 to 3.0, or a combination thereof.

2. The electrochemically active component according to claim 1, wherein the ceramic film is a continuous film of β″-Al₂O₃.

3. The electrochemically active component according to claim 2, wherein the β″-Al₂O₃ is doped with at least one of Mg and Ti.

4. The electrochemically active component according to claim 2, wherein the continuous film comprises ZrO₂, such that the ceramic film is a ceramic composite film.

5. The electrochemically active component according to claim 2, wherein the ceramic film is a Na ion conductor.

6. The electrochemically active component according to claim 1, wherein the ceramic film comprises a plurality of ceramic layers, wherein each layer of the plurality has a thickness of less than or equal to about 100 μm.

7. The electrochemically active component according to claim 1, wherein the ceramic film is a continuous film of sintered Na_{1.67}Al_{10.33}Mg_{0.67}O₁₇ (NAMO), ZrO₂, and TiO₂ having a thickness of less than or equal to about 75 μm.

8. The electrochemically active component according to claim 1, wherein the ceramic film is a ceramic-metal composite film comprising LiCoO₂—Li₄SiO₄—Li₃PO₄ (LSPO)-Ag.

9. The electrochemically active component according to claim 8, wherein the ceramic-metal composite film is a cathode for a lithium battery.

10. The electrochemically active component according to claim 1, wherein the ceramic film is a ceramic-metal composite film comprising LiNi_{0.33}Mn_{0.33}Co_{0.33}O₂ (NMC)/xLi₄SiO₄-(1−x)Li₃PO₄ (LSPO)/Ag, wherein 0≤x≤1.

11. The electrochemically active component according to claim 10, wherein the ceramic-metal composite film is a cathode for a lithium battery.

12. The electrochemically active component according to claim 1, wherein the ceramic film is a ceramic-metal composite film comprising Li₃VO₄(LVO)/Li_{6.25}Al_{0.25}La₃Zr₂O₁₂(Al:LLZO)/Ag.

13. The electrochemically active component according to claim 12, wherein the ceramic-metal composite film is an anode for a lithium battery.

14. The electrochemically active component according to claim 1, wherein the ceramic film comprises 12CaO-7Al₂O₃ (Ca12A7).

15. The electrochemically active component according to claim 14, wherein the ceramic film is an electron conductor.

16. The electrochemically active component according to claim 1, wherein the ceramic film is a ceramic composite film comprising Mg_{0.5}CeₓZr₂₋ₓ(PO₄)₃ (MZPCeₓ), wherein 0<x≤0.5.

17. The electrochemically active component according to claim 16, wherein the ceramic composite film is a Mg ion conductor.

18. The electrochemically active component according to claim 1, wherein the electrochemically active component is a battery anode, a battery cathode, a battery ion conductor, a battery electron conductor, a thermal electric generator, a high temperature fuel cell, or a gate dielectric.

19. A battery component comprising a ceramic film having a thickness of less than or equal to about 100 μm, wherein the ceramic film comprises β″-Al₂O₃, LiCoO₂—Li₄SiO₄—Li₃PO₄ (LSPO)-Ag, LiNi_{0.33}Mn_{0.33}Co_{0.33}O₂ (NMC)/xLi₄SiO₄-(1−x)Li₃PO₄ (LSPO)/Ag, wherein 0≤x≤1, Li₃VO₄(LVO)/Li_{6.25}Al_{0.25}La₃Zr₂O₁₂(Al:LLZO)/Ag, 12CaO-7Al₂O₃ (Ca12A7), or Mg_{0.5}CeₓZr₂₋ₓ(PO₄)₃ (MZPCeₓ), wherein 0<x≤0.5.

20. A method of making a ceramic film, the method comprising:
combining ceramic precursor nanoparticles having an average diameter of less than or equal to about 500 μm, an additive component, and a solvent to generate a nanopowder suspension;
casting a layer of the suspension onto a substrate;
drying the layer to form a green film;
debindering the green film to form a debindered green film; and
sintering the compressed and debindered green film to form the ceramic film,
wherein the ceramic film has a thickness of less than or equal to about 100 μm and comprises Na-β″-Al₂O₃, Na_{1.67}Al_{10.33}Mg_{0.67}O₁₇ (NAMO), 0.4Li₄SiO₄-0.6Li₃PO₄ (LSPO), Mg_{0.5}Zr₂(PO₄)₃ (MZP), La₃Ta₂O₁₂, Li₂₊₂ₓZn₁₋ₓGeO₄ (LISICON), Li₅La₃Ta₂O₁₂, Li_{0.5}La_{0.5}TiO₃, Li₇₋ₓLa₃Zr₂₋ₓTaₓO₁₂ where 0<x<2 (e.g., Li₇La₃Zr₂O₁₂), Li₆La₃SnMO₁₂, Li_{6.75+x}La₃₋ₓSrₓZr_{1.75}Nb_{0.25}O₁₂ where 0.05≤x≤0.25 (LLSZN), Li₂B₄O₇, LiCoO₂ (LCO), LiFePO₄ (LFP), LiNiCoAlO₂ (NCA), LiMn₂O₄ (LMO), LiNi_{0.5}Mn_{1.5}O₄ (LNMO), Li₃VO₄ (LVO), Li₄Ti₅O₁₂, 12CaO-7Al₂O₃ (C12A7), InₓSn₁₋ₓO₂ where 0<x<1 (ITO), and ZnO, Y₂O₃, ZrO₂, NiAl₂O₄, NiO, Fe₂O₃, HfO₂, SiO₂, SrSnO₃, ZnSnO₃, BaSnO₃, RE₂O₃, AlxByPᵤLaₘLi_{z}RE1ₐSi_{b}RE2_{c}Zr_{d}YₑO_{f} where RE is a rare earth element, and the molar range of each element can be: x=0.05 to 0.99, y=0.00 to 0.99, u=0.0 to 3.0, m=2.0 to 3.5, z=2.5 to 10.5, a=0.05 to 3.5, b=0.01 to 1.0, c=0.25 to 5.0, d=0.0 to 2.0, and e=0.01 to 0.5, CoₓLi_{y}Mn_{z}NₐP_{b}Ti_{c}O_{d} Ag_{d} where the molar range of each element can be: x=0.0 to 2.0, y=0.0 to 5.0, z=0.0 to 3.0, a=0.0 to 2.0, b=0.0 to 3.0, c=0.0 to 2.0, and d=0.0 to 10.0, NaₓZr_{y}Ti_{z}YₐAl_{b}Mg_{c}Li_{d}Oₑ where the molar range of each element can be: x=0.0 to 6.0, y=0.0 to 4.0, z=0.0 to 3.0, a=0.0 to 3.0, b=0.0 to 12.0, c=0.0 to 5.0, d=0.0 to 5.0, and e=0.0 to 22.0, AlₓCo_{y}Ni_{z}YₐZr_{b}O_{c} where the molar range of each element can be: x=0.0 to 6.0, y=0.0 to 5.0, z=0.0 to 3.0, a=0.0 to 2.0, and b=0.0 to 3.0, and combinations thereof.

21. The method according to claim 20, wherein the ceramic precursor nanoparticles are made by liquid-feed flame spray pyrolysis (LF-FSP).

22. The method according to claim 21, wherein the ceramic precursor nanoparticles are made from a precursor selected from the group consisting of, carboxylate salts comprising Li, Na, Ca, Mg, Ba, Zr, Ce, Co, Mn, Dy, Er, Gd, Ho, La, Lu, Nd, Pr, Pm, Sm, Sc, Tb, Tm, Yb, and Y; alumatrane (N(CH₂CH₂O)₃Al); alkoxy phosphites and phosphates; alkoxysilanes; nickel acetate tetrahydrate; and combinations thereof.

23. The method according to claim 20, wherein the additive component comprises at least one dispersant, at least one binder, at least one plasticizer, or a combination thereof.

24. The method according to claim 23, wherein the at least one dispersant is selected from the group consisting of polyacrylic acid, bicine, citric acid, steric acid, fish oil, phenylphosphonic acid, phosphoric acid, ammonium polymethacrylate, organosilanes, and combinations thereof.

25. The method according to claim 23, wherein the at least one binder is selected from the group consisting of polyvinyl butyral, polyvinyl acetate, methyl cellulose, ethyl cellulose, polyacrylate esters, polyurethane, polyethylene glycol, acrylic compounds, polystyrene, polyvinyl alcohol, polymethylmethacrylate, polybutylmethacrylate, and combinations thereof.

26. The method according to claim 23, wherein the at least one plasticizer is selected from the group consisting of benzyl butyl phthalate, acetic acid alkyl esters, bis[2-(2-butoxyethoxy)ethyl] adipate, 1,2-Dibromo-4,5-bis(octyloxy)benzene, dibutyl adipate, dibutyl itaconate, dibutyl sebacate, dicyclohexyl phthalate, diethyl adipate, diethyl azelate, di(ethylene glycol) dibenzoiate, diethyl sebacate, diethyl succinate, diheptyl phthalate, diisobutyl adipate, diisobutyl fumarate, diisobutyl phthalate, diisodecyl adipate, diisononyl phthalate, dimethyl adipate, dimethyl azelate, dimethyl phthalate, dimethyl sebacate, dioctyl terephthalate, diphenyl phthalate, di(propylene glycol) dibenzoate, dipropyl phthalate, ethyl 4-acetylbutyrate, 2-(2-ethylhexyloxy)ethanol, isodecyl benzoate, isooctyl tallate, neopentyl glycol dimethylsulfate, 2-nitrophenyl octyl ether, poly(ethylene glycol) bis(2-ethylhexanoate), poly(ethylene glycol) dibenzoate, poly(ethylene glycol) dioleate, poly(ethylene glycol) monolaurate, poly(ethylene glycol) monooleate, poly(ethylene glycol) monooleate, sucrose benzoate, 2,2,4-trimethyl-1,3-pentanediol dibenzoate, trioctyl timelitate, and combinations thereof.

27. The method according to claim 20, further comprising:
ball milling the nanopowder suspension prior to the casting.

28. The method according to claim 20, wherein the substrate is selected from the group consisting of polyethylene terephthalate (PET), biaxially-oriented polyethylene terephthalate (BoPET), polytetrafluoroethylene (PTFE), a plastic, rubber, metal, steel, stainless steel, graphite foil, glass, and a combination thereof.

29. The method according to claim 20, wherein the casting is performed by bar coating, wire wound rod coating, drop casting, spin coating, doctor blading, dip coating, or spray coating.

30. The method according to claim 20, wherein the drying the layer to form the green film removes substantially all of the solvent and comprises incubating the layer at a temperature of greater than or equal to about 20° C. to less than or equal to about 200° C. for a time of greater than or equal to about 30 minutes to less than or equal to about 24 hours.

31. The method according to claim 20, further comprising:
removing the green film from the substrate prior to the debindering.

32. The method according to claim 20, further comprising:
compressing the green film at a pressure of greater than or equal to about 5 MPa to less than or equal to about 300 MPa,
wherein the compressing is performed immediately before or immediately after the debindering.

33. The method according to claim 20, wherein the debindering is performed by subjecting the green film to a temperature of greater than or equal to about 300° C. to less than or equal to about 700° C. for a time of greater than or equal to about 0.25 hours to less than or equal to about 10 hours.

34. The method according to claim 20, wherein the sintering comprises heating the debindered green film to a temperature of greater than or equal to about 700° C. to less than or equal to about 1700° C. for a time of greater than or equal to about 1 hour to less than or equal to about 48 hours.

35. The method according to claim 20, further comprising, prior to the sintering:
disposing a second green film onto either the green film or the ceramic film, the second green film having the same or a different composition than the green film; and
sintering the second green film to form the ceramic film,
wherein the ceramic film is a composite ceramic film.

36. The method according to claim 20, wherein the ceramic film is at least one of flexible and transparent.

37. The method according to claim 20, wherein the ceramic film is configured to be a battery cathode, catholyte, electrolyte, anolyte, or anode.

38. The method according to claim 20, wherein the nanopowder suspension further comprises nanoparticle dopants, and the ceramic film is a composite film comprising a ceramic material generated from the ceramic precursor nanoparticles and the nanoparticle dopants.

39. The method according to claim 20, wherein the ceramic film is a cathode material selected from the group consisting of LiCoO₂ (LCO), LiNiₓMn_{y}Co_{z}O₂ (NMC) where 0≤x≤1, 0≤y≤1, 0≤z≤1, LiFePO₄ (LFP), LiNiCoAlO₂ (NCA), LiMn₂O₄ (LMO), and LiNi_{0.5}Mn_{1.5}O₄ (LNMO) and combinations thereof.

40. The method according to claim 20, wherein the ceramic film is an electrolyte material selected from the group consisting of Na-β″-Al₂O₃, Na_{1.67}Al_{10.33}Mg_{0.67}O₁₇ (NAMO), 0.4Li₄SiO₄-0.6Li₃PO₄ (LSPO), Mg_{0.5}Zr₂(PO₄)₃ (MZP), La₃Ta₂O₁₂, Li₂₊₂ₓZn₁₋ₓGeO₄ (LISICON), Li₅La₃Ta₂O₁₂, Li_{0.5}La_{0.5}TiO₃, Li₇₋ₓLa₃Zr₂₋ₓTaₓO₁₂ where 0<x<2 (e.g., Li₇La₃Zr₂O₁₂), Li₆La₃SnMO₁₂, Li_{6.75+x}La₃₋ₓSrₓZr_{1.75}Nb_{0.25}O₁₂ where 0.05≤x≤0.25 (LLSZN), Li₂B₄O₇ and combinations thereof.

41. The method according to claim 20, wherein the ceramic film is an anode material selected from the group consisting of Li₃VO₄ (LVO), Li₄Ti₅O₁₂, and combinations thereof.

42. The method according to claim 20, wherein the ceramic film is an electrical conductor selected from the group consisting of 12CaO-7Al₂O₃ (C12A7).

43. A thin ceramic film made by the method according to claim 20.

44. A battery comprising a ceramic film made by the method according to claim 20.

45. A ceramic film comprising Na-β″-Al₂O₃, Na_{1.67}Al_{10.33}Mg_{0.67}O₁₇ (NAMO), 0.4Li₄SiO₄-0.6Li₃PO₄ (LSPO), Mg_{0.5}Zr₂(PO₄)₃ (MZP), La₃Ta₂O₁₂, Li₂₊₂ₓZn₁₋ₓGeO₄ (LISICON), Li₅La₃Ta₂O₁₂, Li_{0.5}La_{0.5}TiO₃, Li₇₋ₓLa₃Zr₂₋ₓTaₓO₁₂ where 0<x<2 (e.g., Li₇La₃Zr₂O₁₂), Li₆La₃SnMO₁₂, Li_{6.75+x}La₃₋ₓSrₓZr_{1.75}Nb_{0.25}O₁₂ where 0.05≤x≤0.25 (LLSZN), Li₂B₄O₇, LiCoO₂ (LCO), LiFePO₄ (LFP), LiNiCoAlO₂ (NCA), LiMn₂O₄ (LMO), LiNi_{0.5}Mn_{1.5}O₄ (LNMO), Li₃VO₄ (LVO), Li₄Ti₅O₁₂, 12CaO-7Al₂O₃ (C12A7), InₓSn₁₋ₓO₂ where 0<x<1 (ITO), and ZnO, Y₂O₃, ZrO₂, NiAl₂O₄, NiO, Fe₂O₃, HfO₂, SiO₂, SrSnO₃, ZnSnO₃, BaSnO₃, RE₂O₃, AlxByPᵤLaₘLi_{z}RE1ₐSi_{b}RE2_{c}Zr_{d}YₑO_{f} where RE is a rare earth element, and the molar range of each element can be: x=0.05 to 0.99, y=0.00 to 0.99, u=0.0 to 3.0, m=2.0 to 3.5, z=2.5 to 10.5, a=0.05 to 3.5, b=0.01 to 1.0, c=0.25 to 5.0, d=0.0 to 2.0, and e=0.01 to 0.5, CoₓLi_{y}Mn_{z}NₐP_{b}Ti_{c}O_{d} Ag_{d} where the molar range of each element can be: x=0.0 to 2.0, y=0.0 to 5.0, z=0.0 to 3.0, a=0.0 to 2.0, b=0.0 to 3.0, c=0.0 to 2.0, and d=0.0 to 10.0, NaₓZr_{y}Ti_{z}YₐAl_{b}Mg_{c}Li_{d}Oₑ where the molar range of each element can be: x=0.0 to 6.0, y=0.0 to 4.0, z=0.0 to 3.0, a=0.0 to 3.0, b=0.0 to 12.0, c=0.0 to 5.0, d=0.0 to 5.0, and e=0.0 to 22.0, AlₓCo_{y}Ni_{z}YₐZr_{b}O_{c} where the molar range of each element can be: x=0.0 to 6.0, y=0.0 to 5.0, z=0.0 to 3.0, a=0.0 to 2.0, and b=0.0 to 3.0, or a combination thereof, wherein the ceramic film has a thickness of less than or equal to about 100 μm.

46. The ceramic film according to claim 45, wherein the ceramic film is a composite ceramic film further comprising a dopant selected from the group consisting of Al, Ga, In, Mn, Ca, Ba, Sr, Y, Nb, Ta, Si, Mo, RE rare earth elements (scandium (Sc), yttrium (Y), lanthanum (La), cerium (Ce), praseodymium (Pr), neodymium (Nd), promethium (Pm), samarium (Sm), europium (Eu), gadolinium (Gd), terbium (Tb), dysprosium (Dy), homium (Ho), Erbium (Er), thulium (Tm), ytterbium (Yb), and lutetium (Lu)), actinides, lanthanides, or combinations thereof.

47. The ceramic film according to claim 45, further comprising a conductive additive selected from the group consisting of silver (Ag), gold (Au), palladium (Pd), platinum (Pt), copper (Cu), lead (Pb), tungsten (W), titanium (Ti), and combinations thereof.

48. The ceramic film according to claim 45, wherein the ceramic film comprises at least one additional layer comprising a second ceramic film having a thickness of less than or equal to about 100 μm.
